(19) United States
(12) Patent Application Publication
(10) Pub. No.: US 2007/0090638 A1
(43) Pub. Date: Apr. 26, 2007

(54) Holder for books, newspapers, magazines, notebooks, laptops, e-books and folder

(76) Inventor: Renato Severino Severi Rivera, San Jose (CR)

Correspondence Address: DENNISON, SCHULTZ & MACDONALD, 1727 KING STREET, SUITE 105, ALEXANDRIA, VA, 22314, US

(21) Appl. No.: 10/581,023

(22) PCT Filed: Nov. 26, 2004
(86) PCT No.: PCT/CR04/00006

§ 371 Date: May 30, 2006

(30) Foreign Application Priority Data
Nov. 27, 2003 (CR) 2003-0261

(51) Int. Cl. B42D 1/00

(52) U.S. Cl. 281/27.3

(57) ABSTRACT

The present Patent of Invention and its subdivisions refer to a state-of-the-art and innovative device that consists in a fastener of books, newspapers, magazines, paper pads, laptops, e-books and binders which structures possess a special design that provides the user an unlimited number of characteristics and functions highlighting among them the portability, maneuverability, functionality and easy reading of books, newspapers, magazines, paper pads, laptops and e-books. Since the structure is manufactured with light and aesthetic materials, it will be available in different thickness and many sizes as small, standard, medium, large and extra-large. This state-of-the-art fastener of books, newspapers, magazines, paper pads, laptops, e-books and binders was conceived to satisfy the needs in the market of accessories for the reader and user of portable computers (laptops) and electronic books (e-books); providing an extremely useful and light structure that satisfies the multiple needs of these users regarding the use and handling of all reading material like books, newspapers, magazines, notebooks, portable computers (laptops) and electronic books (e-book).

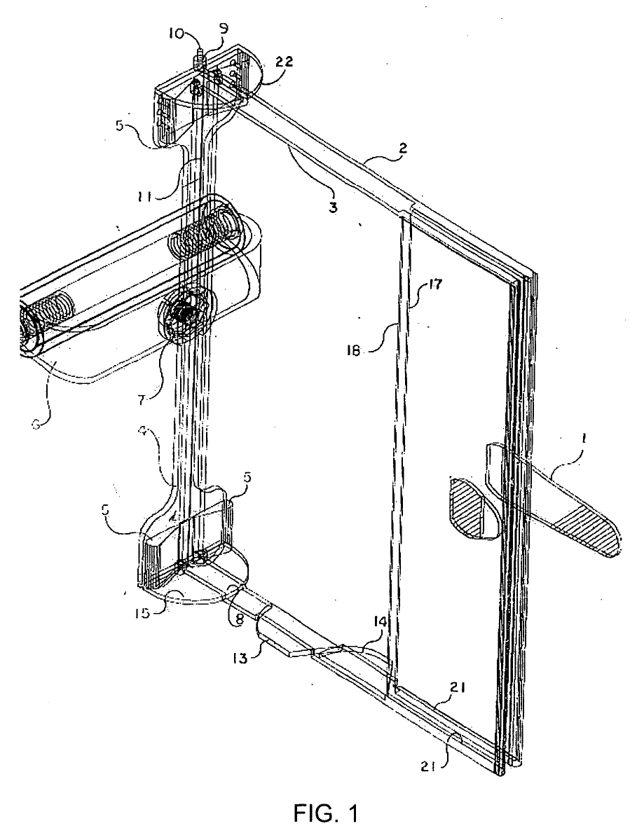

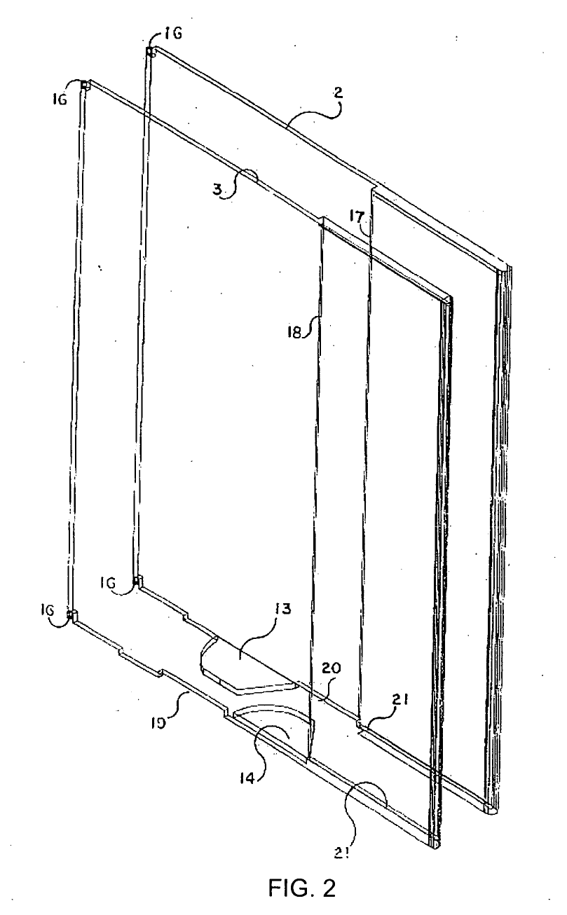

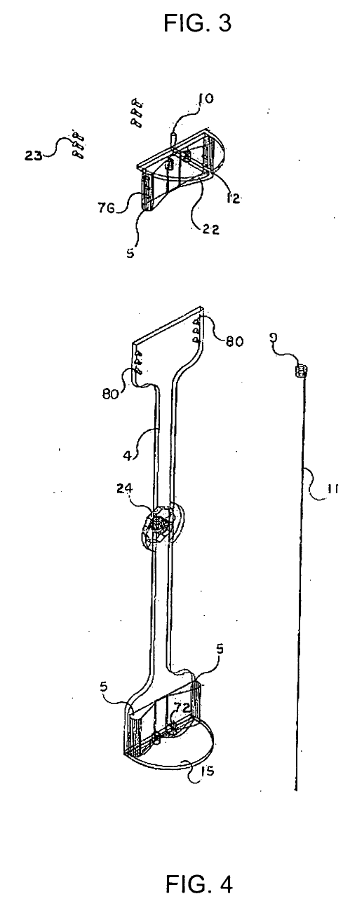

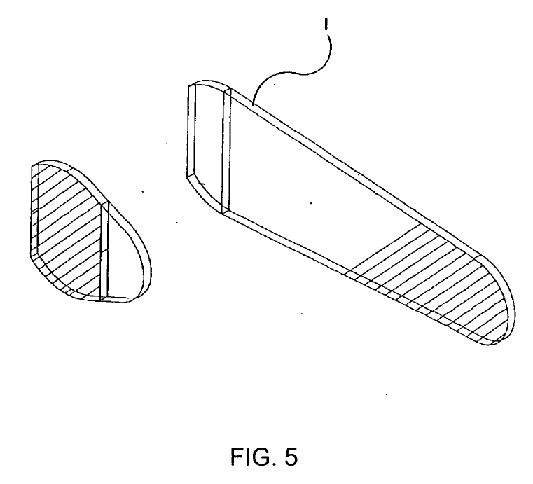

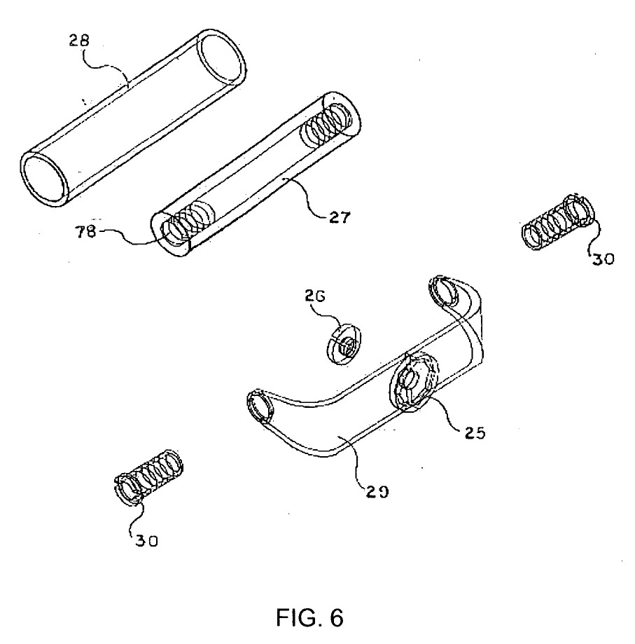

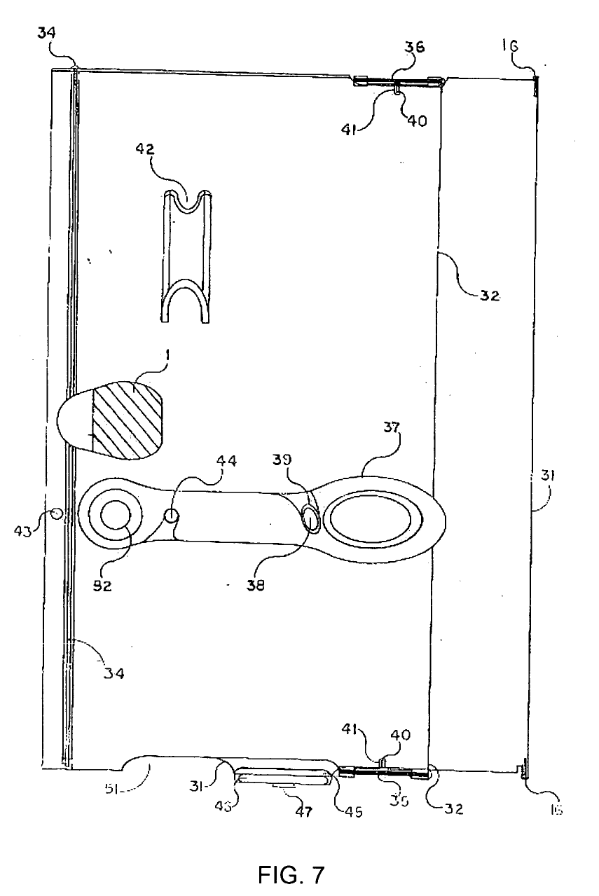

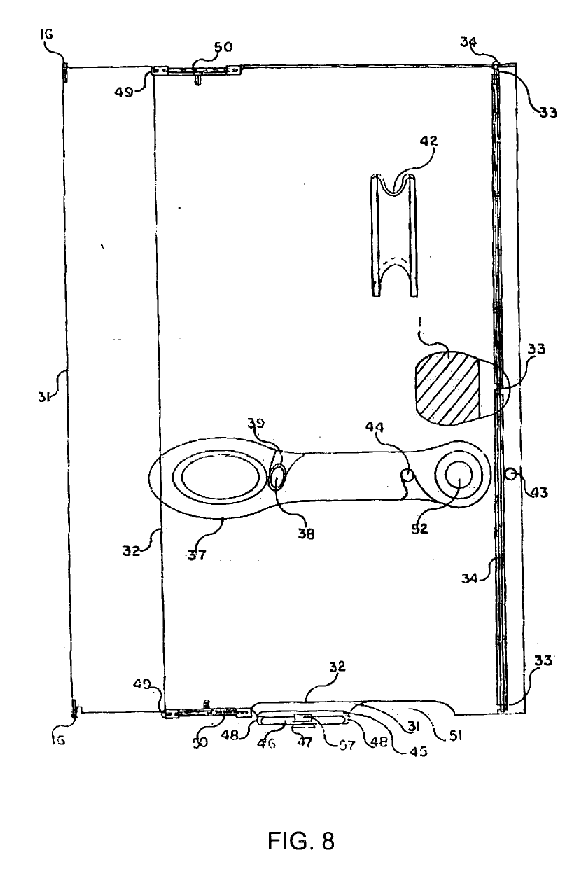

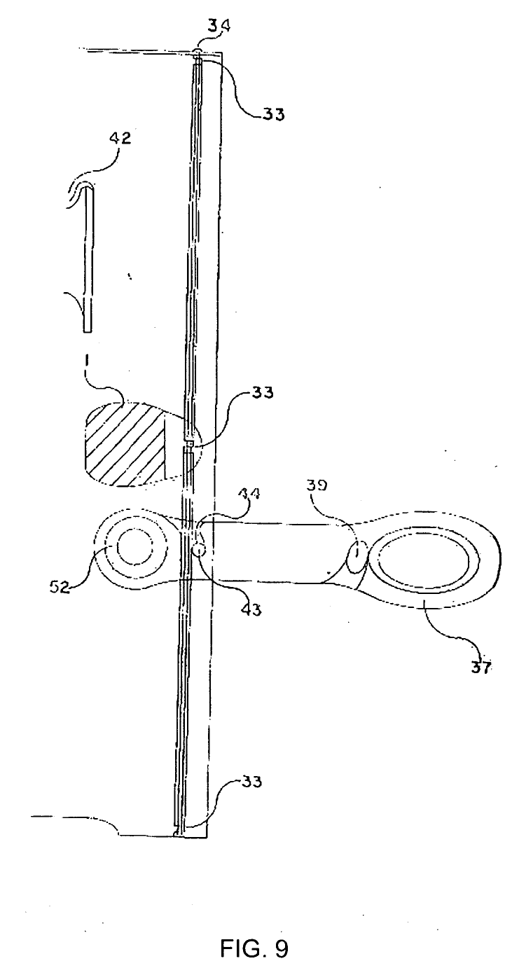

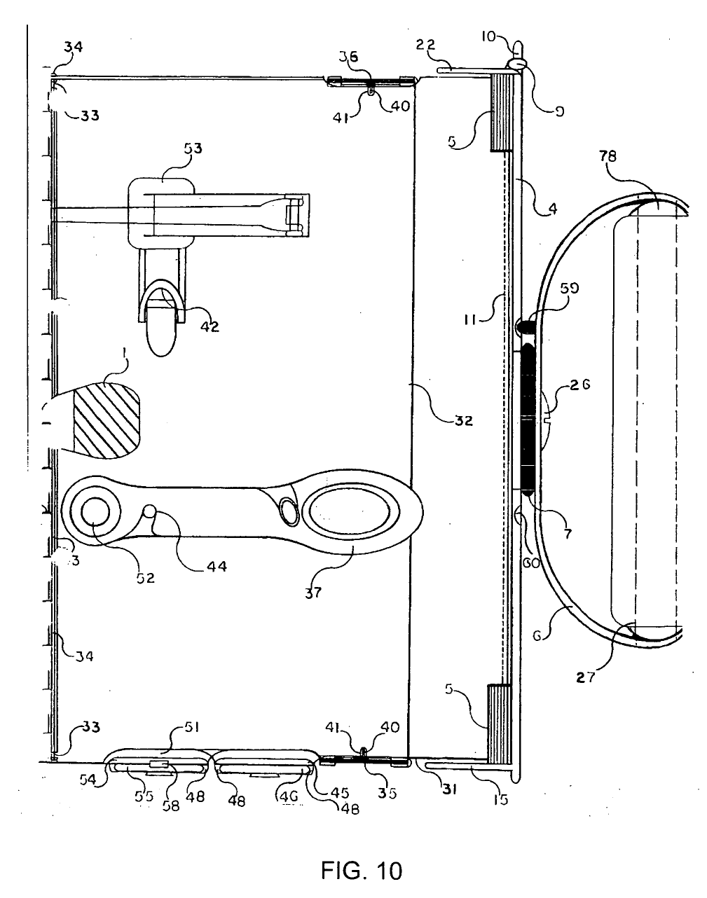

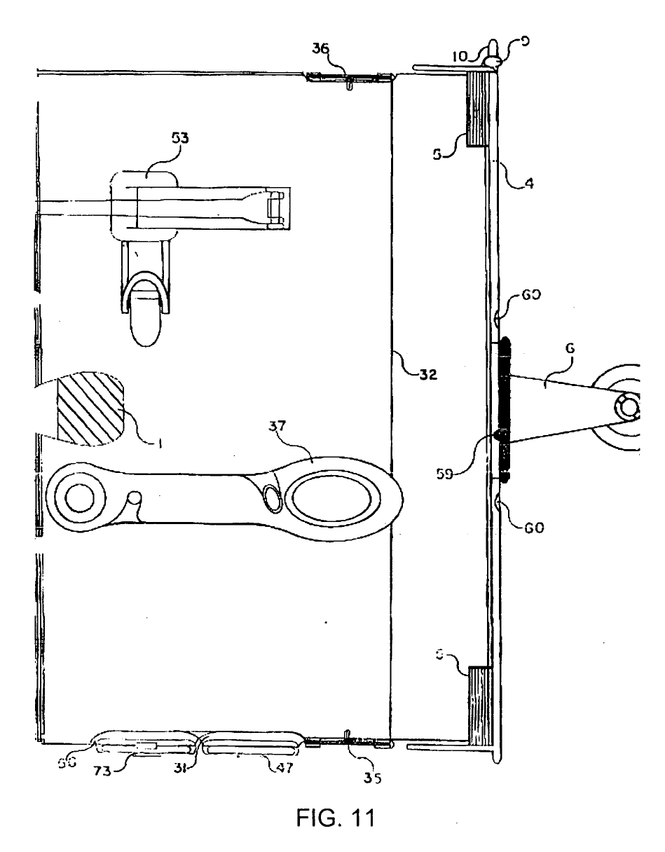

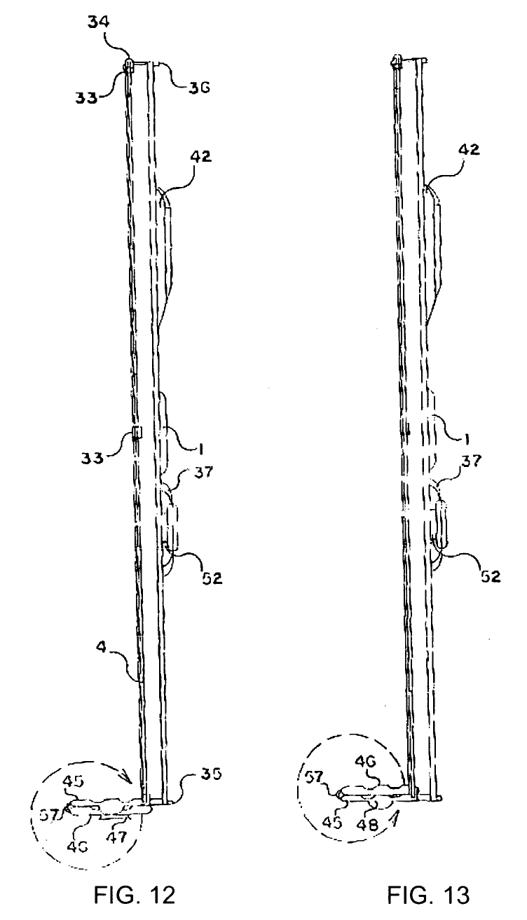

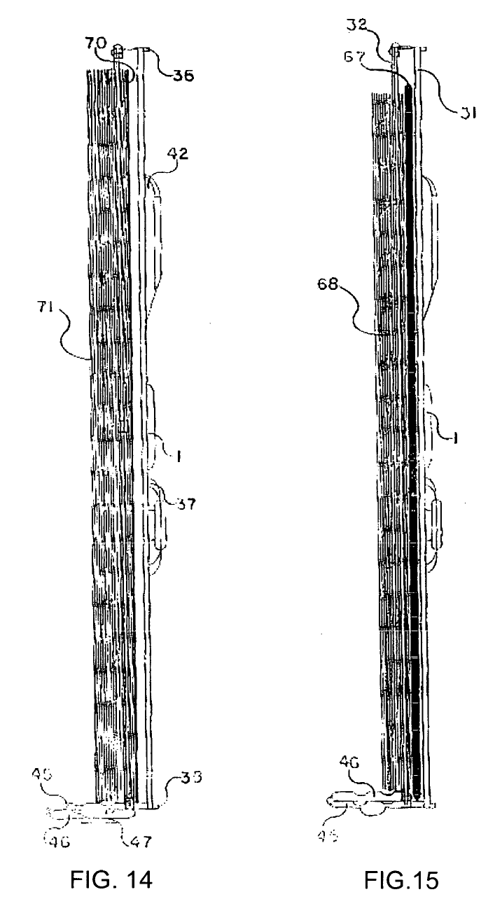

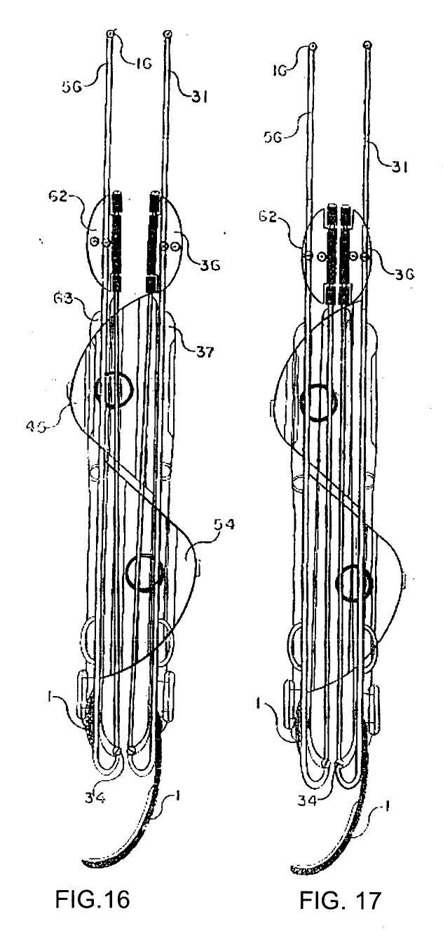

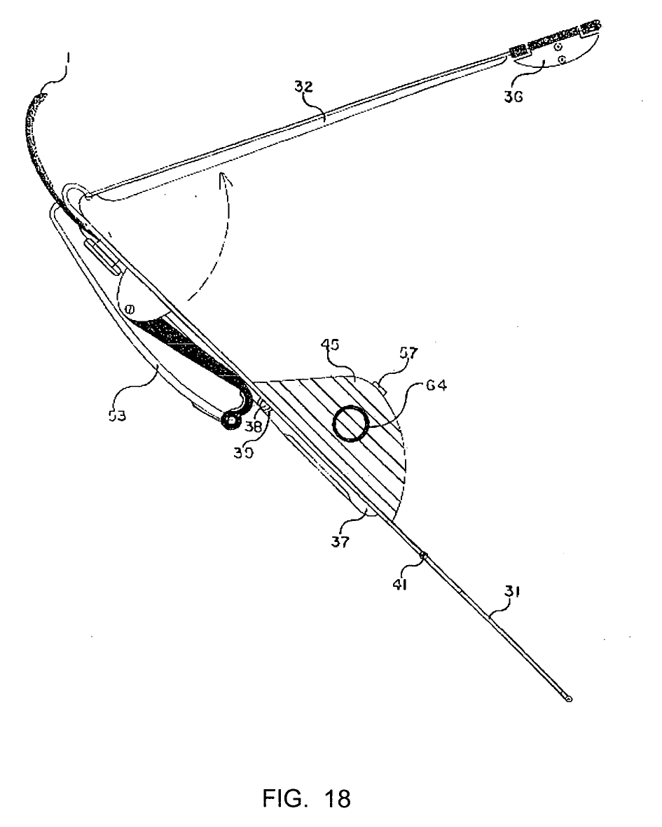

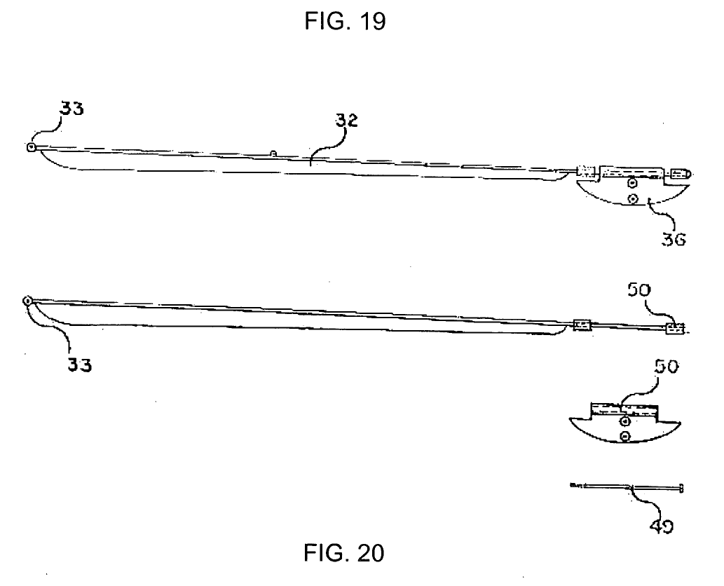

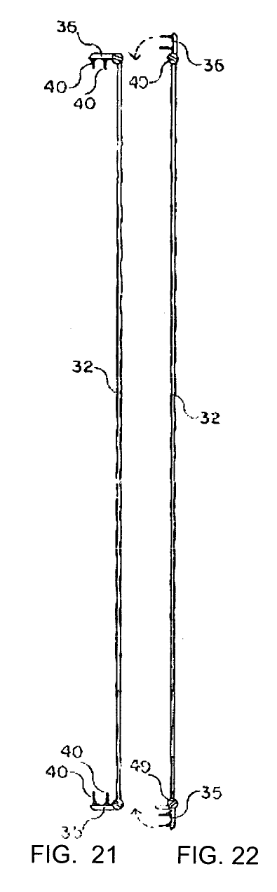

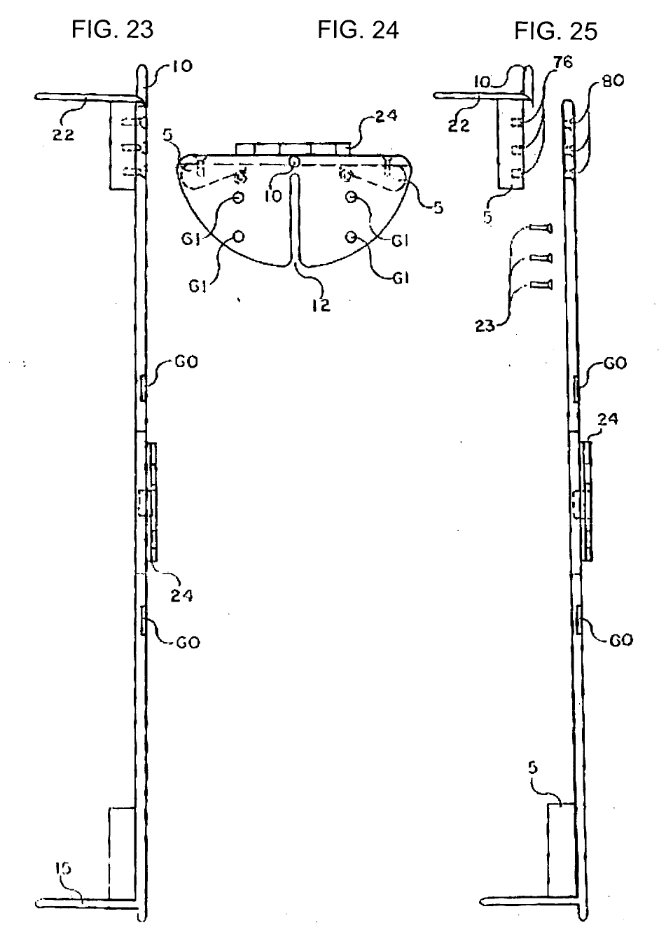

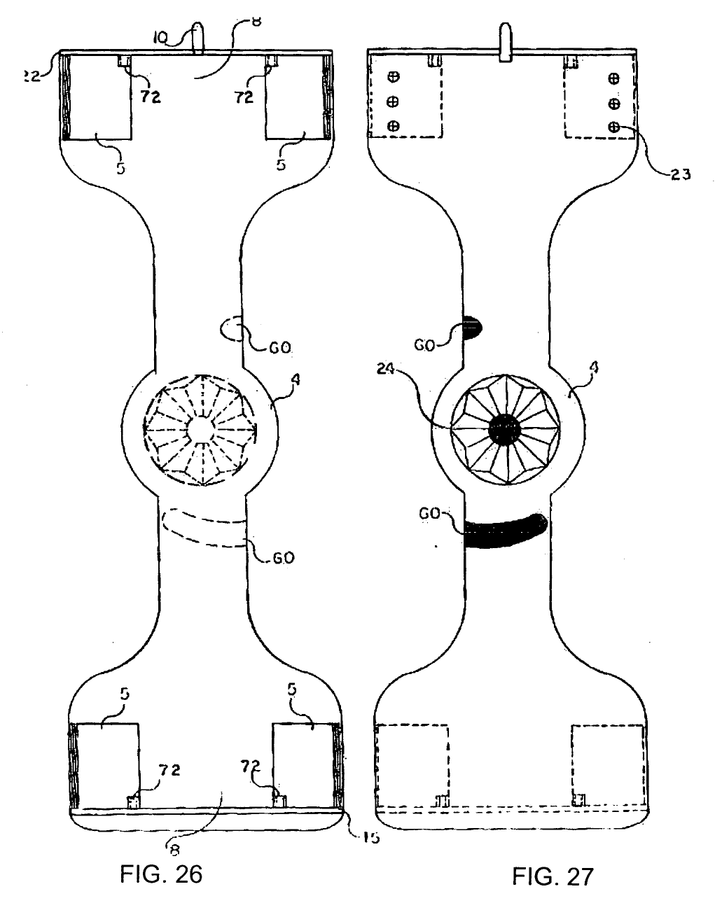

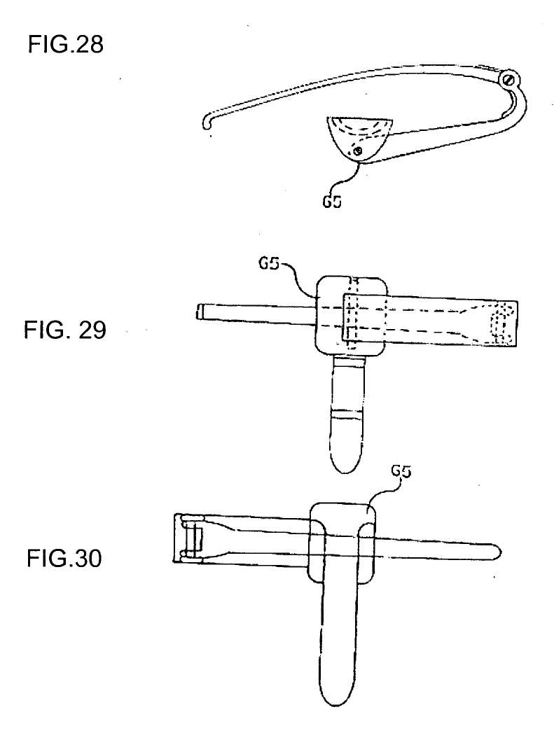

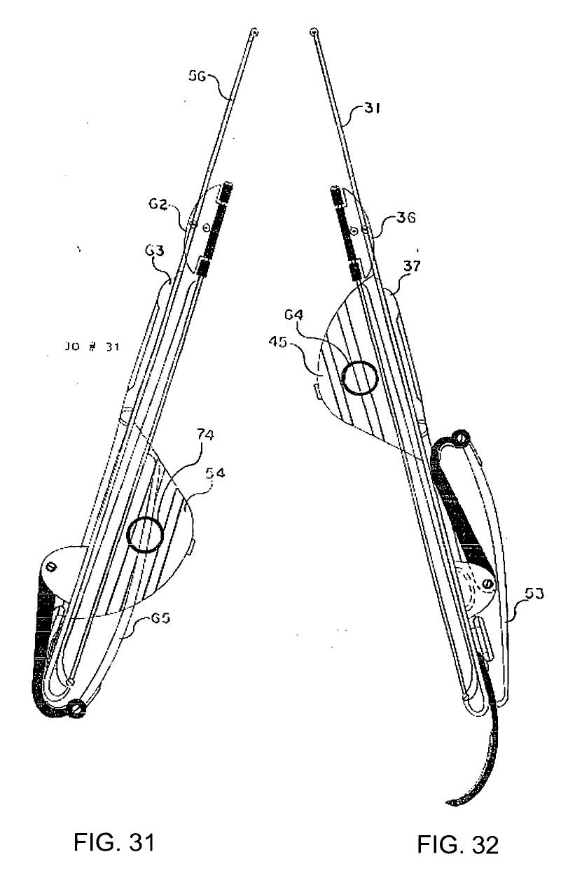

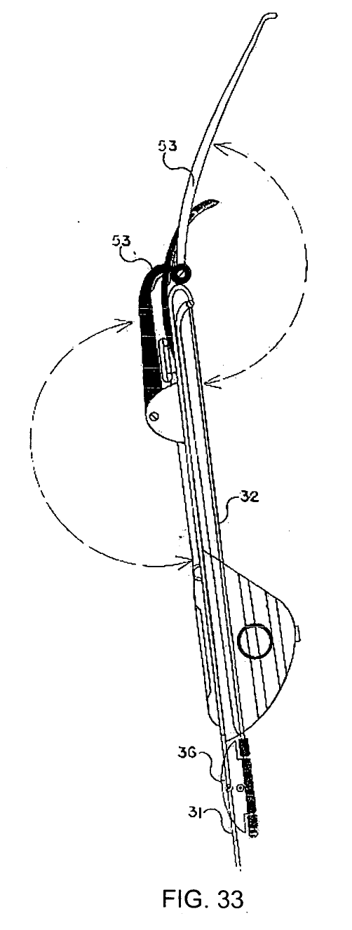

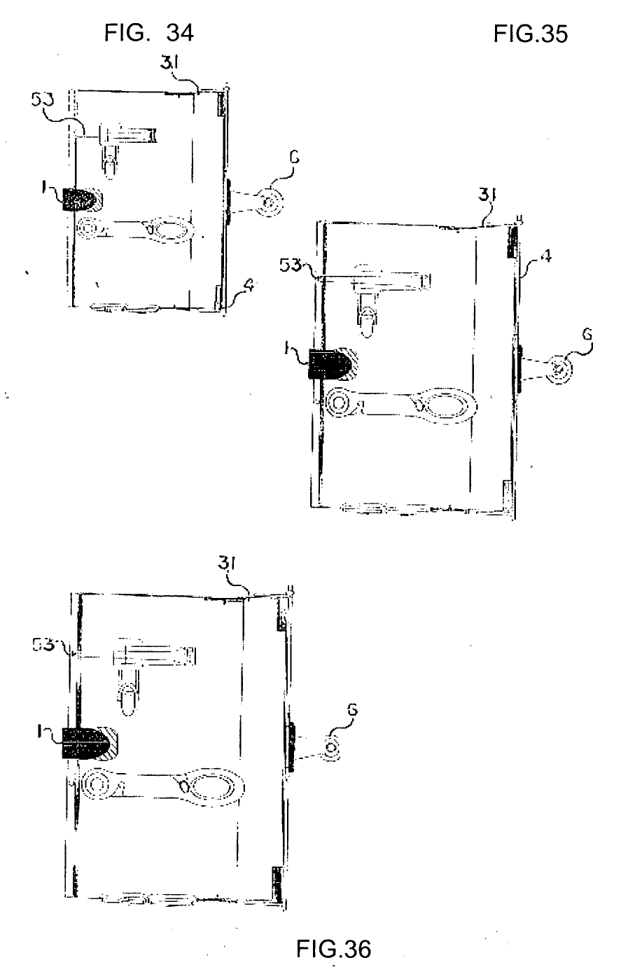

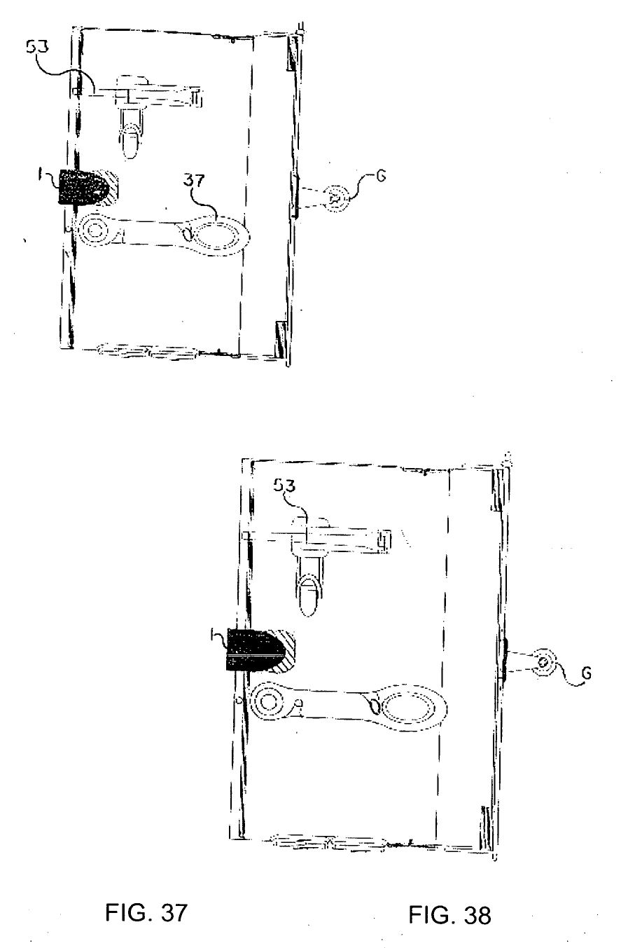

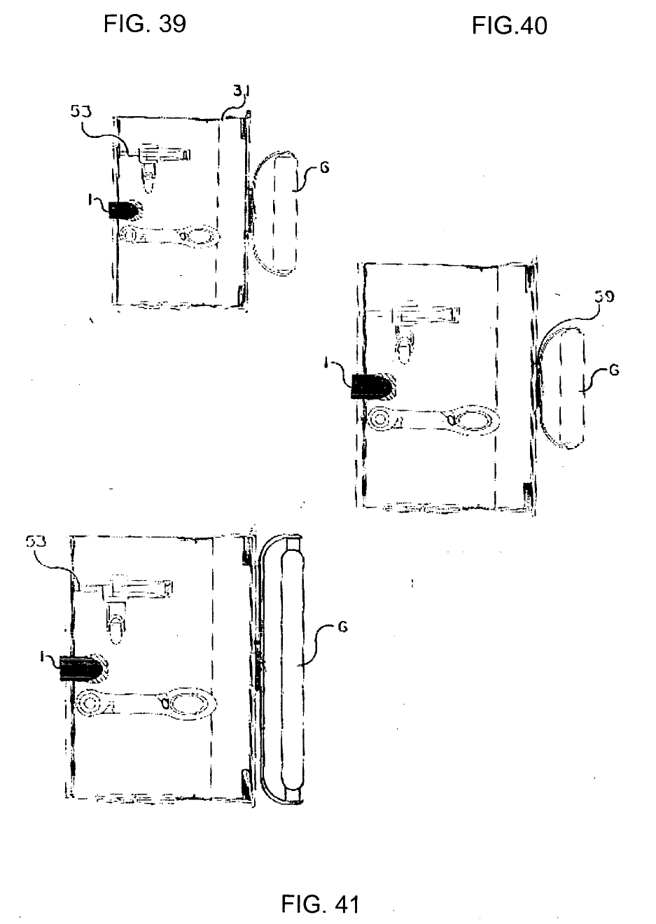

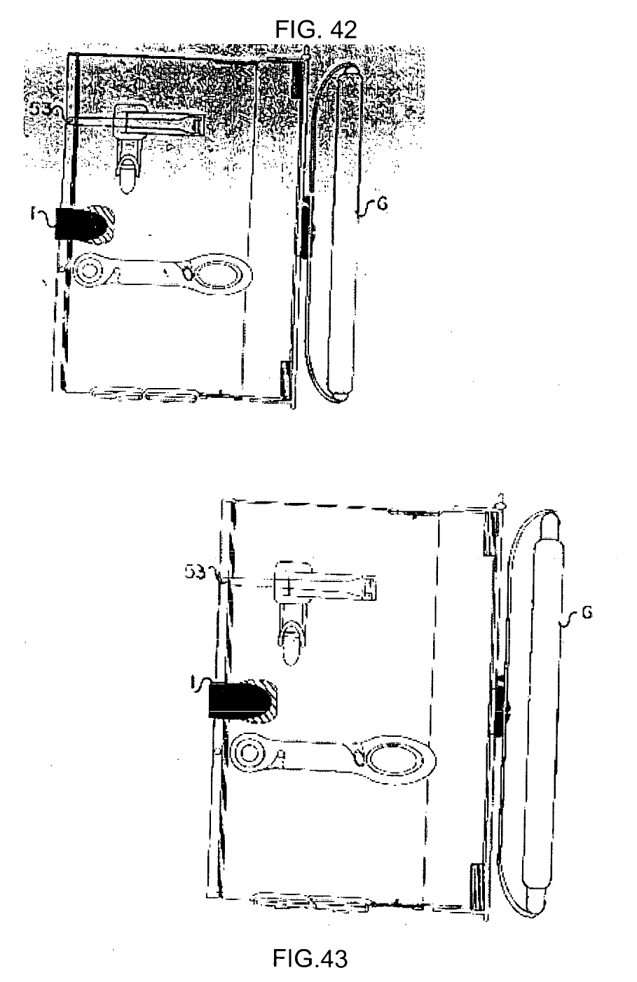

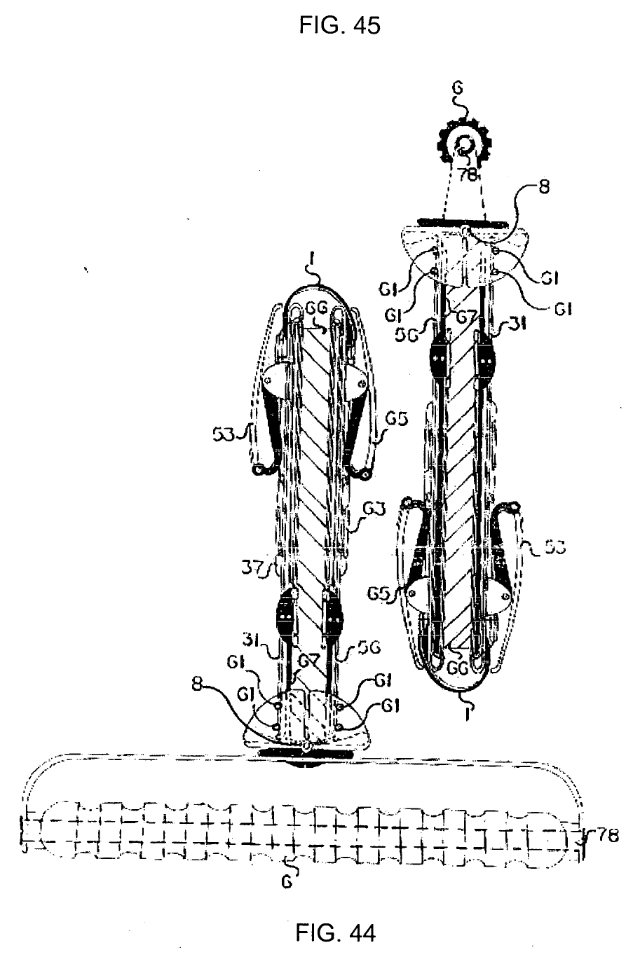

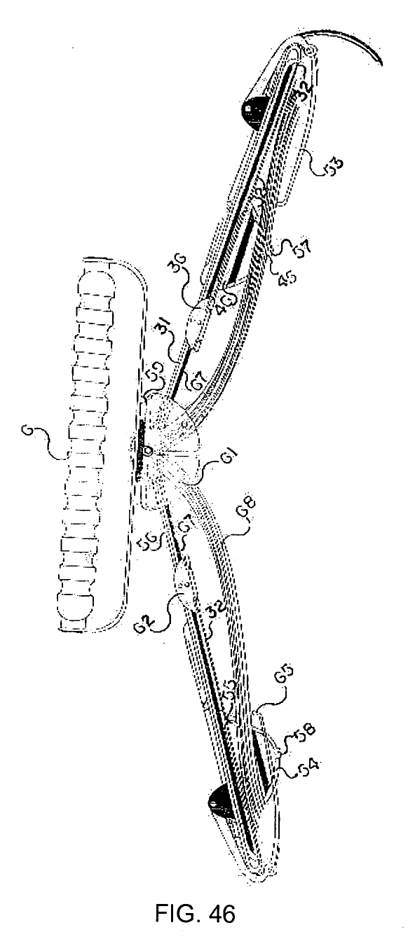

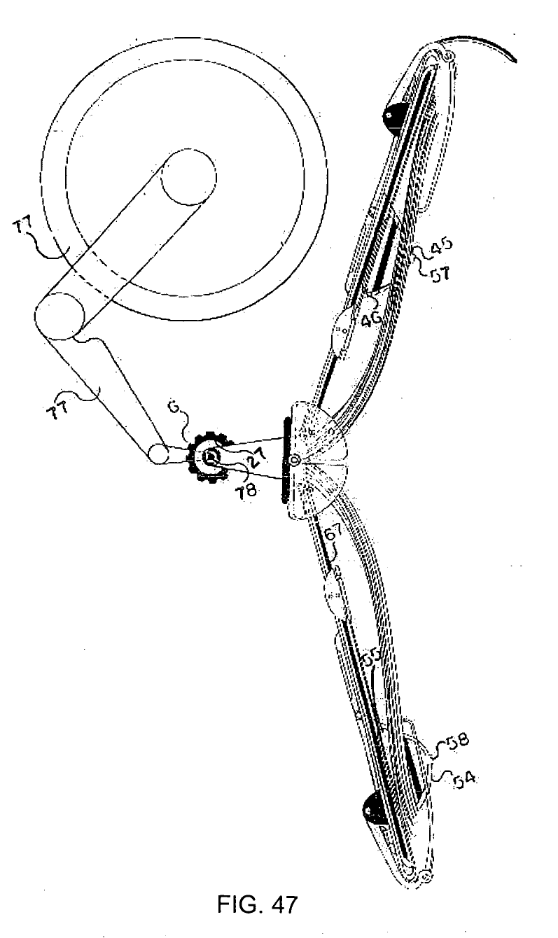

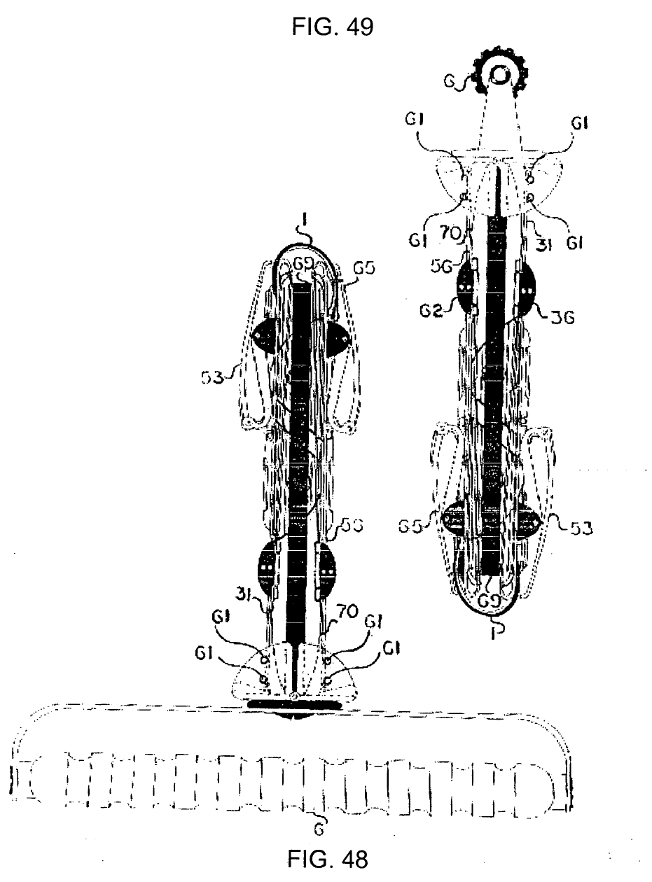

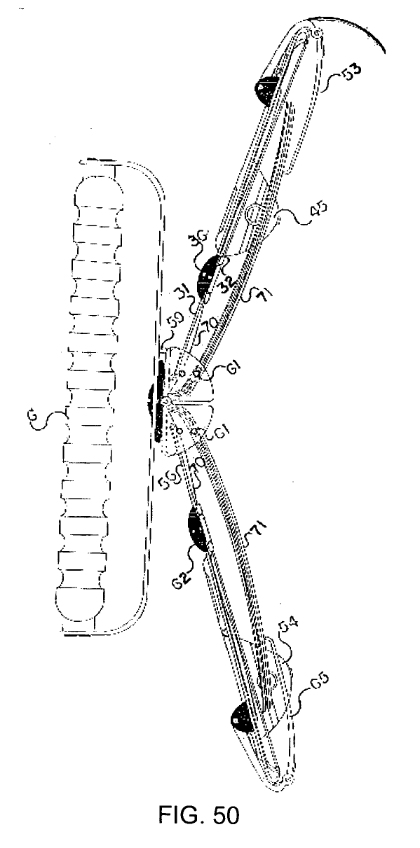

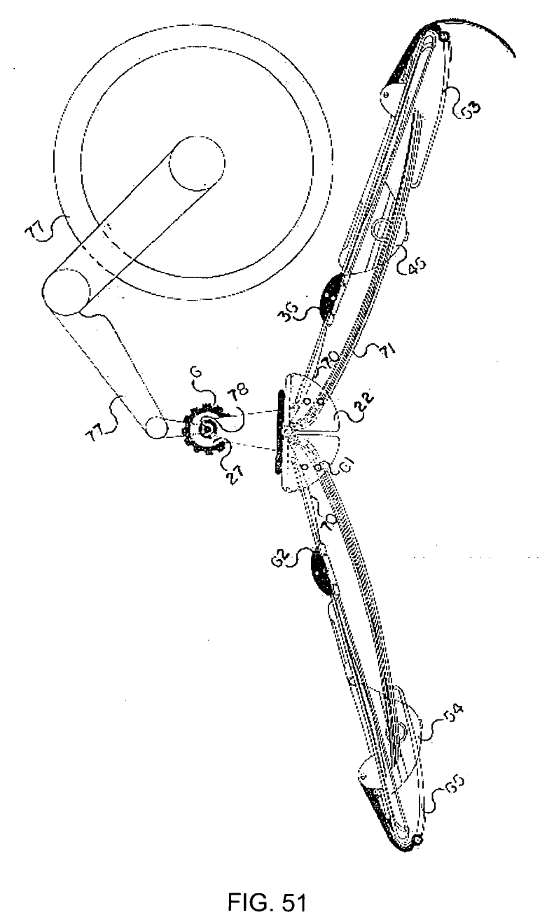

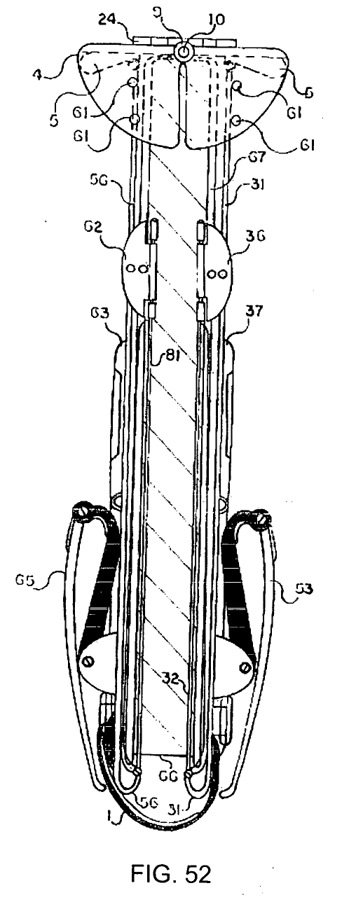

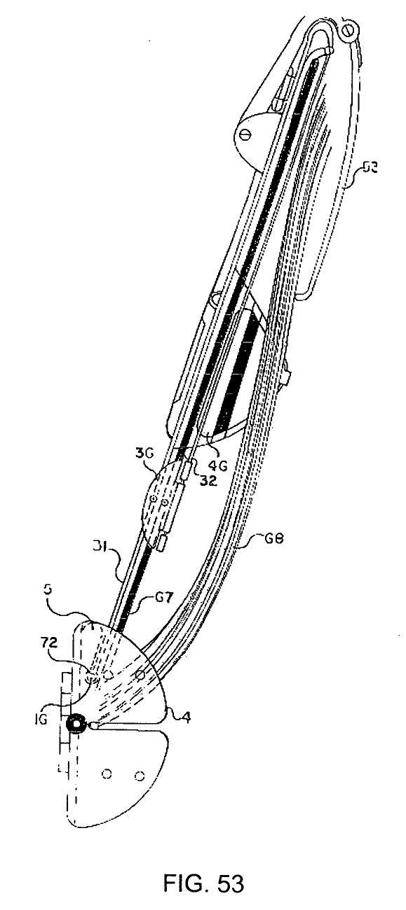

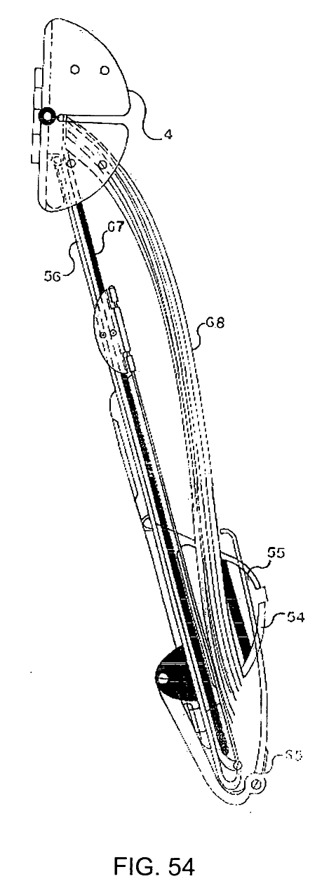

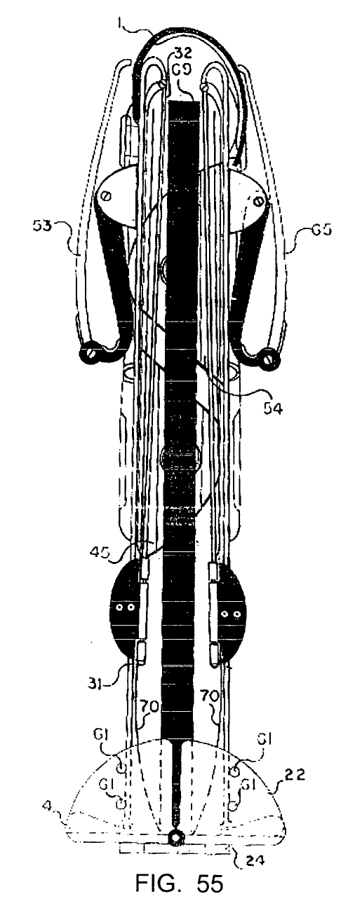

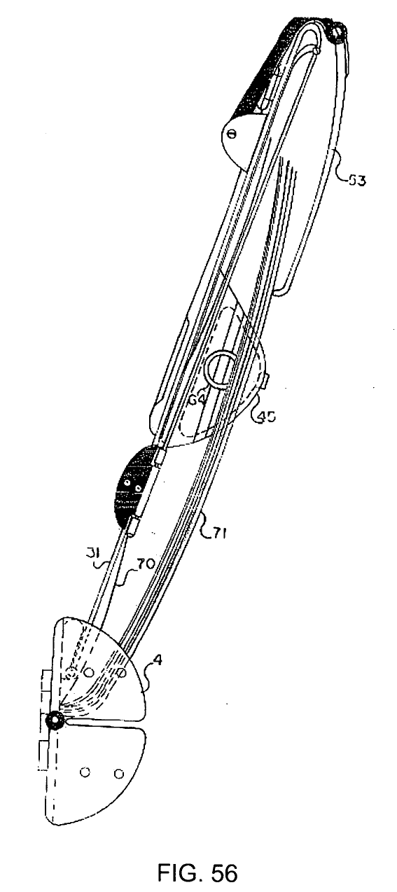

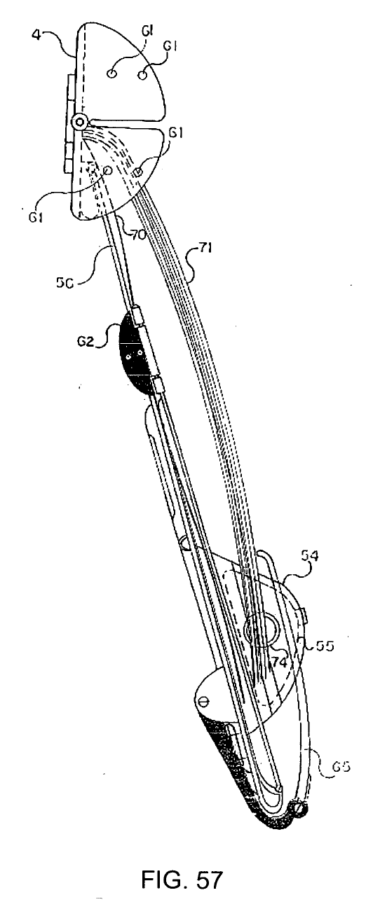

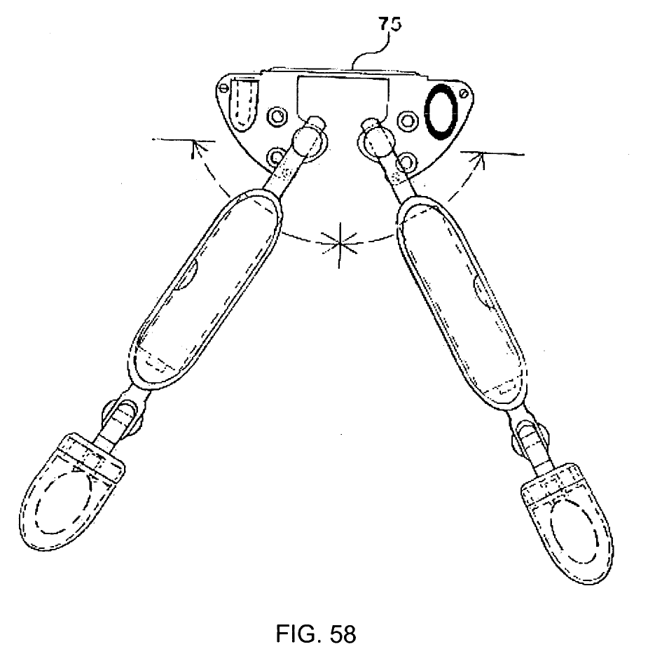

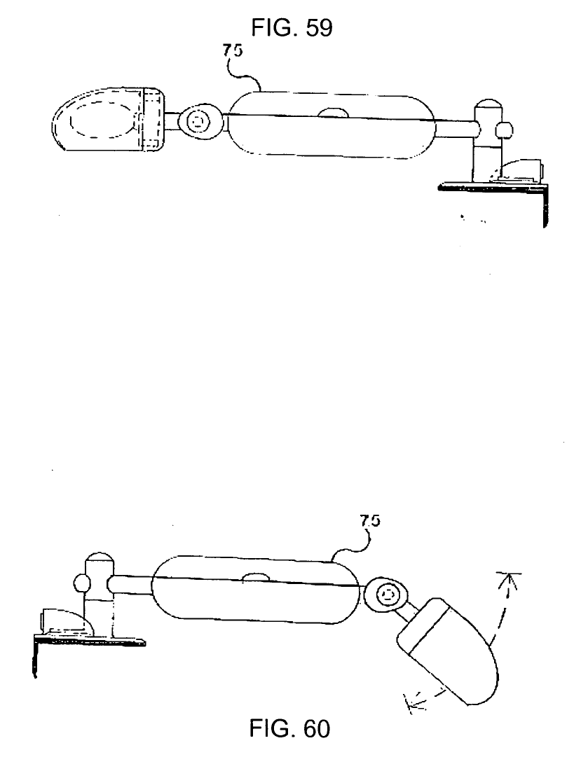

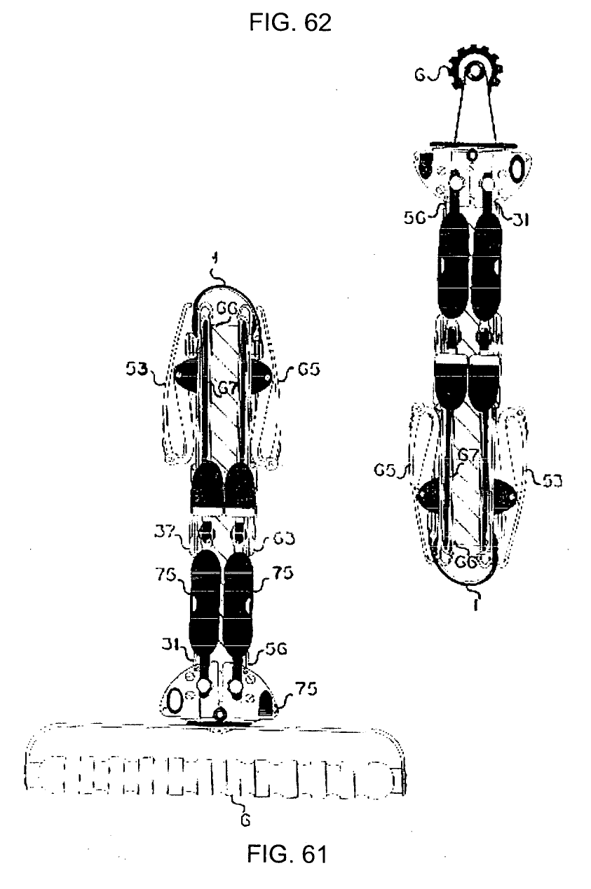

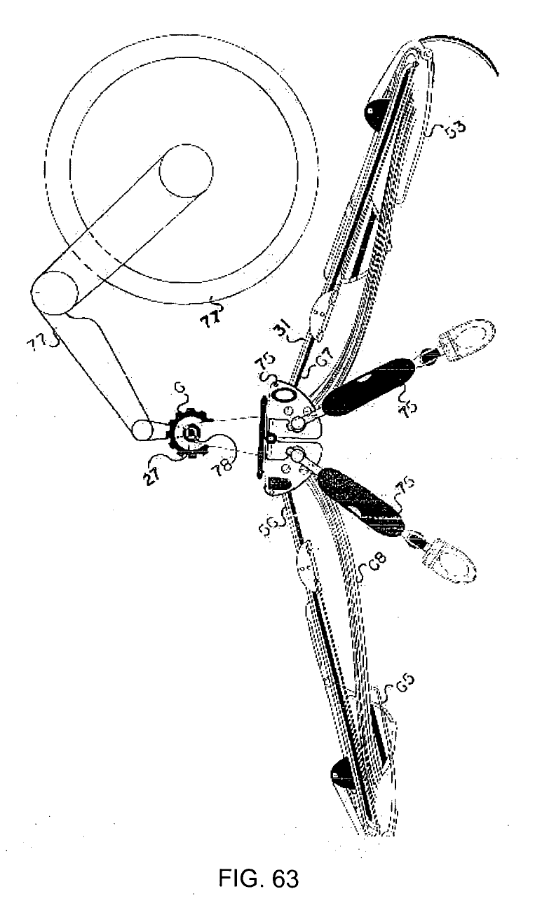

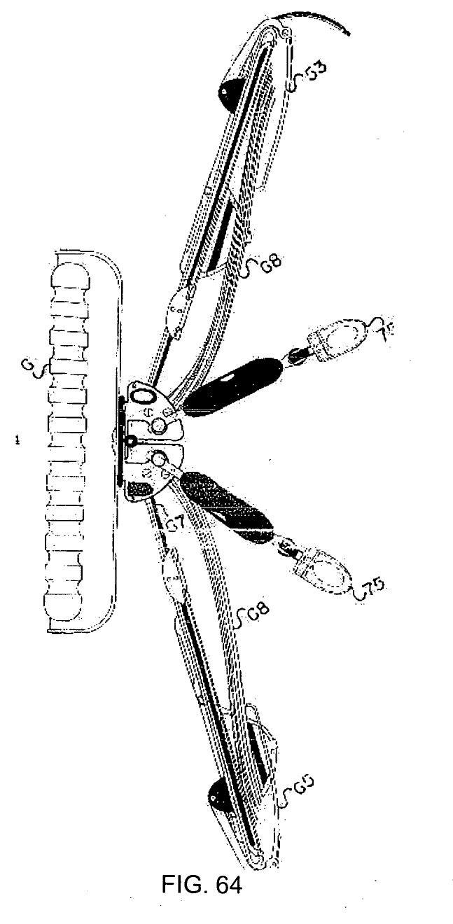

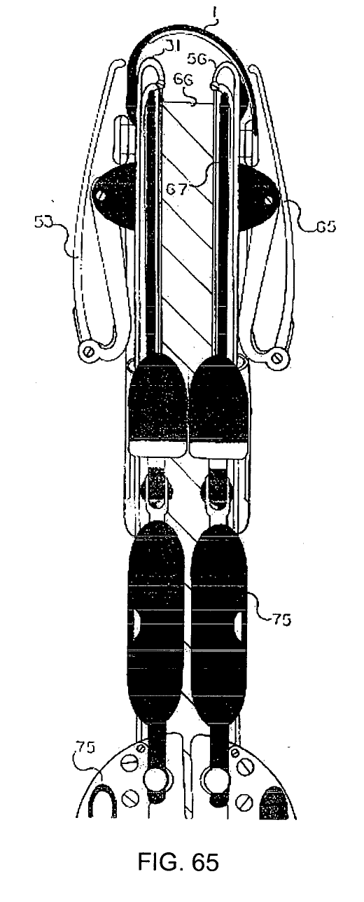

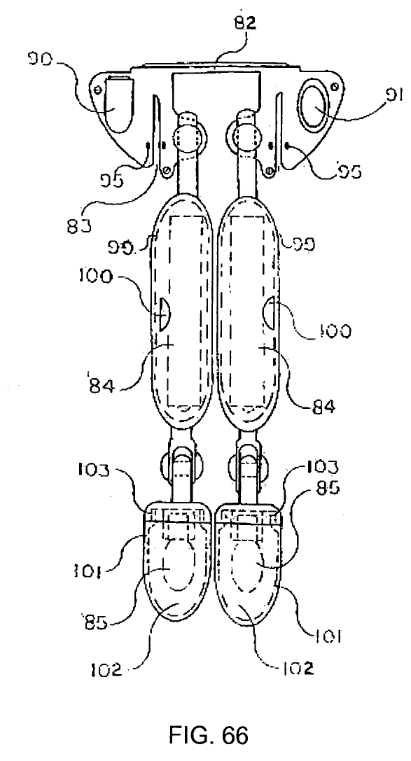

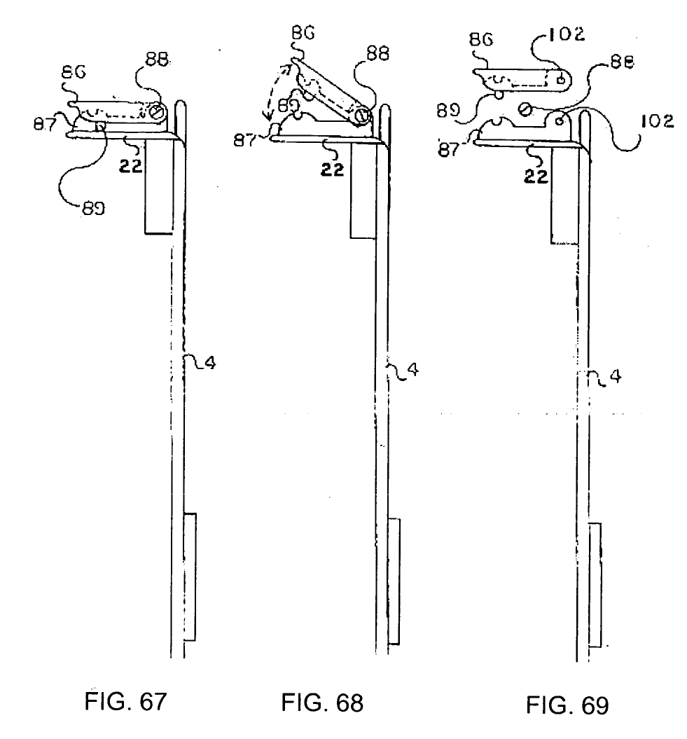

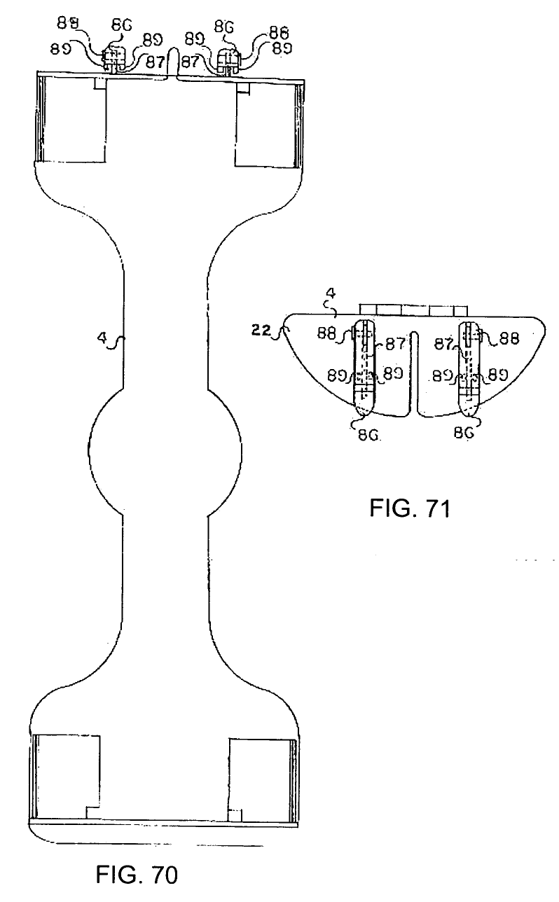

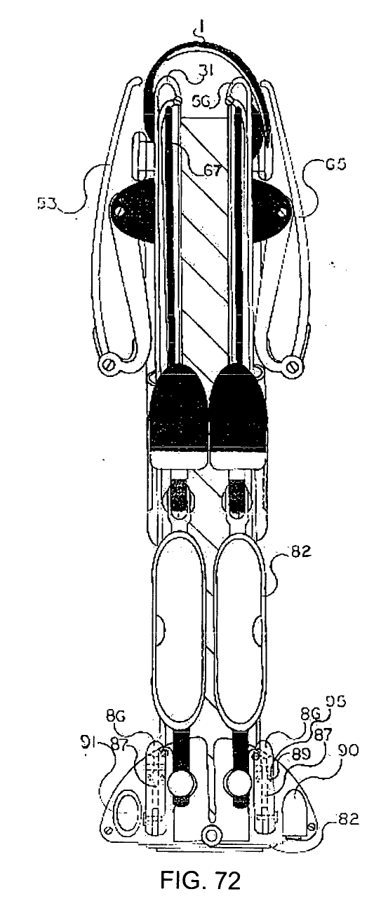

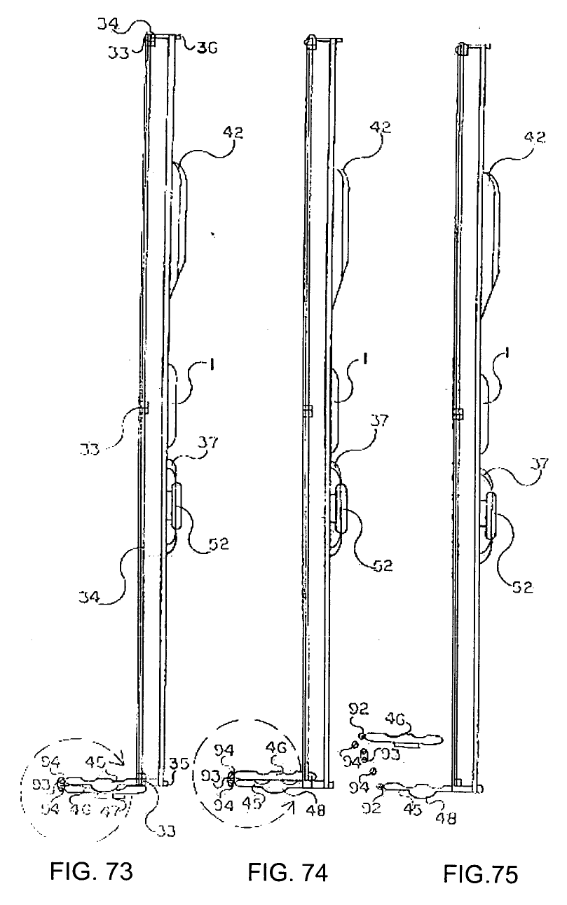

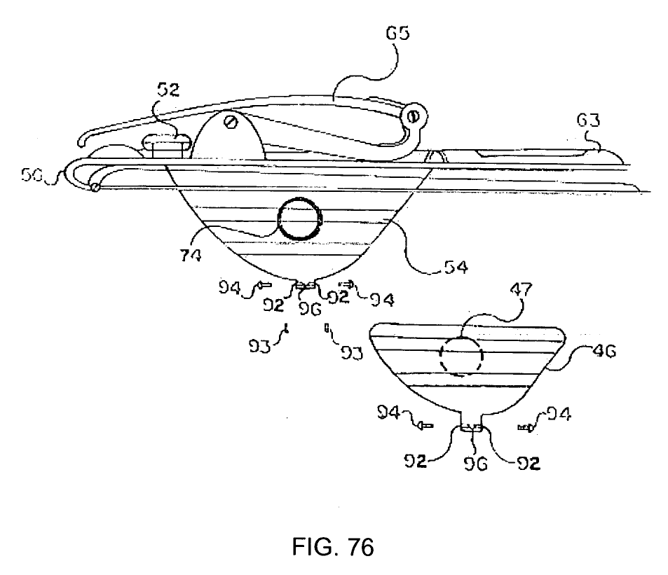

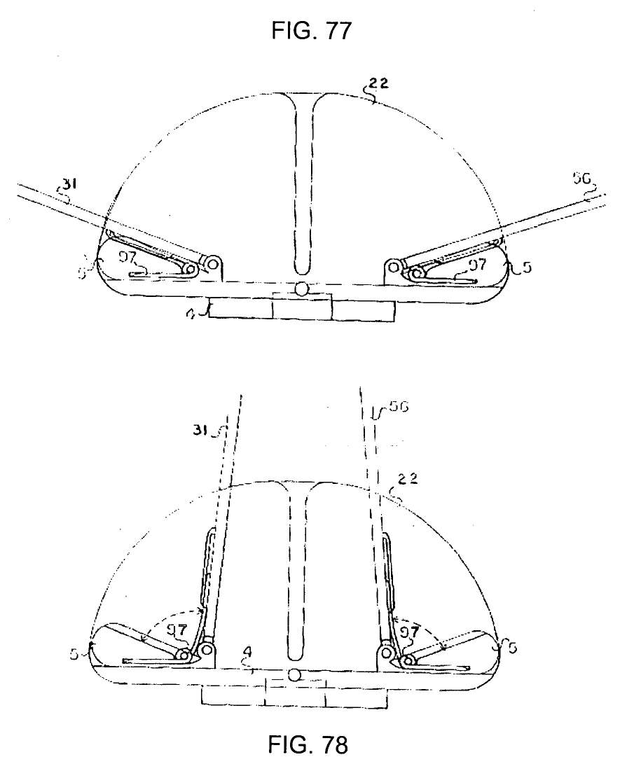

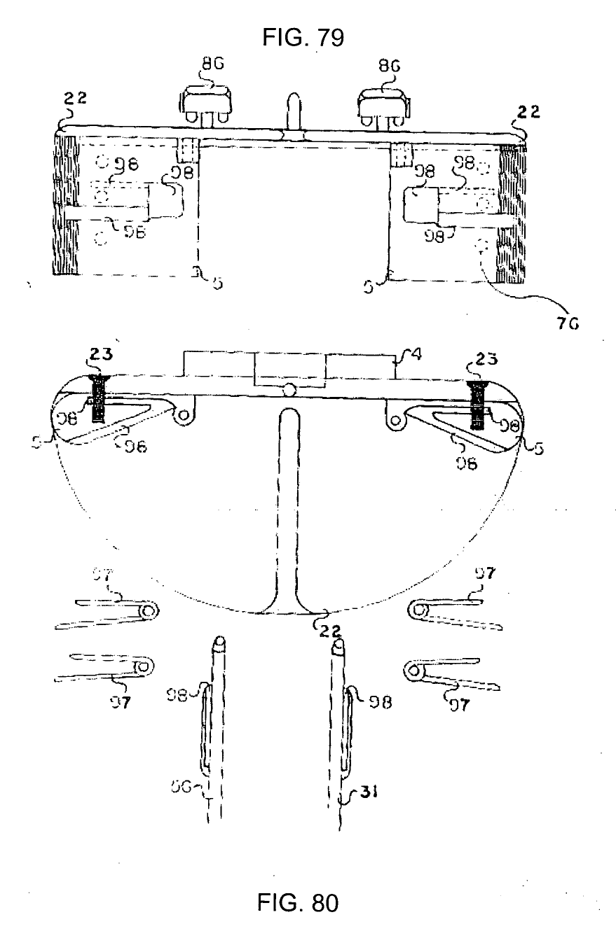

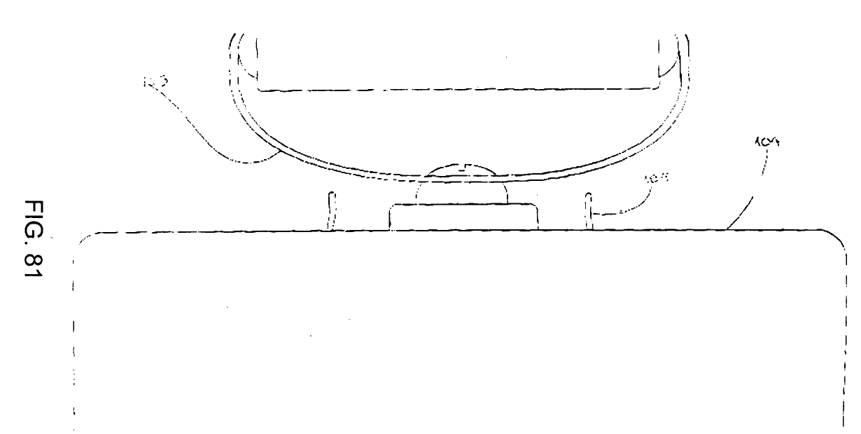

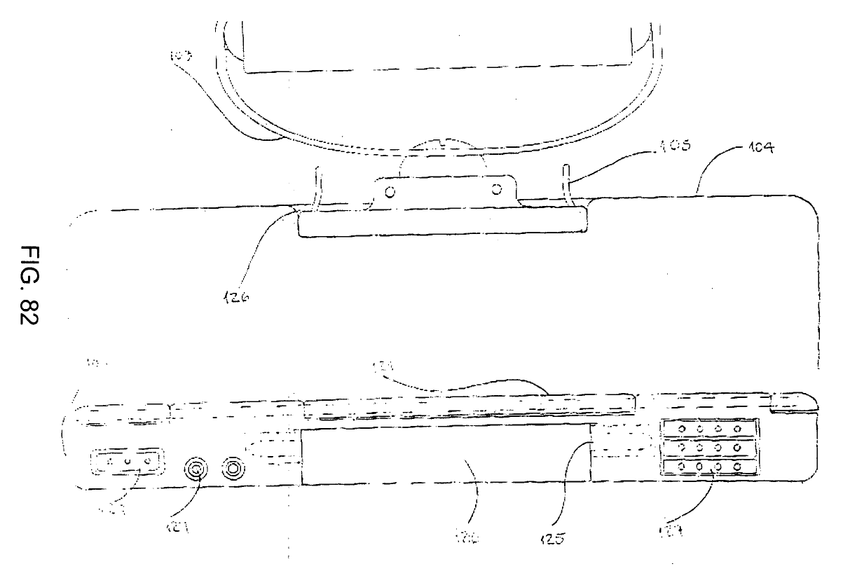

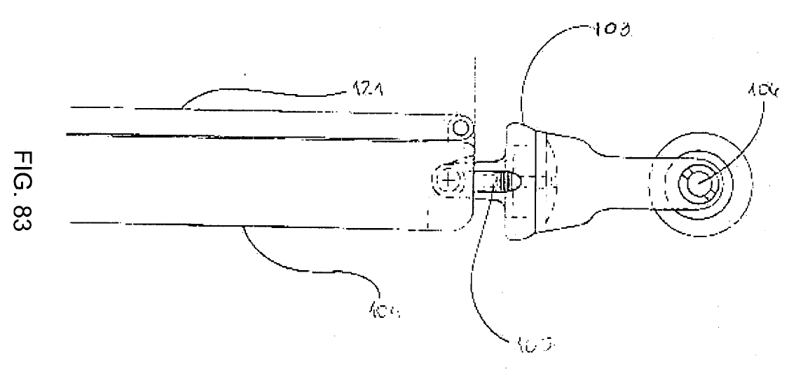

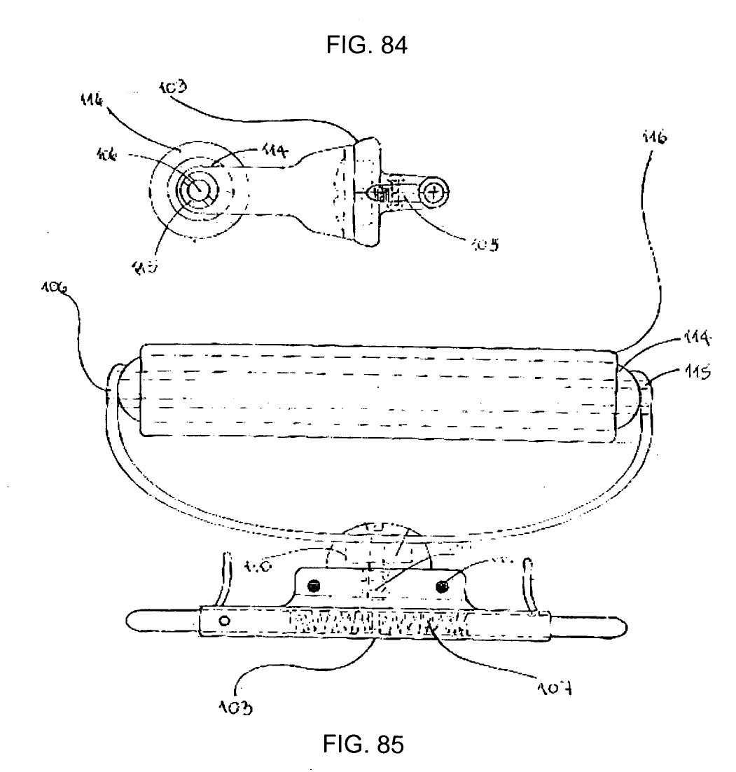

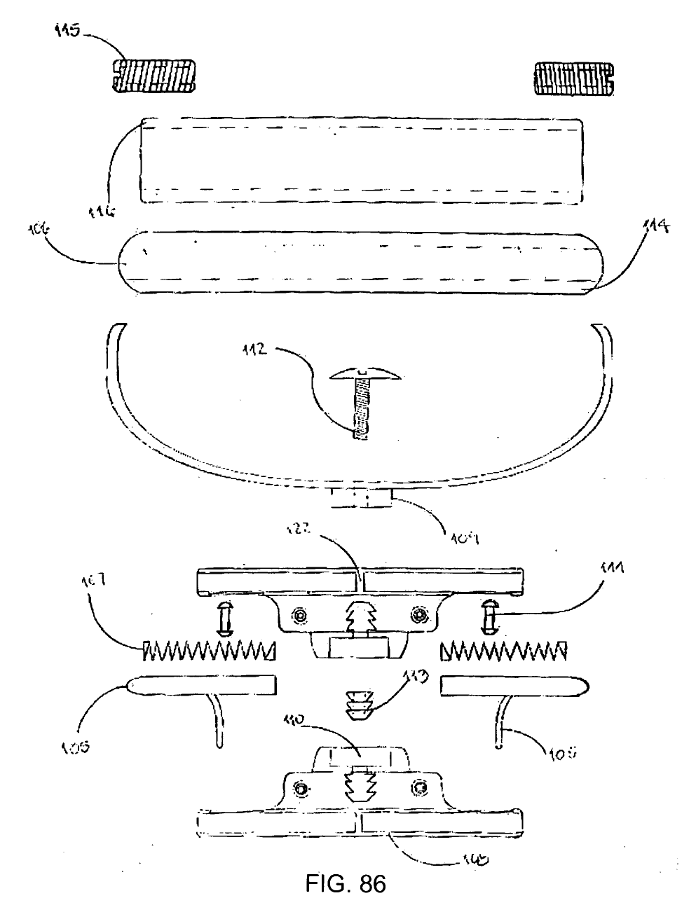

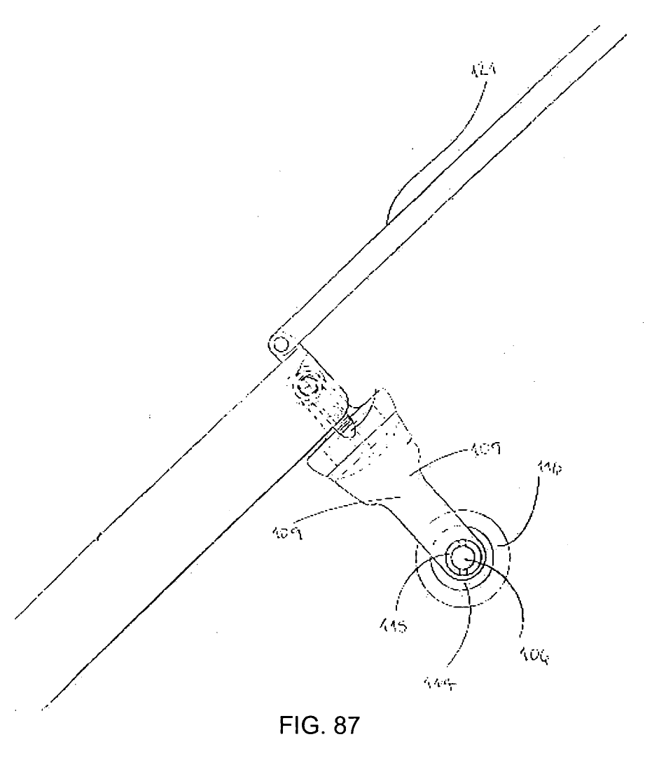

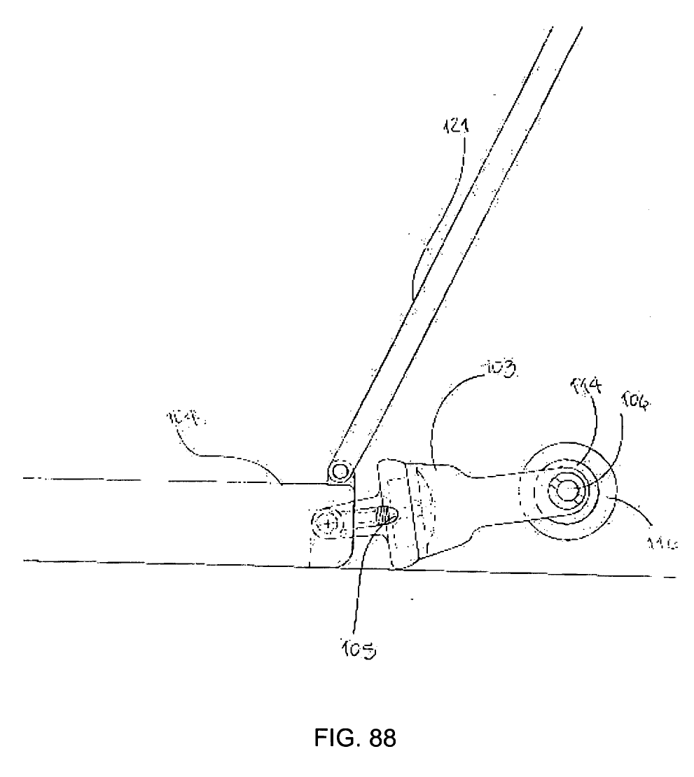

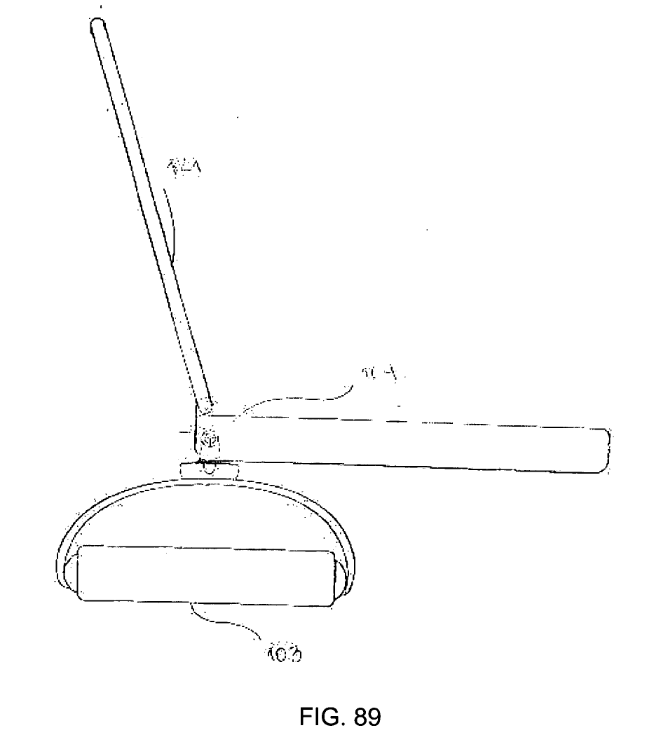

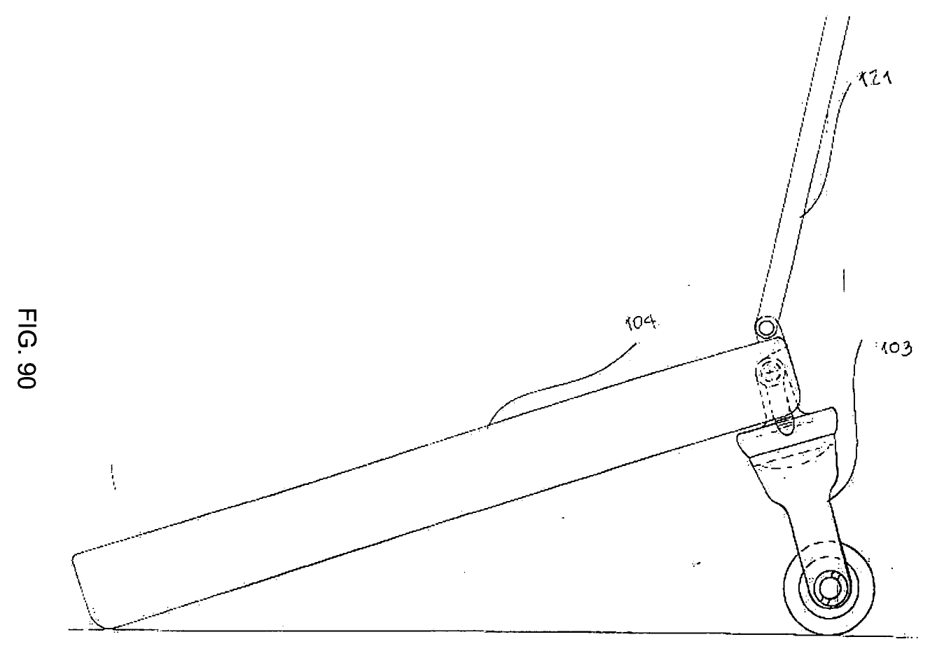

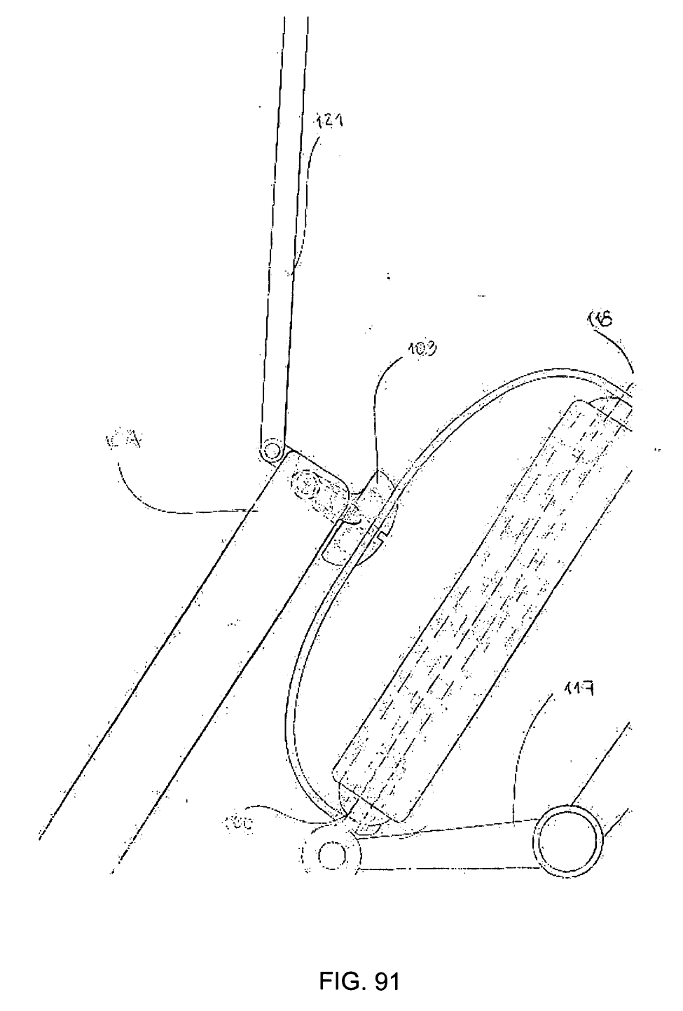

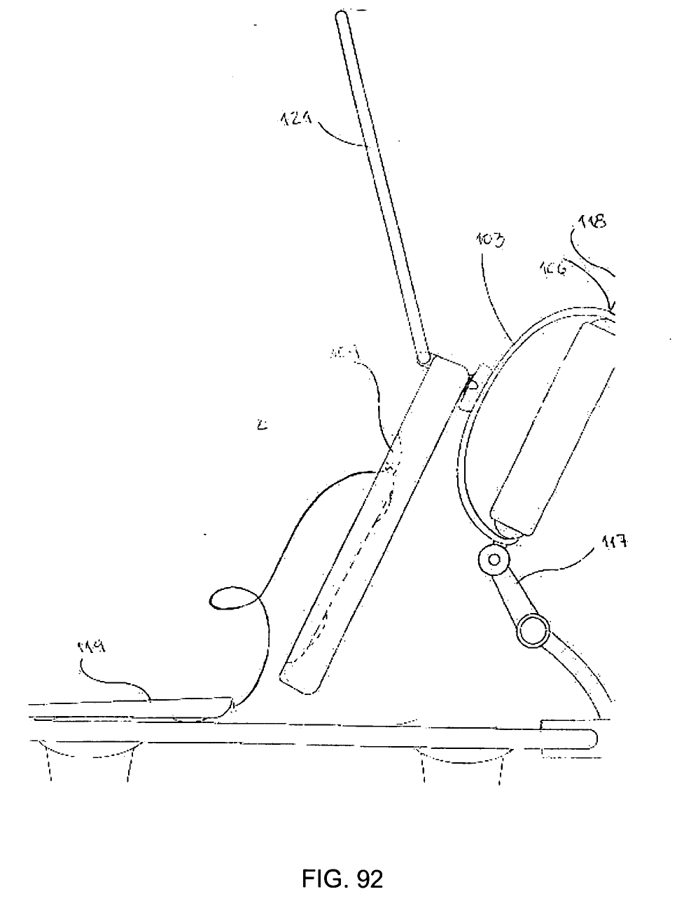

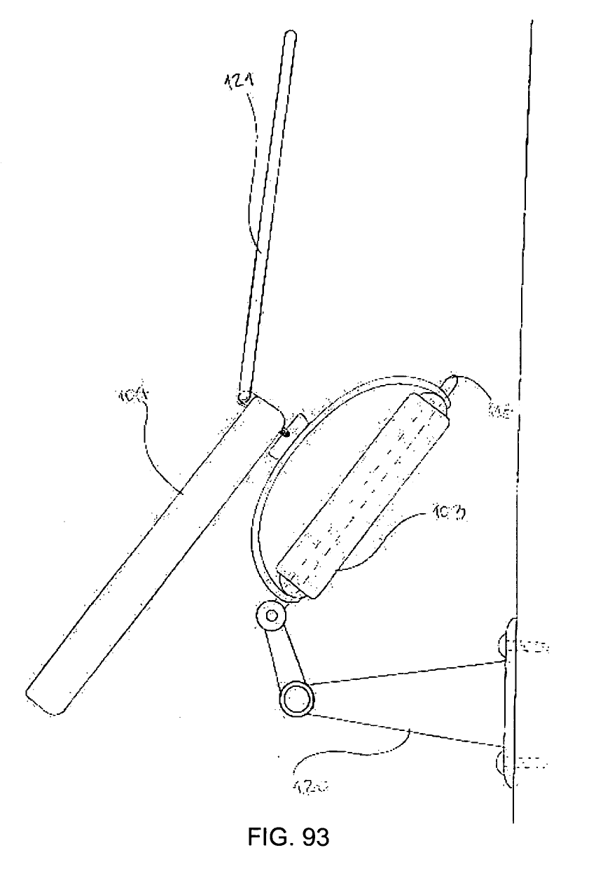

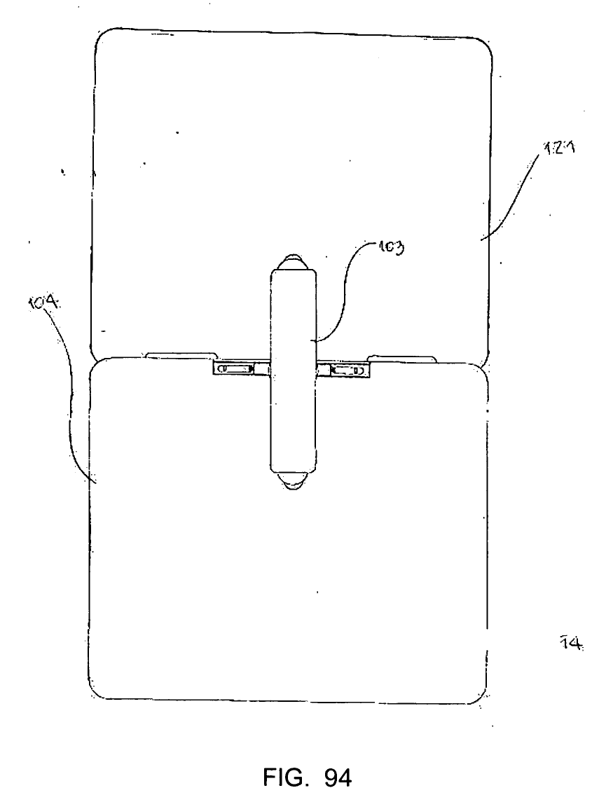

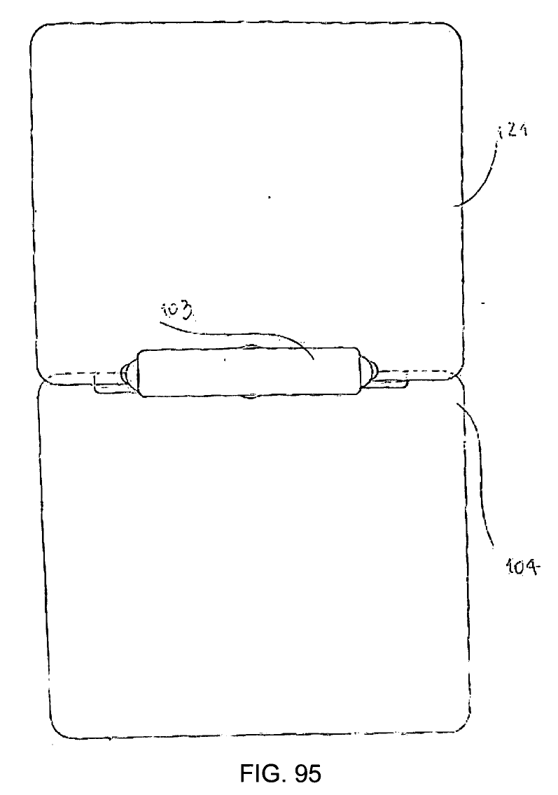

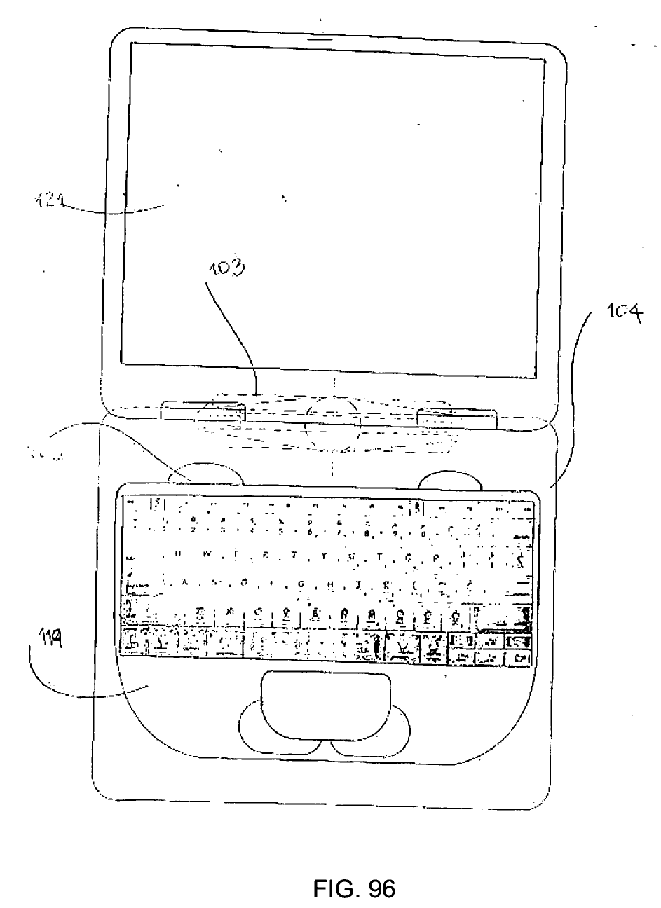

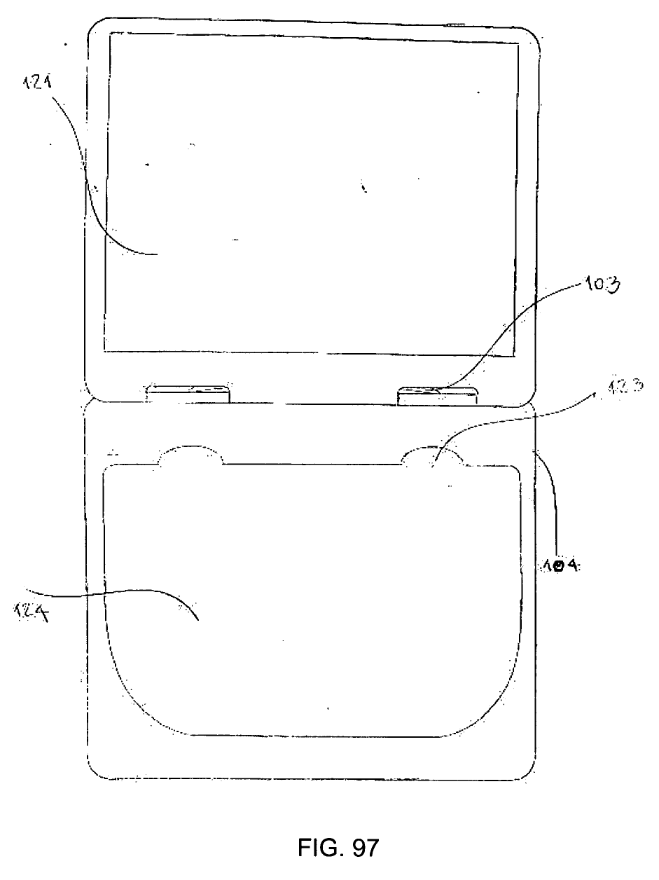

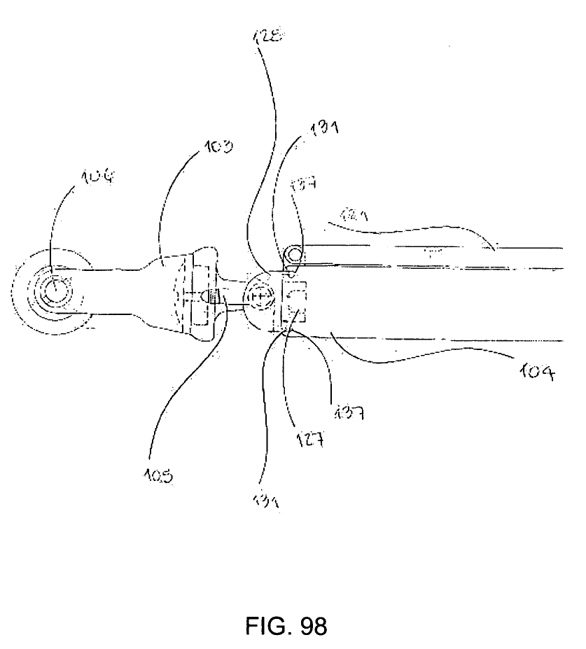

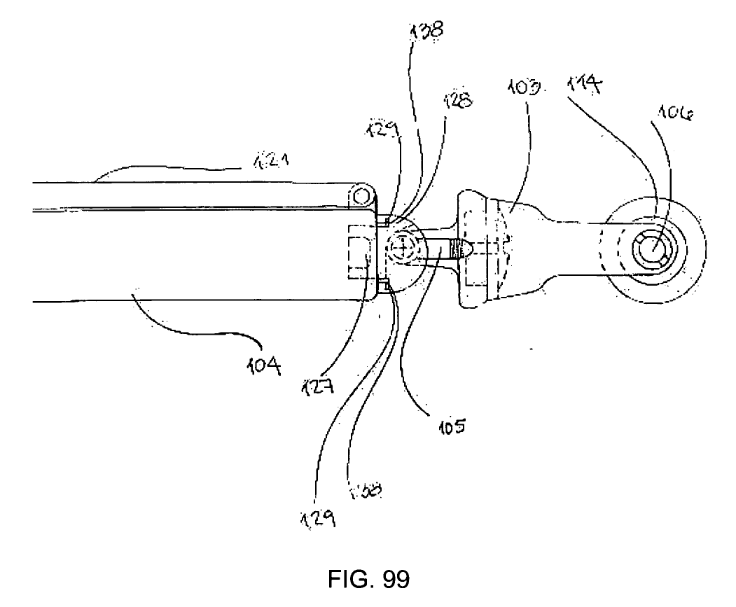

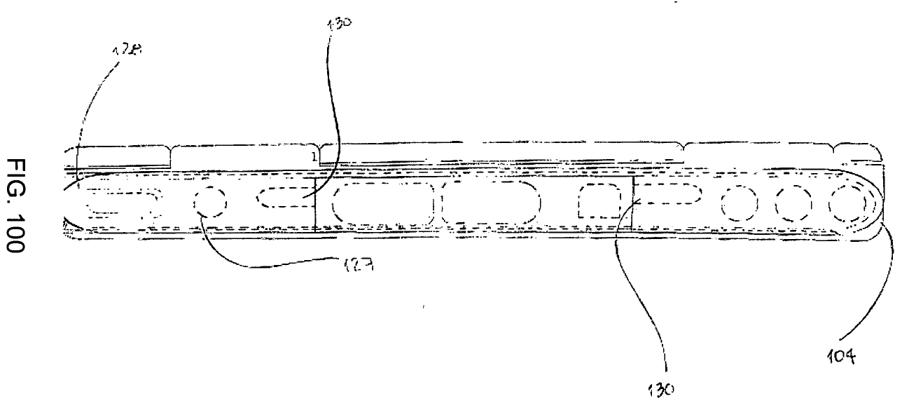

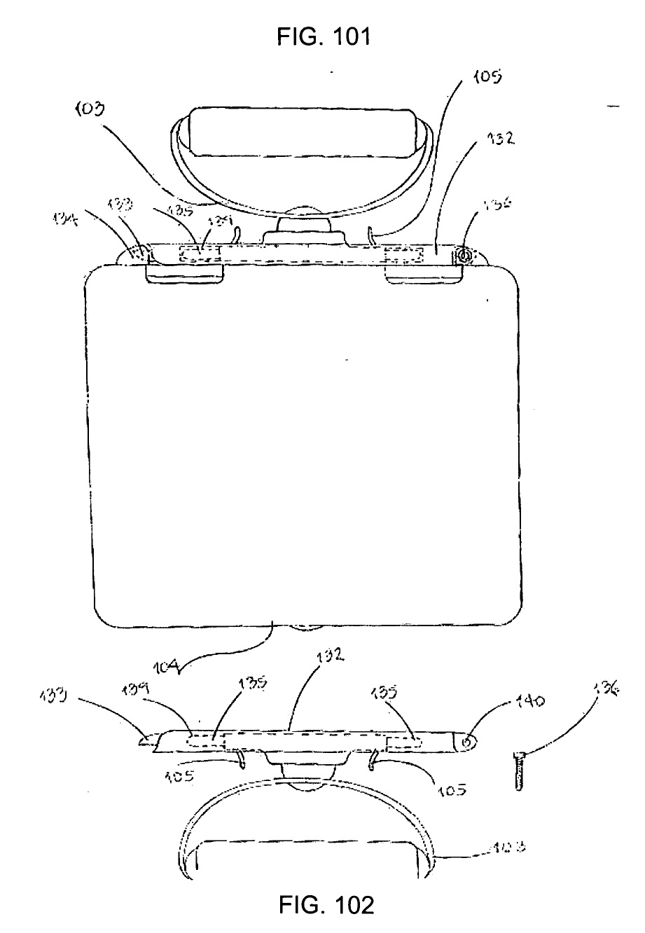

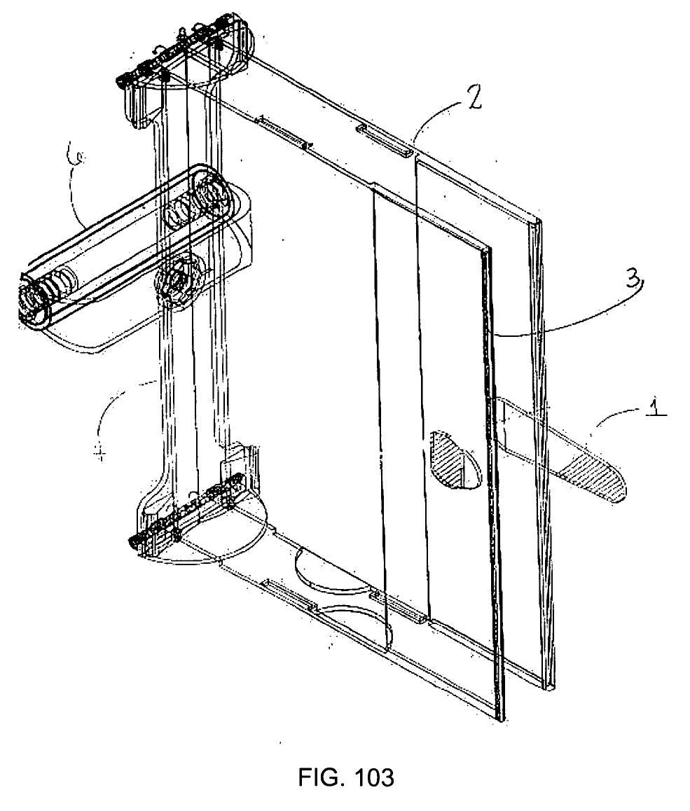

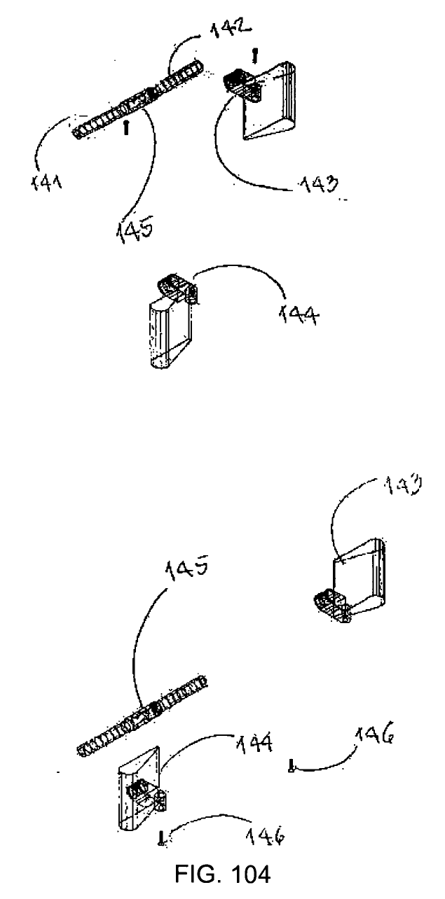

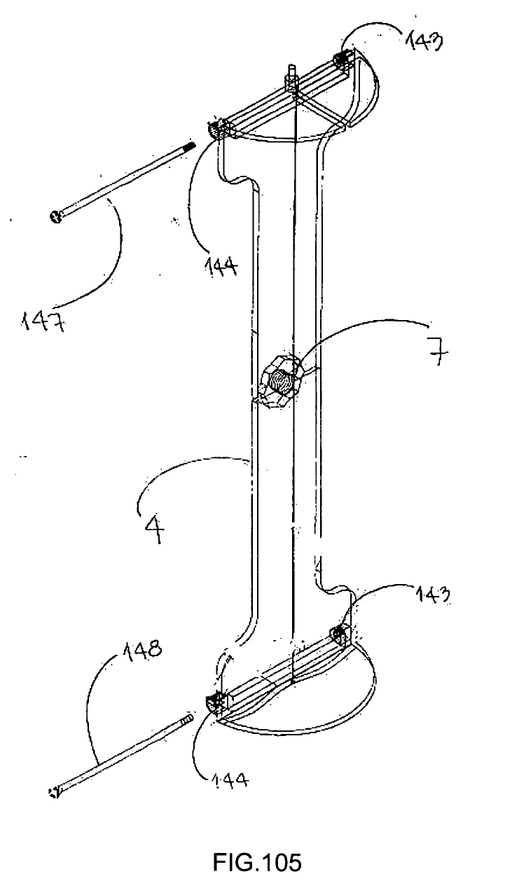

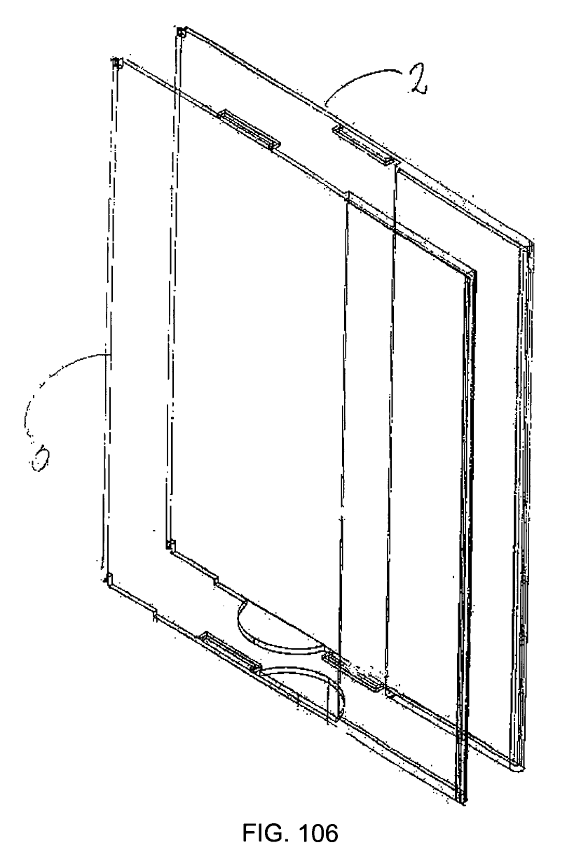

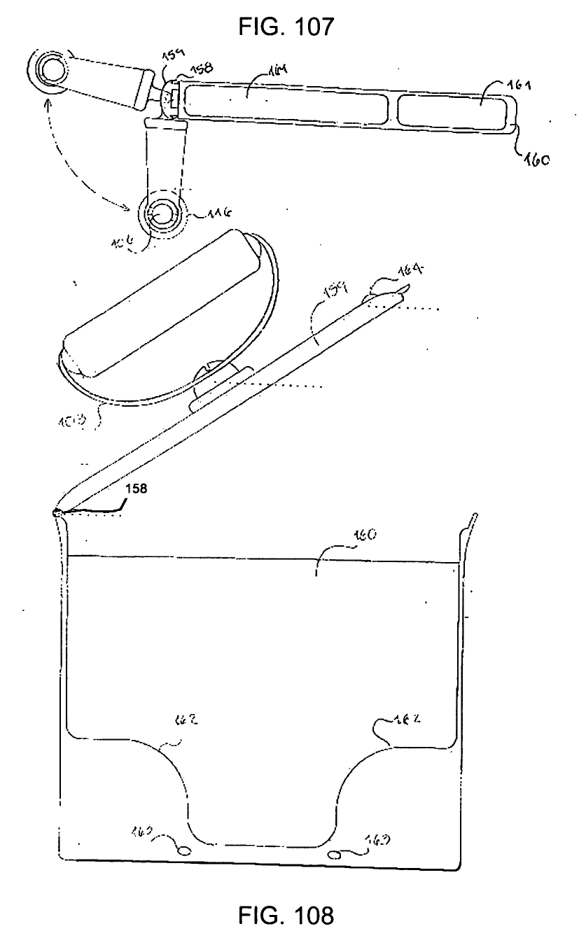

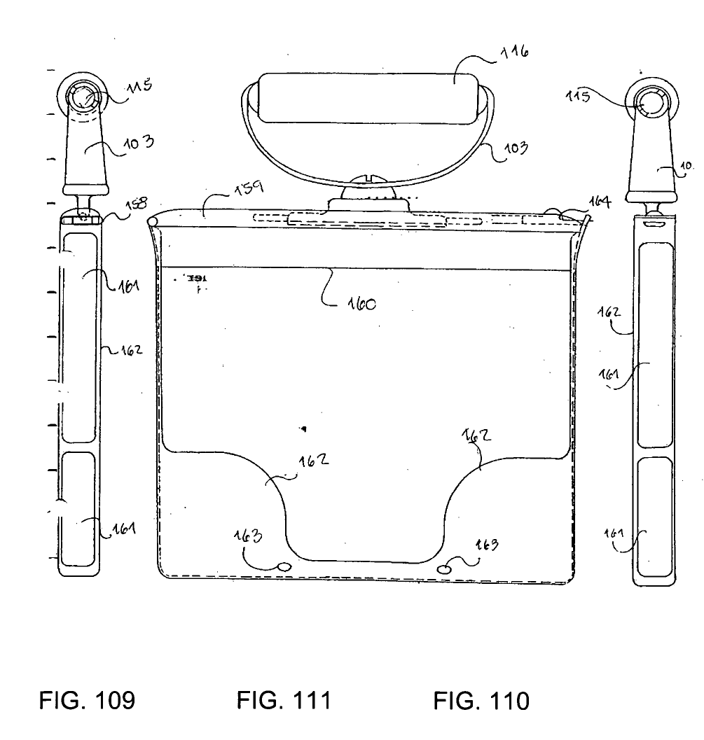

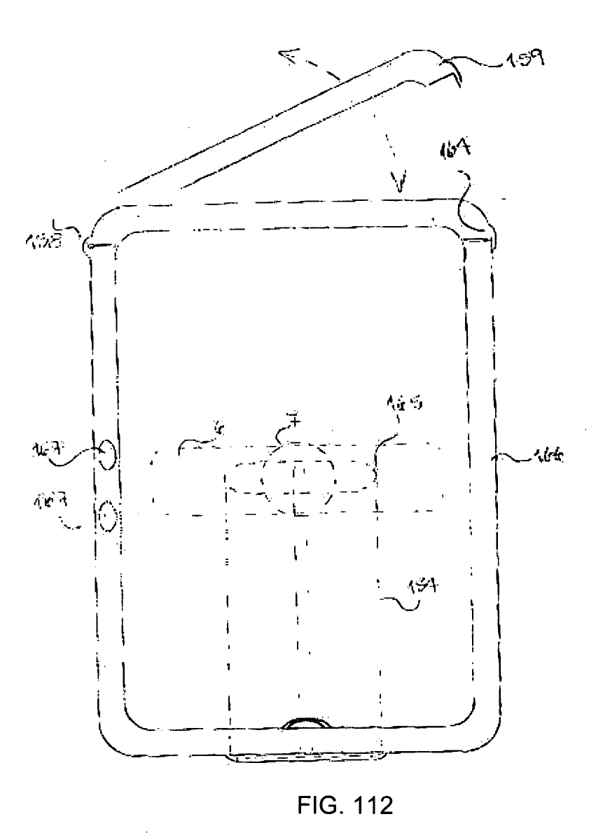

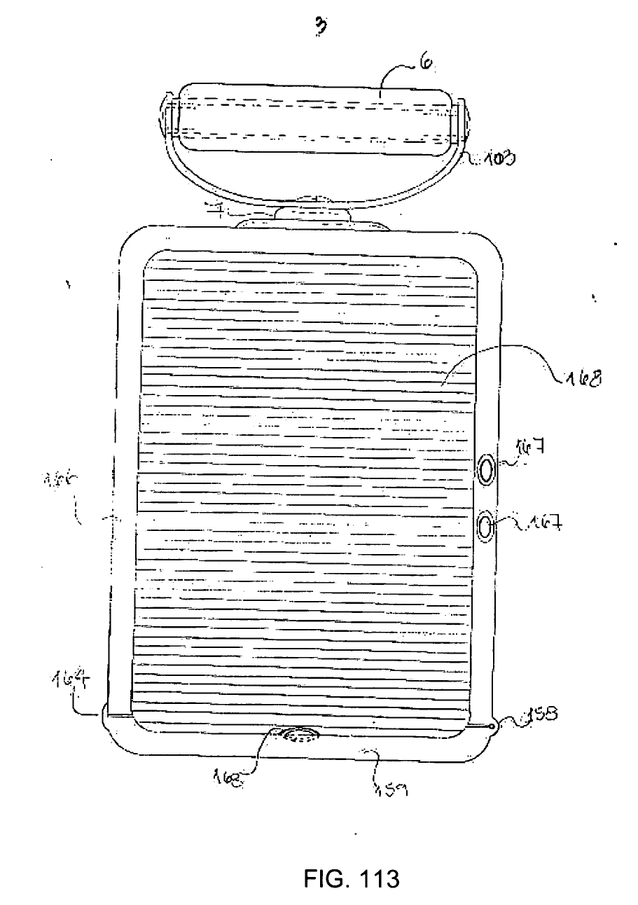

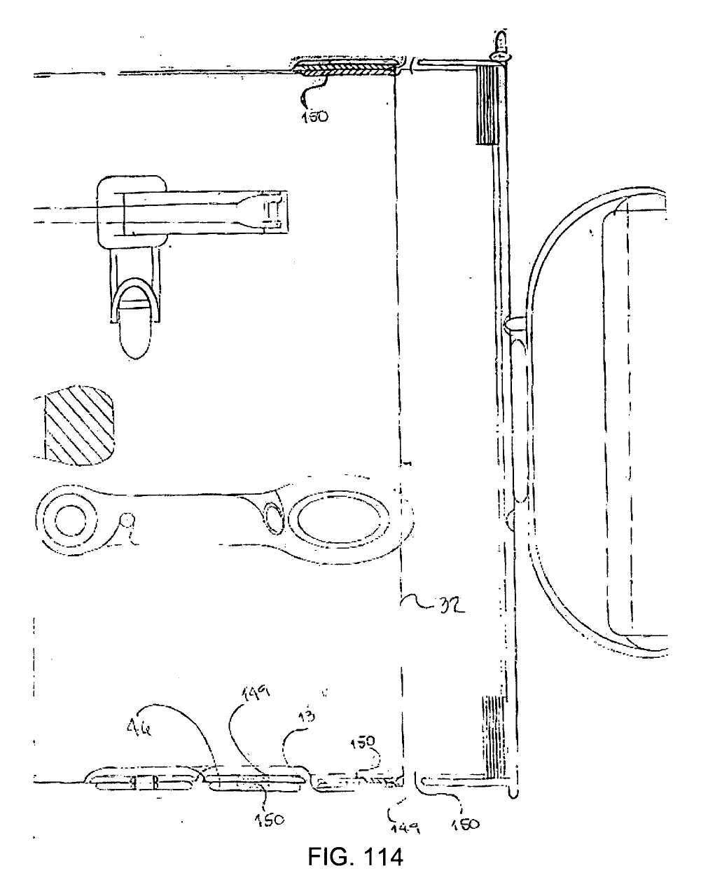

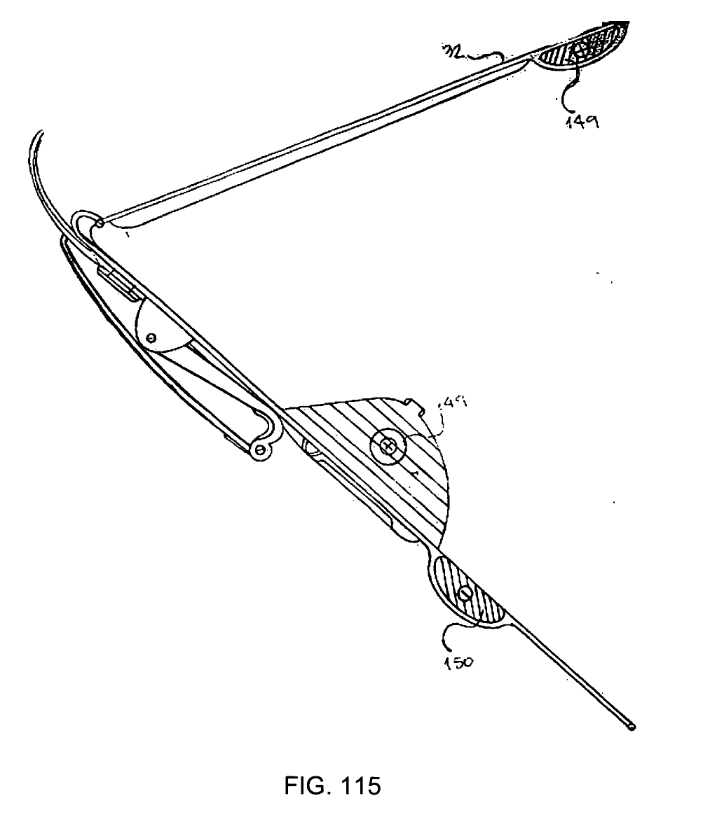

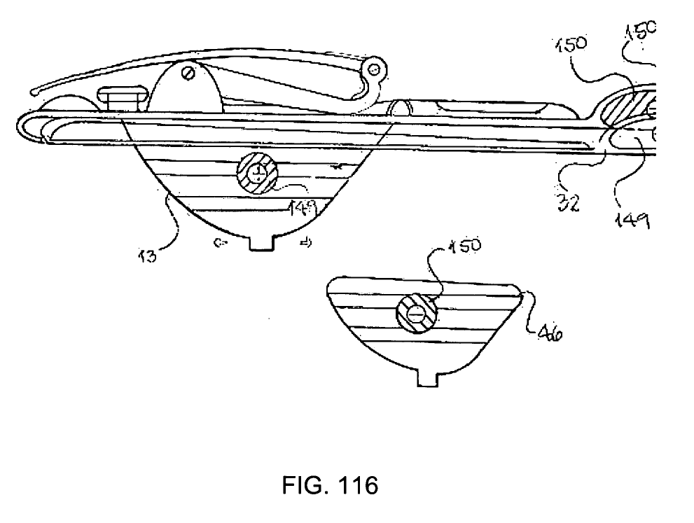

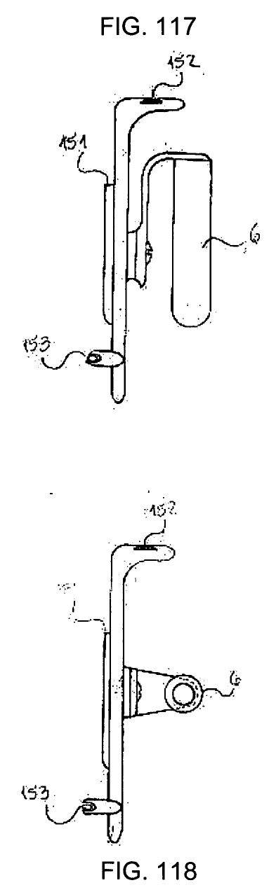

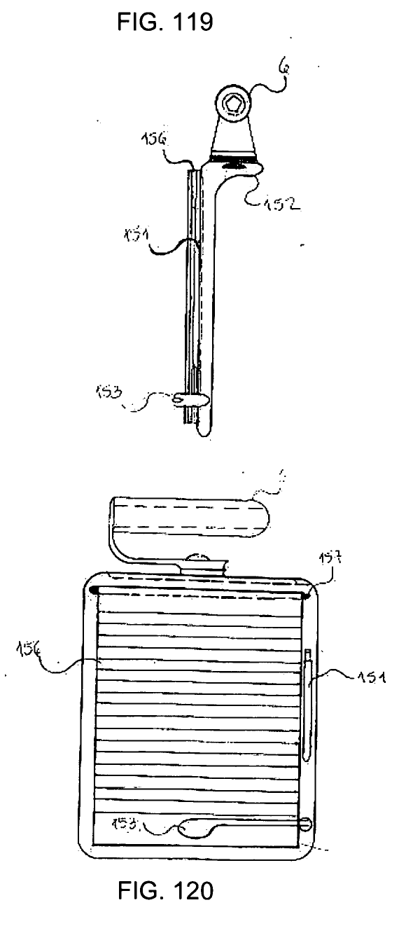

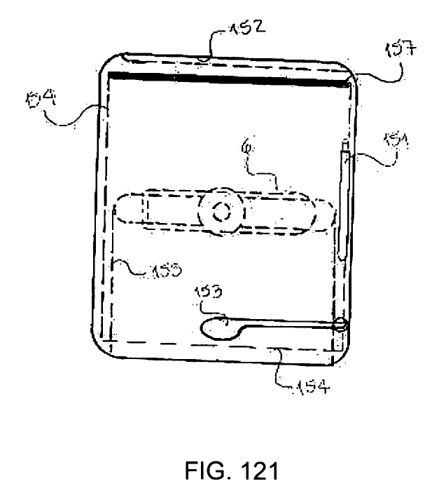

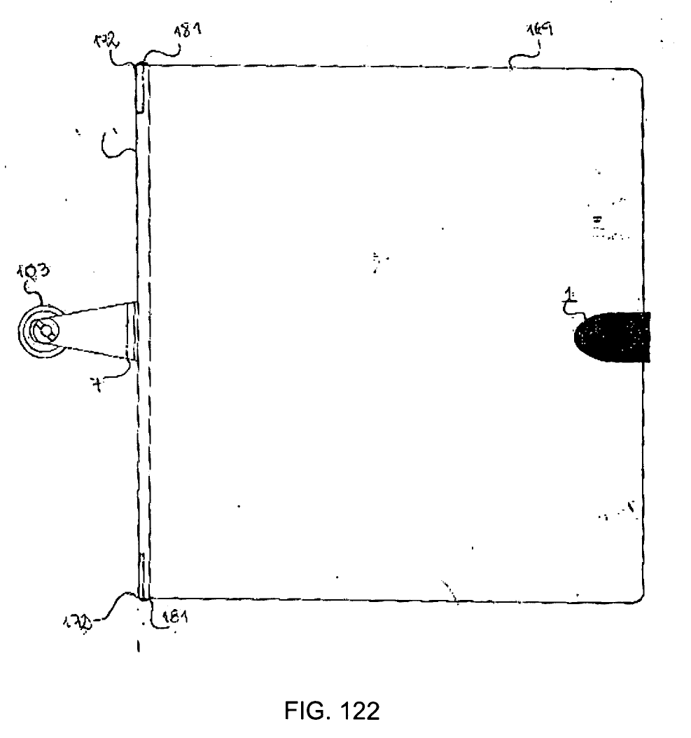

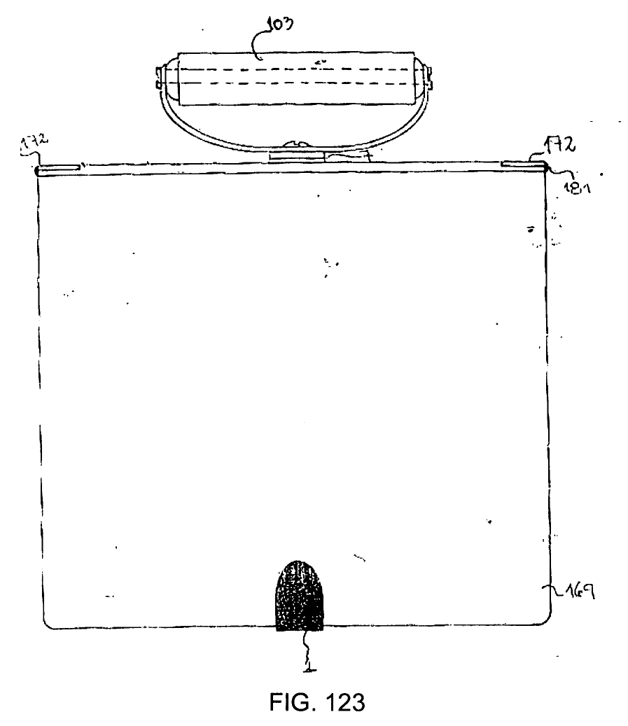

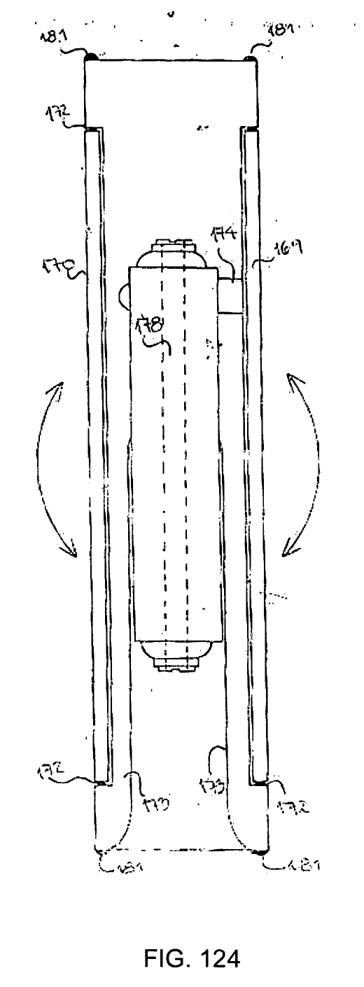

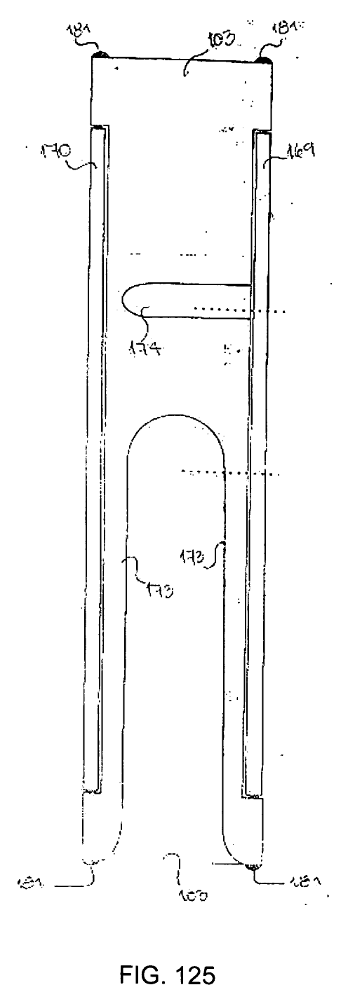

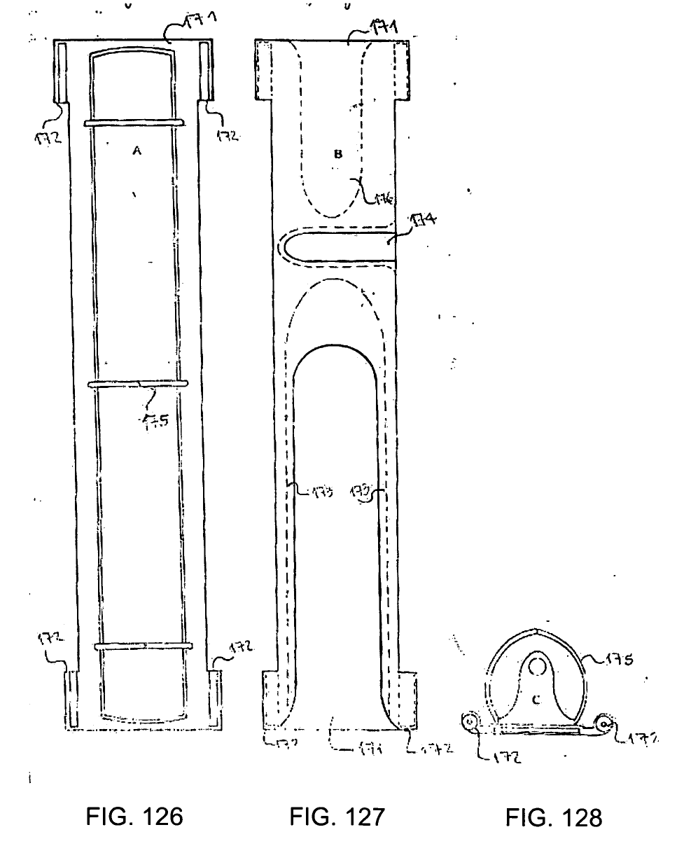

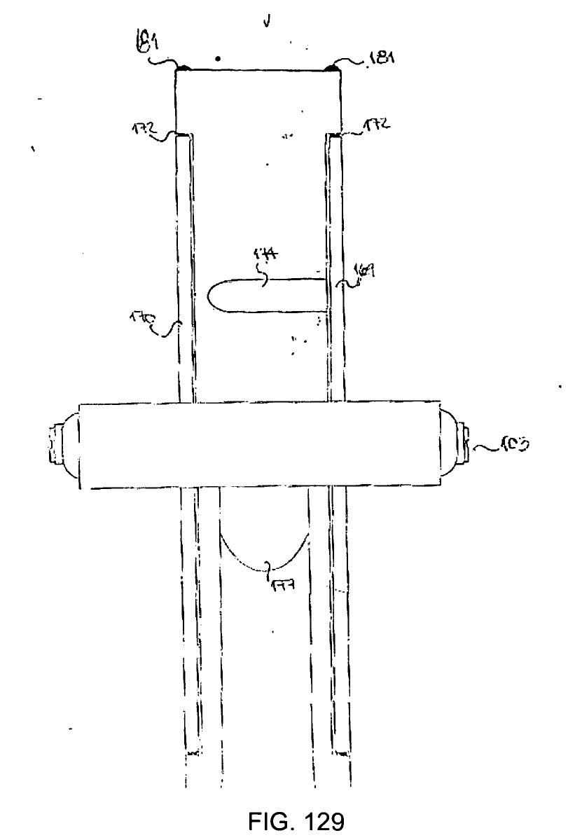

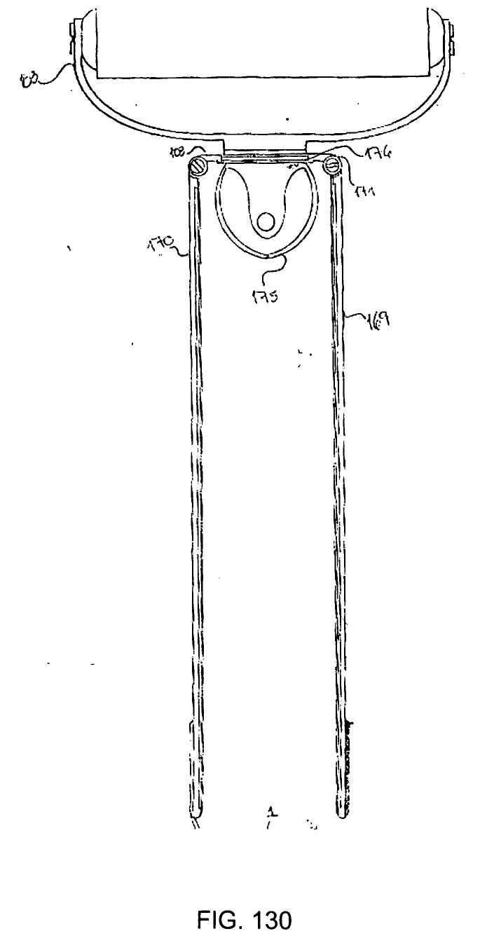

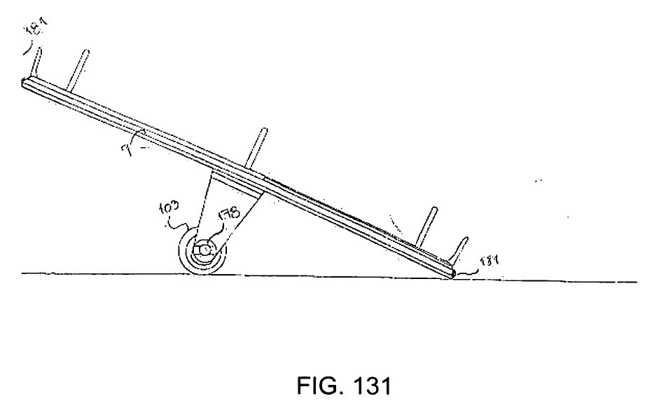

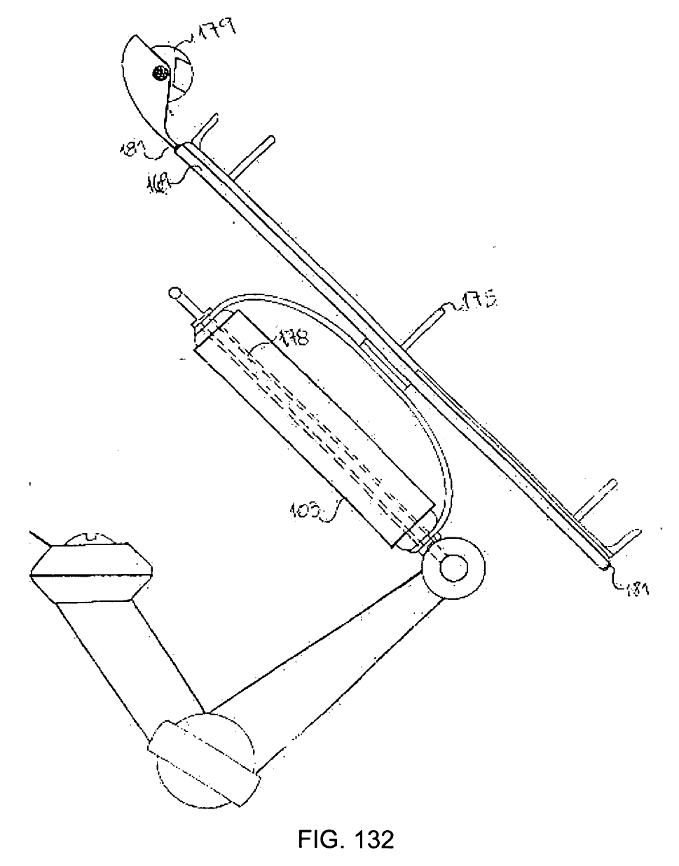

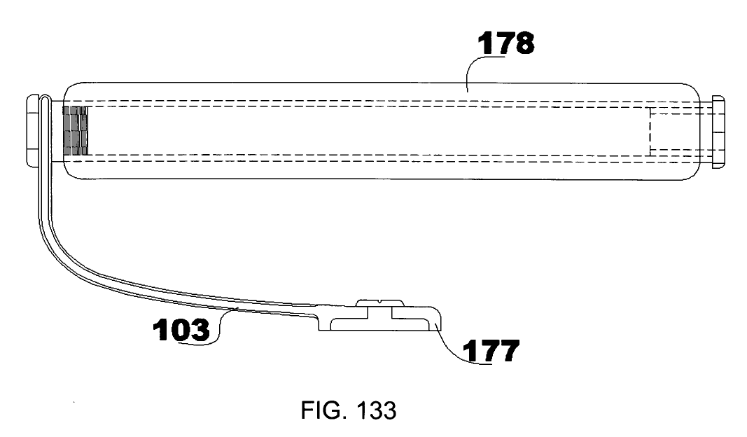

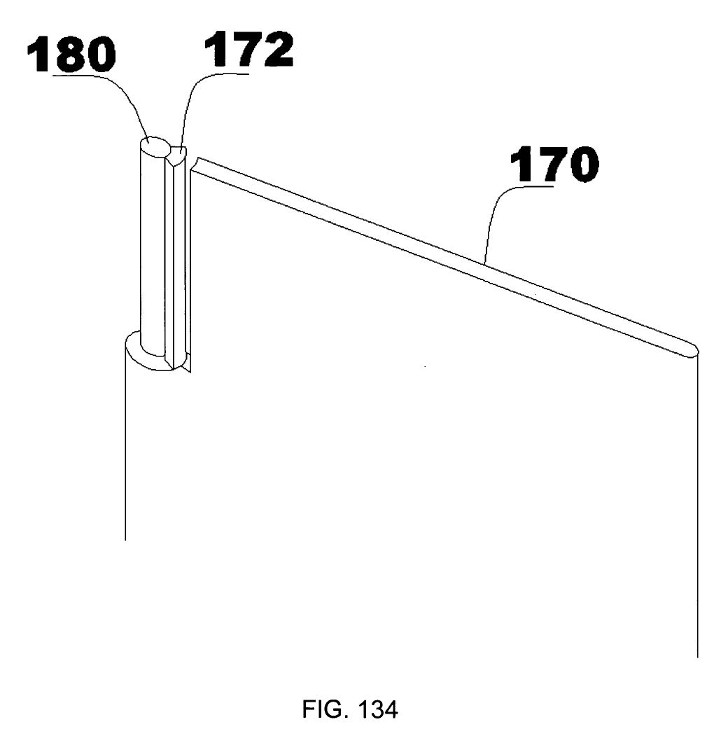

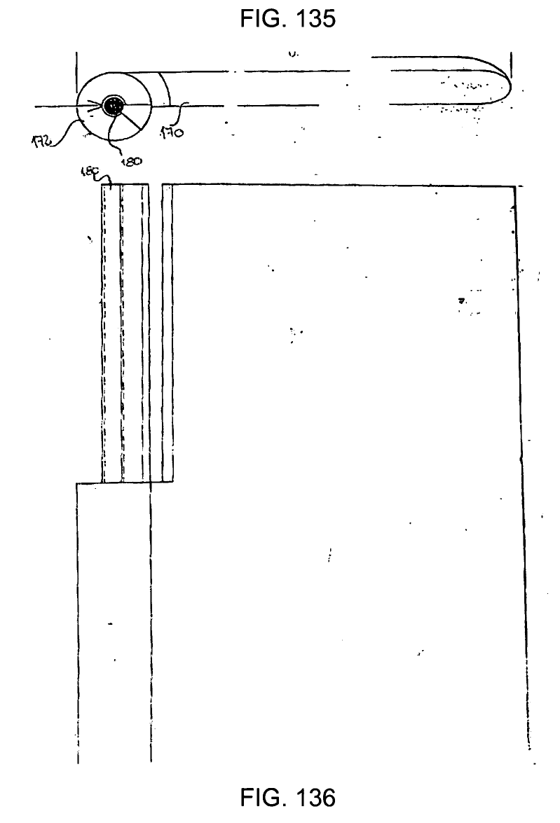

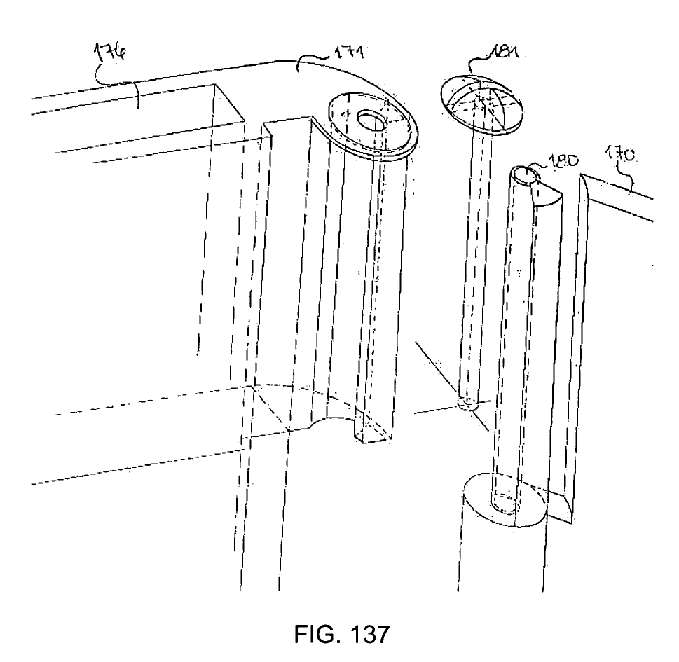

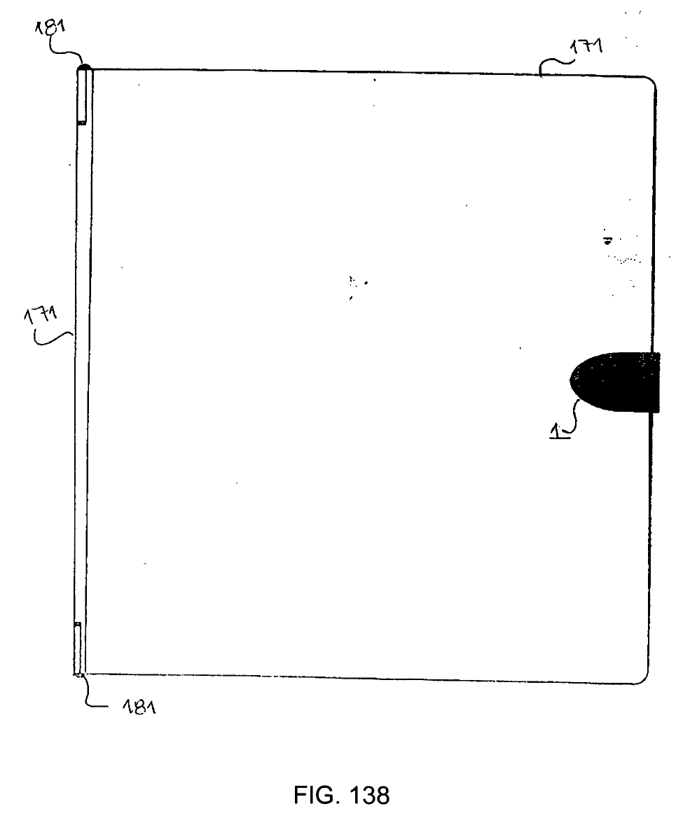

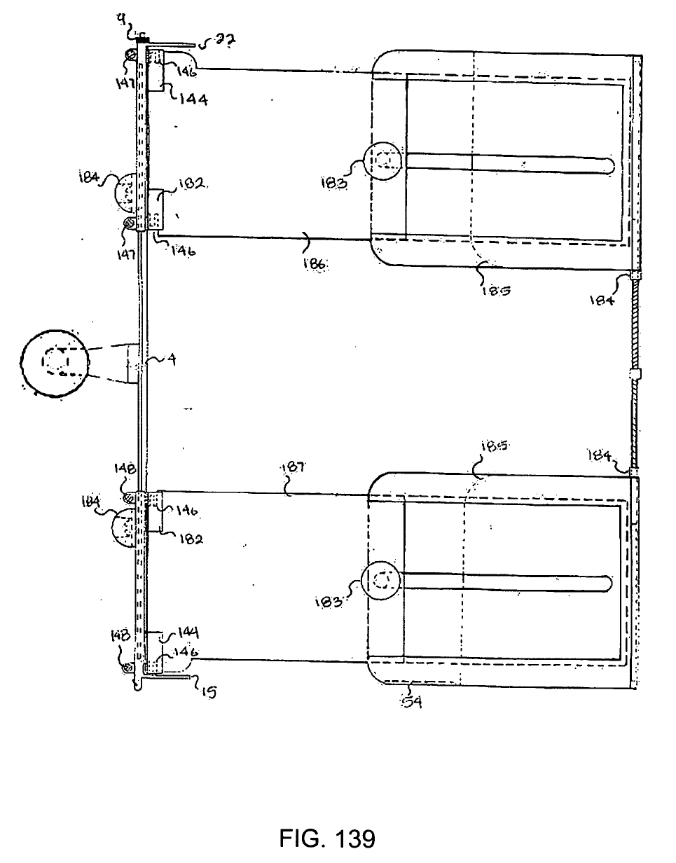

The fastener of books, newspapers, magazines, paper pads, laptops, e-books and binders in the version to hold books, newspapers, magazines and similar, provides the convenience of being able to sustain with one open hand in an appropriate position for reading a book, newspaper, magazine or similar. The design of this device, by means of the swivel handle, makes possible many applications and conveniences never before obtained with any other equipment or accessory created for these purposes.

The present invention consists of the following elements that are described next, in a general form:
A central base in which two wings or doors are installed, in which it is possible to insert the title page, hard cover or the first paper sheets of the beginning and end of the book, newspaper, magazine and similar.
The inferior part or inferior half moon that constitutes the base of the book, newspaper, 65.magazine or similar, which backside will be fastened against the swivel fastener by means of the thin central thread that is held in the inferior base of the central piece. This thread that is assembled by means of a buttonhole in the small base located in the half superior moon of the central piece will assemble the book, newspaper, magazine or similar with the fastener as a unit in order to be manipulated with one single hand.
The fixers of removable paper sheets which possess a spring system and transparent feet which main objective is to fix the paper sheets of the book, newspaper, magazine or similar. This will avoid the paper sheets to return to their original position and they will be kept in an appropriate position in order to be able to read them no matter if you are outdoors and the wind bothers you while reading.
The central piece. In its inferior and central area, a swivel handle has been assembled. This is so designed that the handle possesses the female and this central piece possesses the male in order to function as a “rachet” system joined by a screw that passes through the female and the central part of the swivel handle coiling in the male's central part to constitute this way the central piece.
Swivel handle that provides different applications and conveniences to the user, such as the ability of transforming this invention into a tool to work with the personal computer, when rotating this handle, placing it in vertical position and assembling it in an expandable arm to be able to place books, newspapers, magazines or similar without sustaining them and in a reading position while the user operates the keyboard of the personal computer when introducing or extracting information of a book, newspaper, magazine or similar.
1) It will also be possible to assemble the fastener of books, newspapers, magazines, paper pads, laptops-notebooks, tablet PC and binders, in the version to hold books, newspapers, magazines and similar in tripods for conferences, classrooms and presentations purposes.

2) How to use the fastener of books, newspapers, magazines, paper pads, laptops, e-books and binders: The present invention and its subdivisions. When placing the mentioned swivel handle previously in horizontal position, it is possible to sustain a book, newspaper or magazine with the paper sheets open in perfect position and exact angle with a single hand. This is possible thanks to the butts specially designed to function with the appropriate angle to avoid the wings or doors to be open more than the necessary in order to hold the paper sheets of the book or magazine positioning them in the correct angle for reading.

CHART NO. 1
Dimensions of the wings or doors.

| Size | Dimensions of the wings or doors (cm) |
|---|---|
| Mini | 14.0 × 18.7 |
| Small | 15.5 × 21.8 |
| Standard | 20.7 × 27.0 |
| Medium | 23.5 × 27.6 |
| Large | 23.5 × 35.0 |
| Extra Large | 28.5 × 34.6 |

The Fastener of books, newspapers, magazines, paper pads, laptops-notebooks, tablet PC and binders additionally presents a system of adjustments for the paper sheet holder doors and they will be used when the invention is used to carry books of different thickness. This version can be identified in the drawings 103 at the 106.

### Fastener of Books, Newspapers, Magazines, Paper Pads, Lap-Tops, 5. E-Books and Binders. Previous Technique

At the moment the industry of accessories for electronic devices such as portable personal computers (laptop), electronic books (e-books), as well as devices to hold and to use in a comfortable way books, magazines, newspapers and other documents has not developed currently any mechanism that provides characteristics of easy handling, use and manipulation of the articles before mentioned.

Nowadays, there only exist paper sheet fasteners that are merely rigid surfaces made out from wood or acrylic with a hook or clip that fastens those sheets with the objective of being able to write on them or to attach them for a better use or reading of documents fixed in this fastener. Additionally, it does not exist a device in the market that facilitates and provides comfort to the reader and that offers following characteristics: portability, easy use and comfort in its handling.

Also, in the case of the portable personal computers (laptop) that have been designed by high tech companies to serve as a computer science tool for work, study and entertainment; basing their name on the word of the English language “LAP” that means: the superior area of the legs understood between the waist and the knees. This is the reason for its original way of using these portable computers (Laptops): on the legs, in the area between waist and knees; with the inconvenience and risk that the portable computer can slip and fall to the floor damaging the equipment and with the further loss of important information or the physical unit itself.

A second form of using the portable computers (Laptops) is on a flat surface, as a desk or a table, with the inconvenience of not providing the inclination of 35 degrees in the keyboard similar to that of a typewriter. The third well-known form of using the portable computers (Laptops) is accommodating them on an arm and operating the same with the free hand, having then the high risk to fall with the additional loss or destruction of the same as well as the information contained in it.

For the case of the electronic notebooks (e-books), their use is a little complicated since their paper sheet size is similar to the letter size (8.5×11 inches), their manipulation and corresponding use is usually on one hand being operated with the other free hand—what makes the manipulation so fragile, unstable and with a high risk of suffering an accident.

Catalog of Elements:

A detail of the catalog of elements that form part of the invention is described as follows:
1. Velecro [English Translation unavailable]
2. Right paper sheet holder door
3. Left paper sheet holder door
4. Central base of the structure
5. Butts for the paper sheet holder doors* *which are 2 superior butts and 2 inferior butts that will be melt together with the 2 pieces that form the central base of the structure when being manufactured.
6. Totally assembled and installed swivel handle.
7. Internal “rachet” system of the swivel handle.
8. Functional area in the center of the central base, between the superior and inferior half moons
9. Buttonhole of the central thread.
10. Small base for the buttonhole of the central thread, on the half superior moon.
11. Central thread.
12. Cut of 2 millimeters thick, to the center of the half superior moon.
13. Supporting fin of paper sheets, corresponding to the right door.
14. Supporting fin of paper sheets, corresponding to the left door.
15. Half inferior moon, which is the main support for the book, newspaper or magazine required to be coupled in the structure.
16. Male, hinge part that the paper sheet holder doors use.
17. Right interior floodgate, which will be melt in the same mold with the right exterior paper sheet holder door when being manufactured.
18. Left interior floodgate, which will be melt in the same mold with the left exterior paper sheet holder door when being manufactured
19. Space needed to allow the supporting fin of paper sheets of the right paper sheet holder door to overlap.
20. Space needed to allow the supporting fin of paper sheets of the left paper sheet holder door to overlap.
21. 1.25-milimeter space, between the interior floodgate and the exterior paper sheet holder door.
22. Half superior moon of the central base.
23. Screws that fix the half superior moon with the central base.
24. Over-relief and hexagonal male with central milimetric thread of the same material of the central base and component of the “rachet” system of the swivel handle.
25. Hexagonal female incorporated in the base of the swivel handle and component of the rachet system.
26. Screw with milimetric thread that joins the central base of the structure and the swivel handle.
27. Main swivel cylinder of the handle.
28. Foam or soft material that covers the main cylinder.
29. Main base of the swivel handle.
30. Screws with thread that join the main cylinder with the swivel base of the handle.
31. Right paper sheet holder door.
32. Right floodgate of the interior system.
33. Hinges of the interior system floodgate.
34. Screw, which is a component of the hinge of the interior system.
35. Inferior fin, which can be attached to and detached from the exterior paper sheet holder door; component of the floodgate of the interior system.
36. Superior fin, which can be attached to and detached from the right exterior paper sheet holder door; component of the floodgate of the interior system.
37. Right holder for enlarged paper sheets of certain publications.
38. Bubble that constitutes part of the material of the exterior paper sheet door where it is attached and detached the right ellipse of the holder for enlarged paper sheets when rotated 90 degrees.
39. Right ellipse that is constituted in the holder for enlarged paper sheets.
40. Males that are components of the superior and inferior fins, which can be attached to and detached from the paper sheet holder door.

Females with vertical position in the external paper sheet doors where the males can be attached to or detached from the interior system fins.
41. Vertically positioned space over relief that constitutes part of the material of the external paper sheet holder doors to sustain the right and left fixer accessories of paper sheets.
42. Bubble that constitutes part of the material of the exterior paper sheet holder door where the left hole of the holder for enlarged paper sheets will be fastened or unfastened when rotated 90 degrees and when using it.
43. Left hole that constitutes part of the holder for enlarged paper sheets of certain publications.
44. Supporting fin of paper sheets, of the right paper sheet holder door.
45. Supporting spacer of paper sheets of the right paper sheet holder door.
46. Male of the right spacer of paper sheets that will be incrusted inside the female of the supporting fin of paper sheets, when this spacer is in use and is being rotated 369 degrees.
47. Locking devices that fasten the supporting spacer of paper sheets.
48. Milimetric screw, in which the superior and inferior fins rotate, component of the floodgates of the interior system.
49. Milimetric axis where the screw that sustains the fin passes through.
50. Space of the right paper sheet holder door that allows the supporting fin of paper sheets of the left paper sheet holder door to overlap.
51. Axis in which rotates the holder for enlarged paper sheets.
52. Removable fixer accessory of paper sheets, corresponding to the right door.
53. Supporting fin of paper sheets of the left paper sheet holder door.
54. Supporting spacer of paper sheets for the left door.
55. Left paper sheet holder door.
56. Join that allows the right supporting spacer of paper sheets to rotate in 360 degrees and to be incrusted on the supporting fin of paper sheets of the same side.
57. Union that allows to rotate in 360 degrees to the left supporting spacer of paper sheets and to be incrusted on the supporting fin of paper sheets of the same side.
58. Butt for the swivel handle that will avoid this handle to rotate totally on its axis.
59. Milimetric channels that are necessary to stop the butt of the swivel handle in order to avoid the structure to rotate on itself when too much weight has been transported to on one of the paper sheet holder doors by a certain publication.
60. Four (4) females that have milimetric thread and are necessary to adapt the accessory of illumination.
61. Superior fin that attached to and detached from the left paper sheet holder door, component of the left floodgate of the interior system.
62. Left holder for enlarged paper sheets of certain publications.
63. Female to circulate on the supporting fin of paper sheets of the right side, in which the male of the spacer of paper sheets is attached or fastened.
64. Removable fixer accessory of paper sheets for the left door.
65. Paper sheets of a closed hard-cover book.
66. Hard cover or binder of the book.
67. Paper sheets of the open hard-cover book.
68. Paper sheets of the closed soft-cover publication.
69. Soft-cover of a certain publication.
70. Paper sheets of the open soft-cover publication.
71. Female in which the male/16 of the paper sheet holder doors will enter, main essential piece of the hinges.
72. Male of the left supporting spacer of paper sheets that is incrusted inside the female of the fin.
73. Round female over the supporting fin of paper sheets of the left side, in which the male of the spacer of paper sheets is locked, when this sapcer is in use.
74. Optional accessory of illumination.
75. Females with milimetric thread.
76. Expandable arm or tripod with a circular base.
77. Hole that passes through the revolvable main cylinder of the handle.
78. User.
79. Holes with conical beginning, through which the screws that fix the half superior moon with the central base of the structure pass.
80. Left floodgate of the interior system.
81. Optional accessory of illumination with their coupling system without screws.

Coupling guides corresponding to the optional accessory of illumination.
82. Double A Batteries 12 V of the optional accessory of illumination.
83. Bulbs corresponding to the optional accessory of illumination.
84. Superior piece with movement range corresponding to the coupling system for the optional accessory of illumination.
85. Fixed inferior piece of the coupling system for the optional accessory of illumination.
86. Screws that assemble the superior piece with the fixed inferior piece of the coupling system for the optional accessory of illumination.
87. Males of the superior pieces of the coupling system.
88. Connector for the 110 V to 12 V current transformers, corresponding to the optional accessory of illumination.
89. ON/OFF switch corresponding to the optional accessory of illumination.
90. Females of the system of double hinge for the supporting spacer of paper sheets.
91. Joins for the system of double hinge of the supporting spacer of paper sheets.
92. Milimetric screws that work as males for the double hinge system of the supporting paper sheet spacer.
93. Milimetric females of the optional accessory of illumination, component of the coupling system.
94. Butts inside the milimetric females corresponding to the system of double hinge of the supporting spacer of paper sheets.
95. Mechanism of springs for the paper sheet holder doors; 2 superior springs inside the superior butts attached to the half superior moon and 2 inferior springs inside the inferior butts attached to the half inferior moon.
96. Cavities that will be located inside the superior and inferior butts, these are useful to couple the mechanism of springs of the paper sheet holder doors.
97. Battery-transportable capsules, corresponding to the optional accessory of illumination.
98. Small spaces that are necessary to unlock the superior cover of the battery-transportable
capsules.

Shields with thread for the bulbs of the optional accessory of illumination.
99. Females with milimetric thread, corresponding to the coupling system for the optional accessory of illumination.
100. Swivel handle of two axes.
101. CPU including screen.
102. Males of the swivel handle, part of the horizontal axis, mechanism to lock and to unlock the swivel handle from the personal computer.
103. Hole or female of the handle
104. Springs, component of the internal mechanism of the swivel handle.
105. Central structure of the swivel handle
106. Male of the central axis of the swivel handle
107. Female of the central axis of the swivel handle
108. Rivet or screws
109. Screw that joins the male and female of the central axis of the swivel handle
110. Female with milimetric thread
111. Main cylinder of the swivel handle
112. Males with incorporated females
113. Foam for the user's comfort
114. Expandable arm or tripod
115. Male of the expandable arm or tripod
116. Detachable keyboard
117. Expandable arm screwed in a wall
118. Screen
119. Central area of the horizontal axis
120. Half moons with depth
121. Cavity for the detachable keyboard
122. Female of the portable computer
123. Area or space to assemble the swivel handle
124. Connections
125. Removable rail
126. Males, component of the external structure of the CPU in which the rail 128 is assembled with the portable computer
127. Females of the removable rail, couple for the males of the swivel handle
128. Males of the removable rail which are coupled with the females of the portable computer
129. Base that it is assembled in the back part of the portable computer, in which one will also be able to assemble and disassemble the swivel handle
130. Male that is introduced in the female of the portable computer, component of the base that is assembled in the posterior part of the portable computer
131. Component of the portable computer in which the female is located to ensure the male of the removable piece
132. Males of the swivel handle (dotted lines), which can be assembled and disassembled in the base assembled to the portable computer.
133. Screw that vertically ensures the base that is assembled in the posterior part of the portable computer.
134. Female for the male of the removable rail
135. Female in the removable rail for the male of the structure of the portable computer
136. Females inside the removable piece that serve to couple the males of the swivel handle.
137. Hole where the screw passes.
138. Male threads for the left side (to graduate the publication width)
139. Male threads for the right side (to graduate the publication width)
140. Female with thread for the right side. (to graduate the publication width)
141. Female with thread for the left side. (to graduate the publication width)
142. Width regulator for the index finger. (to graduate the publication width)
143. Milimetric screws that fasten the paper sheet holder doors (to graduate the publication width)
144. Superior axis screw for the width regulator
145. Inferior axis screw inferior for the width regulator
146. Positive magnetos
147. Negative magnetos
148. Pencil holder
149. Area where the swivel handle is assembled when it is necessary to move the structure.
150. Holder of transparent paper sheets with spring system
151. Over-lapped area of the structure that will fix the hard cover of the notebooks
152. Over-lapped area in the structure inside which the adaptable fin of the handle will slip
153. Paper pads
154. Space where the paper pads is introduced.
155. Hinge where the floodgate of the accessory rotates.
156. Floodgate of the accessory
157. Adaptable structure with the lap-top.
158. Spaces for the connections of the lap-top
159. Milimetric superior area of the accessory
160. Spaces on the milimetric superior area
161. Locker with spring system of the floodgate of laptop holder
162. Fin of the e-book holder
163. Structure of the e-book holder
164. Spaces for the buttons of the e-book
165. Roll-up blind
166. Right plastic right door of the binder
167. Left plastic left door of the binder
168. Central base of the binder
169. Special hinges
170. Over-relief fins inside which the swivel handle should be coupled.
171. Under-relief space where the identification of the binder is inserted

Metallic clip
172. Internal space of the central base to insert an accessory
173. Attachable (clip-on) fin
174. Cylindrical space of the swivel handle to couple an expandable arm or tripod
175. Accessory of the binder (chronometer or pencil holder)
176. Female thread
177. Screws that join doors with central base
178. Female without thread for the left side (to graduate the width of the publication)
179. Knob for width regulation of the publication
180. Knob for height regulation of the publication
181. Over-relief fin that allows a milimetric space for insertion of the magazine covers.
182. Adjustable superior door system
183. Adjustable inferior door system

### DESCRIPTION OF THE DRAWINGS

Drawing 1: It offers an isometric view of the invention where you can identified the swivel handle (5) joined or attached to the central base (4) by means of the internal rachet system (7). This swivel handle (69) offers portability and maneuverability of the magazine, newspaper or book fastened by this structure offering this way multiple utilities to the user. We can also notice the paper sheet holder doors, (3) and (2), fixed to the central base (4) by means of the hinges located in the butts (5). There are four butts distributed as follows: two next to the half superior moon (22), and two next to the half inferior moon (15). These butts (5) avoid the paper sheet holder doors, (3) and (12), to open completely allowing the paper sheets of the book, newspaper or magazine to be open in perfect position. When reading or sustaining the structure with one single hand by means of the swivel handle (6) and the user needs to read the left page, he or she will need to turn or rotate his or her hand wrist 2 or 3 degrees to the left. If he or she needs to read the right page, he or she will need to turn or rotate his or her hand wrist 4 or 6 degrees to the right. We also see the utilitarian area (8) where the front edge of a book, newspaper or magazine rests, fastening the publication by means of the central thread (11), which must be placed to the center of the publication, assembling the buttonhole (9) in the small base (10). Additionally, a bunch of paper sheets of the beginning and end of the book must be inserted into the milimetric space (21), located between the paper sheet holder doors, (3) and (2), and the interior floodgates (18), and (17). The fins are also shown—(13) and (14)—supporting of paper sheets, which are part of the holder doors paper sheets (3), (2), this supporting fins of paper sheets will offer stability to our book, newspaper or magazine, when the structure is open, maintaining the paper sheets at the same level that the half inferior moon (15). The Velcro (1) is important for holding the doors when closed.

Drawing 2: it shows the isometric view of the paper sheet holder doors, (3) and (2), usually manufactured in transparent plastic of high quality. We can spot the spaces, (19) and (20), intended to overlap the supporting fins of paper sheets, (13) and (14), when desired to keep the doors closed, (3) and (2). It is also possible to observe the male (16) of the hinges, which will be assembled between the females (72), located in the inferior and superior butts (5). These are not shown this graph. We can also see the internal floodgates, (17) and (18), which will be melted in the same mold in which the paper sheet holder doors, (3) and (2), have been melted, providing the milimetric spaces (21) to the center that are necessary for allowing the initial and final part of the soft cover to slip between them.

Drawing 3: it shows the isometric graph corresponding to the central base (4) of the disassembled structure where we can spot the small and milimetric screws (23) needed to fasten the half superior moon (22) with the central base (4). The half superior moon (22) that possesses the milimetric space (12) is needed for slipping the central thread (11), assembling the buttonhole (9) inside the small base (10), which is located to the center of the half superior moon (22). Furthermore, we can distinguish the hexagonal male (24) with centered thread, piece that will be melted in the same mold where the central base has been melted (4). This hexagonal male (24) is an important component of the rachet system which belongs to the swivel handle (6) of the structure. In regard to the butts, (5) we can see that both superior butts are part of the material that forms the half superior moon (22). They have three milimetric females (76), which will work in combination with the screws (23). These screws will pass through the buttonholes (80) with conical entrance, so attaching the half superior moon to the central base (4). This will fasten the paper sheet holder doors, (2) and (3), which will be installed in the male (16) and female (72) system of hinges. The paper sheet holder doors, (2) and (3), and the male (16) of this doors are elements that are mentioned in the explanation of this drawing but they don't appear in this drawing.

Drawing 4: it shows the isometric view of the central thread (11) together with its own buttonhole (9). This central thread must be located to the center of the publication no matter the position chosen to read the publication. Likewise, it is necessary to slip the superior part of this central thread (11) through the milimetric space (12) assembling the buttonhole (9) inside the small base (10), which is located in the central superior part of the half superior moon (22). This will allow you to be able to push the edge of certain publication towards the central base (4) of the structure. The inferior part of the central thread (11) will be fixed in the center of the half inferior moon (15).

Drawing 5: it shows the isometric view of the two pieces that constitute the Velcro (1). They will be located to the center of the paper sheet holder doors, (3) and (2), and are necessary to fix firmly the paper sheet holder doors when required to keep them closed. The paper sheet holder doors, (2) and (3), are elements that are mentioned in the explanation of this drawing but they are not shown in this graph.

Drawing 6: it shows the isometric view of the disassembled swivel handle. We can see the main base (19), with a hexagonal female (25) which constitutes the essential part of the rachet system. Furthermore, there is a cylinder-shaped sponge or soft material (28) that will cover the main cylinder (27). This cylinder has a hole (78) that will allow the invention to be assembled in expandable arms/tripods when positioning the swivel handle in vertical position. This main cylinder (27) will be firmly fixed to the main base (29) by means of the screws (30), specially designed hollow screws. To join and firmly fix the swivel handle with the central base of the structure, it is necessary to use those screws (26) with milimetric thread.

Drawing 7: it shows the external view of the right door manufactured in transparent plastic of high quality where we can distinguish its different components: at firstly, we can see the male (16) which is part of the hinge. We can also notice the Velcro (1) that is necessary to keep the doors closed when required. Furthermore, we can observe the exterior paper sheet holder door (31), which will work simultaneously with the right floodgate (32) of the internal system and they will be joined by means of the hinge system, (33) and (34). The existing difference between the floodgate of the internal system (32) of the ramification #1 and the floodgates, (18) and (17), of the original conception of the invention is the range of movement of the floodgates of the internal system (32) that is possible thanks to the hinge system, (33) and (34). This interior system of floodgates will allow hard covers of up to ⅛ inch thick to be placed between the paper sheet holder door (31) and the floodgate of the interior system (32), firmly fixing the floodgate of the interior system (32) with the paper sheet holder door (31) by means of the vertical milimetric females (41). These females are located in the paper sheet holder door (31) where the males (40) of the superior (36) and inferior (35) fins are assembled. Furthermore, we can observe the holder (37) for enlarged paper sheets in certain publications, right holder (37), in the transportable position and without being used. In order to use the right holder (37), it should be rotated 90 degrees to sustain the enlarged paper sheets. This will make possible to fasten firmly in perfect position a four-page sequence. Mentioned holder for enlarged paper sheets (37) functions when it turns round on its own axis (52), using the bubbles, (38) and (43), the left hole (44) and the ellipse (39) to be positioned in the desirable positions, which are two: in use and out of use. We can additionally see the paper sheet spacer (46) and the supporting fin of paper sheets (45) that will maintain the stability of the paper sheets of a publication. This operation will be properly explained in the next operative drawings. Finally, we see the over-relief space (42) necessary to adapt to the removable fixer accessory (53) of paper sheets and the space (51) required to allow the supporting fin of paper sheets of the left door to overlap. The removable fixer accessory (53) of paper sheets and the supporting fin of paper sheets of the left door are elements that are mentioned in the explanation of this drawing but they are shown in this graph.

Drawing 8: The existing difference between this drawing and the drawing 7 is that now we see the right door from the internal side, appreciating the dotted lines that correspond to the milimetric screw (49) on which the superior (36) and inferior (35) fins rotate, axis (49) located in the left superior and inferior sides of the right floodgate (32) of the internal system. It is also possible to identify the element (48) corresponding to the locking devices in which the supporting spacer of paper sheets (46) rests. Likewise, there appears the element (57) corresponding to the join located between the supporting fin of paper sheets (45) and the supporting spacer of paper sheets (46). The supporting fin (46) of paper sheets will rotate in 360 degrees on this join. The Velcro (1) is also send and it is affixed on the right exterior paper sheet holder door (31), allowing the central hinge of the system of hinges (33) that correspond to the right floodgate of the interior system (32) to be visible.

Drawing 9: it shows the holder for enlarged paper sheets (37) having rotated on its own axis (52) in 360 degrees, using the bubble (43) to positioning itself where the hole is located (44). Additionally, we spot the empty space inside the ellipse (39), necessary to lock itself in the bubble (38) when we rotate backwards the holder for enlarged paper sheets, placing it in a transportable position and without being used. With this holder for enlarged paper sheets, we can keep a 4-page sequence open and in perfect position, holding the invention with one single hand, on a table or desk or assembled in a tripod or expandable arm.

Drawing 10: it shows the right view of the invention presented in “small” size of the different offered sizes to be manufactured. This size is ideal for small books, as well as the “Bible size” of conventional measures. We observe the swivel handle (6), in vertical position with the internal rachet system (7). Mentioned swivel handle (6) is joined to the central base of the structure (4) by means of the milimetric screw (26) with the butt (59) that will avoid the structure to rotate totally on its own axis. This will avoid the structure to rotate without control when there is more weight on one of the paper sheet holder doors, (31) and (56), than the other. The vertical position of the swivel handle (6) and the hole (78) represented with dotted lines along the main cylinder (27), will offer us the different applications and conveniences for coupling the structure in the close position (as shown) or completely open with expandable arms and tripods. The removable fixer accessory of paper sheets (53) assembled inside the vertical space (42) and over relief (42) can also be distinguished. Mentioned removable fixer accessory of paper sheets (53) is in the transportable position without being used. The holder for enlarged paper sheets is also in the transportable position and without being used. It is important to observe how the left supporting fin (54) of paper sheets and its supporting spacer of paper sheets (55) are able to overlap the right paper sheet holder door (31) and the right floodgate of the interior system (32) by means of the space (51). This will allow to keep the same level and stability for the publications that are used from the half inferior moon (15) till the two supporting fins of paper sheets, (45) and (54). We also can perceive the use of the superior (36) and inferior (35) fins, which are part of the right floodgate (32) of the interior system. These join the exterior paper sheet holder door (31) using the males (41) in the superior (36) and inferior (35) fins and the vertical females (41) located in the superior and inferior part of this exterior paper sheet holder door (31). With a dotted line, we see the central thread (11) which is coupled to the small base (10) by means of the buttonhole (9).

Drawing 11: it shows the right view of the invention presented in small size of the different offered sizes to be manufactured. As in drawing 10, we see the right view of the invention with the difference of having the swivel handle in horizontal position, position in which normally mentioned swivel handle (6) will be kept when holding the invention with one single hand. Likewise, this horizontal position of the swivel handle (6) will allow the structure to be placed on a table or desk, functioning as stabilizer with the paper sheet holder doors open, (31) and (56), and so the user will be able to read a book, newspaper or magazine in perfect position. It also shows the channels (60) between which the butt (59) will rotate and hit—something that will be better distinguished in the following drawings.

Drawing 12: it shows the left lateral view of the right door of the invention, in which we can observe with dotted lines the range of movement of the supporting spacer of paper sheets (46). When this spacer is attached to the join (57), it will rotate 360 degrees and when effecting this rotation, it will position itself over the supporting fin of paper sheets (45) and will use the circular male (47) and the circular female (64) to position itself firmly over the fin (45). We can also see the left lateral view of the holder for enlarged paper sheets (37) with its axis (52); the left lateral view of the Velcro (1), the over-relief space (42) that will serve to hold firmly the optional removable fixer accessory of paper sheets (53); the borders of the superior (36) and inferior (35) fins corresponding to the system of interior floodgate; system of hinges (33) with its screw (34) that provides the range of internal movement of the right floodgate (32) of the interior system.

Drawing 13: it shows the supporting spacer (46) of paper sheets. It has already been rotated and positioned on the supporting fin of paper sheets (45)—the element (48) that is one of the locking devices in which the supporting spacer of paper sheets will be placed (46) when this by means of the join (57) will rotate back 360 degrees.

Drawing 14: it shows the left lateral view of the right door of the invention holding the half of a soft-cover publication (70). You can observe that when using a publication of soft cover (70), it is not necessary to use the supporting spacer of paper sheets (46) since the paper sheets (71) of this publication are at the same level as the soft cover (70). We also observe the left lateral view of the holder for enlarged paper sheets (37); the left view of the Velcro (1); the over-relief space (42) that will serve to hold the removable optional accessory and fixer of paper sheets (53); the borders of the superior (36) and inferior (35) fins; the circular male (47) that when using the supporting spacer of paper sheets (46) and rotating it 360 degrees, it will be incrusted inside the circular female (64) located on the right supporting fin of paper sheets (45).

Drawing 15: it shows the left lateral view of the right door of the invention holding half of a hard cover publication (67). You can observe that the hard cover (67) of this publication and a small bunch of paper sheets are between the floodgate of the interior system (32) and the exterior paper sheet holder door (31); we can also identify the use and convenience of the supporting spacer of paper sheets (46) that will even the paper sheets (68) of this publication—paper sheets that are not at the same level of the hard cover (70) that rests on the right supporting fin of paper sheets (45).

Drawing 16: it shows the aerial view of the right and left doors of the invention. We are able to distinguish the external paper sheet holder doors, (56) and (31); the supporting fins of paper sheets, (45) and (54), that are part of these paper sheet holder doors, (56) and (31), and that overlap underneath. We also see the positions adopted by the superior fins, (36) and (62), that correspond to the floodgates of the interior system when a soft cover publication is in use. We also observe the aerial view of the paper sheet holders, (63) and (37), for certain publications; the head of the screw (34) corresponding to the hinges system of the internal floodgates system; we see the Velcro (1) that is divided in two pieces; a fixed piece in the left paper sheet holder door (56) and the other piece located in the right paper sheet holder door (31) which sticks and unsticks from the fixed piece which is located in the left paper sheet holder door (56). The function of the Velcro is to fix firmly the paper sheet holder doors, (56) and (31), when it is desired to carry the structure in a transportable way.

Drawing 17: it shows the aerial view of the right and left doors of the invention. We can distinguish the external paper sheet holder doors, (56) and (31). Also we see the positions adopted by the superior fins, (36) and (62), that correspond to the floodgates of the interior system when a publication of hard cover is in use. Simultaneously, we see the aerial view of the Velcro (1). The Velcro is divided in two pieces, a piece in the left paper sheet holder door (56) and the other piece is located in the right paper sheet holder door (31), which is the one that unsticks from the fixed piece and is located in the left paper sheet holder door (56). The purpose of this Velcro (1) is to fix firmly the paper sheet holder doors, (56) and (31), when we want to close the structure to carry it in a transportable way. We also see the head of the screw (34), corresponding to the hinges system of the internal floodgates system.

Drawing 18: it shows the aerial view of the paper sheet holder door (31), in which is possible to spot the range of movement of the floodgate of the interior system (32). We can also see the aerial view of the vertical female (41) in which the male (40) of the superior fin (36) is inserted. We can identify the right removable fixer accessory r of paper sheets (53) assembled in transportable position and without being used. Additionally, we can distinguish other elements as the aerial view of the supporting fin of paper sheets (45), with its circular female (64) on which the circular male (47) corresponding to the supporting spacer of paper sheets (46) will be inserted. In order to use it, it should be detached from the locking devices (48) rotating it 360 degrees. This supporting spacer of paper sheets (46) is connected to the supporting fin of paper sheets (45) by means of the join (57). We can see the right holder for enlarged paper sheets (37) in a transportable position and without being used. We are using the ellipse (39), which is coupled in the bubble (38), to keep it fixed and in this position. Simultaneously, we notice the aerial view of the Velcro (1), which is the piece of the Velcro that sticks and unsticks from the fixed piece of the Velcro located in the left paper sheet holder door (56). The purpose of this Velcro (1) is to fix firmly the paper sheet holder doors, (56) and (31), when we want to close the structure to carry it in a transportable way. The circular male (47), which corresponds to the supporting spacer of paper sheets (46), the locking devices (48) for this spacer and the left paper sheet holder door (56) are elements that are mentioned in the explanation of this drawing but they are not shown in this graph.

Drawing 19: it shows the aerial view of the floodgate of the interior system (32), with its superior fin (36) and its hinge (33).

Drawing 20: it shows the aerial view of the floodgate of the inferior system (32) totally disassembled. In this graph we can see the hinge (33) and the milimetric axis (50), where the milimetric screw is locked (49).

Drawing 21: it shows a lateral view of the right floodgate of the interior system (32). In this graph, we can observe the horizontal position that will be adopted by the superior (36) and inferior (35) fins when these will be locked by means of the males (40) inside the vertical female (41) corresponding to the paper sheet holder doors, (31) and (56).

Drawing 22: it shows the lateral view of the right floodgate of the interior system (32). In this graph, we can distinguish the range of movement of the superior (36) and inferior (35) fins which rotate on the axis that the milimetric screw (49) provides.

Drawing 23: it shows the lateral view of the central base of the invention where we can observe the half superior (22) and inferior (15) moons. The edge of the book, newspaper or magazine will be sustained. We can also distinguish the over-relief male (24) with milimetric thread to the center, over-relief male (24), which will be part of the material of the central base and component of the internal rachet system of the swivel handle (6).

Drawing 24: it shows the aerial view of the central base (4), showing the 4 holes (61) with milimetric thread. These holes (61) are destined to assemble the optional accessory of illumination (75). The butts (5) are represented with dotted lines and they are required to avoid the paper sheet holder doors to open completely and by this way to obtain a perfect open position of the book, newspaper or magazine that we have coupled in the structure. The milimetric space (12) to the center of the half superior moon (22) will help to couple to the buttonhole (9) in the small base (10) to the center and over the half superior moon (22). This buttonhole (9) previously mentioned corresponds to the central thread (11). Also, we can notice the over-relief male (24) with milimetric thread to the center, male on relief (24) that is formed with the same material of the central base (4) and is component of the internal “racket” system of the swivel handle (6).

Drawing 25: it shows the central base of the invention completely unarmed, being able to identify that the superior part of this base will be fused in one single mold. It has the following elements: half superior moon (22), superior butts (5), milimetric threads (76) located in the back part of the butt (5) and the small base (10) located to the center and over the half superior moon (22). This superior part of the central base will be assembled with the inferior part of the central base by means of the 6 milimetric screws (23), which will be inserted through the holes with conical entrance (80) and they will be coiled inside the milimetric threads (76). When this installation is performed, the assembler will already have had armed and assembled the swivel handle (6) that will already be joined to the central base. Seconds before finishing this installation process, the paper sheet holder doors, (31) and (56), will be placed using the system of female hinges (72), located in the 4 butts (5), and the males (16) of the paper sheet holder doors, (31) and (56). Consequently, the paper sheet holder doors will be fastened between the half superior (22) and half inferior (15) moons. We can also distinguish the channels (60) that will serve to stop the butts (59) of the swivel handle (6).

Drawing 26: it shows the front view of the central base (4), with the utilitarian space (8) for small books and for a bible size book. With small dotted lines we can distinguish the females (72) located in the internal corners of the 4 butts (5)

that together with the males (16) corresponding to the paper sheet holder doors, (3) and (2)/(31) and (56), form the hinge mechanism. The over-relief male (24), also represented with dotted lines, has a milimetric thread to the center. This over-relief male (24) is formed by the same material of the central base (4) and it is a component of the internal rachet system of the swivel handle (6). With dotted lines, we can distinguish the channels (60), between which the butt (59) of the swivel handle (6) will rotate and hit. Also we can notice the half superior (22) and inferior moons (15) identifying the small base (10) to the center of the half superior moon (22). This small base (10) serves to couple in itself the buttonhole (9) corresponding to the central thread (11).

Drawing 27: it shows the rear view of the central base (4), graph drawn in scale 1=1, representing the small size of the different offered sizes to manufacture. At first glance, we see the heads of the 6 screws (23) that maintain together the half superior moon (22) with the rest of the central base (4). We can also observe the milimetric channels (60) between which the butt (59) will rotate and hit. Also we can see the over-relief male (24) with milimetric thread to the center, over-relief male (24), which is formed with the same material of the central base (4). This male is a component of the internal rachet system of the swivel handle (6).

Drawing 28: it shows an aerial view of the removable paper sheet fixer accessory of (65) for the left door. It will be used in the small and standard size structures. The medium, large and extra large size structures will have their own removable paper sheet fixer accessories designed and manufactured according to their sizes. These accessories will possess a spring system that will make possible their operation as paper sheet fixers, maintaining fixed the foot that lies over a small portion of the reading material. The foot will be transparent allowing to read through it.

Drawing 29: it shows the front view of the removable paper sheet fixer accessory (65) in small size, graph drawn in scale 1=1, which will be used in the small and standard size structures.

Drawing 30: it shows the rear view of the removable paper sheet fixer accessory (65) to be installed on the small and standard size structures.

Drawing 31: it shows the aerial view of the left paper sheet holder door (56), with its left removable paper sheet fixer accessory (65) assembled and positioned in the right place to use it. This accessory will possess a spring system that will make possible to stay fixed when it is in the transportable position, and will also allow the paper sheets to be firmly fixed when using it. If you want to turn the page, it is necessary to raise the transparent foot of the paper sheet fixer accessory (65) and to put it back to fix it again. The transparency of this foot will allow the reading through it. We can also notice the position that will be adopted by the superior fin (62) corresponding to the floodgate of the interior system when a hard cover publication is in use. Simultaneously, we see the aerial view of the paper sheet holder (63) for certain publications and the supporting fin of paper sheets (54) of the left paper sheet holder door (56), aerial view of this supporting fin of paper sheets (54) in which we can identify the circular female (74) in which the male (73) corresponding to the supporting spacer of paper sheets (55) will be inserted when desired to use it.

Drawing 32: it shows the aerial view of the right paper sheet holder door (31), with its right removable paper sheet fixer accessory (53) assembled and in transportable position. This accessory will possess a spring system that will make it possible to stay fixed as hear shown in its transportable position and without using it. We can also recognize the position that will be adopted by the superior fin (36) corresponding to the floodgate of the inferior system when a hard cover publication is in use. Simultaneously, we observe the aerial view of the paper sheet holder (37) for certain publications, and the supporting fin of paper sheets (45) of the right paper sheet holder door (31). Aerial view of this supporting fin of paper sheets (45) in which we can distinguish the circular female (64) in which the male corresponding to the right supporting spacer of paper sheets (46) will be inserted (47) when desired to use it.

Drawing 33: it shows the aerial view of the right paper sheet holder door (31), with its removable paper sheet fixer accessory (53) assembled and positioned in the right place to use it. We can recognize through the dotted lines the range of movement of the feet that constitute the removable paper sheet fixer accessory (53) which has a spring system that makes possible its operation. Additionally, we can distinguish the floodgate of the interior system (32) so positioned to allow a hard cover book to be placed between the same (32) and the paper sheet holder door (31) having firmly fixed the floodgate of the interior system (32) with the paper sheet holder door (31) by means of the superior fin (36) corresponding to this interior system.

Drawing 34: it shows the right side view of the invention with the doors closed and firmly fastened with Velcro (1), with the removable paper sheet fixer accessory (53) in transportable position and without using it and with the swivel handle (6) in horizontal position. The structure is represented in the small size, ideal for books like the Bible in conventional size.

Drawing 35: it shows the right side view of the invention, with the doors closed and firmly fastened with Velcro (1) with the removable paper sheet fixer accessory (53) in transportable position and without using it and with the swivel handle (6) in horizontal position.

Drawing 36: it shows the right side view of the invention, with the doors closed and firmly fastened with Velcro (1), with the removable paper sheet fixer accessory (53) in transportable position and without using it and with the swivel handle (6) in horizontal position. The structure is represented in medium size, ideal for the magazines a little bigger than conventional size, for example: “Style” magazine, “Wire” magazine, etc.

Drawing 37: it shows the right side view with the doors closed and firmly fastened with Velcro (1), with the removable paper sheet fixer accessory (53) in transportable position and without using it and with the swivel handle (6) in horizontal position.

Drawing 38: it shows the right side view with the doors closed and firmly fastened with Velcro (1), with the removable paper sheet fixer accessory (53) in transportable position and without using it and with the swivel handle (6) in horizontal position.

Drawing 39: it shows the right side view with the doors closed and firmly fastened with Velcro (1), with the removable paper sheet fixer accessory (53) in transportable position and without using it and with the swivel handle (6) in vertical position. This vertical position of the handle (6) is the right position to assemble the structure in an expandable arm or tripod.

Drawing 40: it shows the right side view with the doors closed and firmly fastened with Velcro (1), with the removable paper sheet fixer accessory (53) in transportable position and without using it and with the swivel handle (6) in vertical position. This vertical position of the handle (6) is the right position to assemble the structure in an expandable arm or tripod.

Drawing 41: it shows the right side view of the invention with the doors closed and firmly fastened with Velcro (1), with the removable paper sheet fixer accessory (53) in transportable position and without using it and with the swivel handle (6) in vertical position. This vertical position of the handle (6) is the right position to assemble the structure in an expandable arm or tripod. In this way it offers an option when manufacturing the structure, giving better stability when it is necessary to open the structure and to lay it on a table or desk, placing the swivel handle (6) in horizontal position as base and stabilizer.

Drawing 42: it shows the right side view with the doors closed and firmly fastened with Velcro (1), with the removable paper sheet fixer accessory (53) in transportable position and without using it and with the swivel handle (6) in vertical position. This vertical position of the handle (6) is the right position to assemble the structure in an expandable arm or tripod. In regard to the swivel handle (6), this graph shows a longer fastener than in drawings #39 and #40, offering an option to give better stability when it is necessary to open the structure and to lay it on a table or desk, placing the swivel handle (6) in horizontal position as base and stabilizer offering then better maneuverability when holding it with one hand or two hands.

Drawing 43: it shows the right side view of the invention with the doors closed and firmly fastened with Velcro (1), with the removable paper sheet fixer accessory (53) in transportable position and without using it and with the swivel handle (6) in vertical position. This vertical position of the handle (6) is the right position to assemble the structure in an expandable arm or tripod.

Drawing 44: it shows the aerial view of the invention with the swivel handle (6) in horizontal position having coupled a hard-cover book (67). The paper sheets (66) of this book are between the paper sheet holder doors, (31) and (56), which are in turn firmly fastened with Velcro (1). The removable paper sheet fixer accessories, (53) and (65), have been assembled in a transportable position and without using them.

Drawing 45: it shows the aerial view of the invention with the swivel handle (6) in vertical position having coupled a hard-cover book (67). The paper sheets (66) of this book are between the paper sheet holder doors, (31) and (56), which are in turn firmly fastened with Velcro (1). The removable paper sheet fixer accessories, (53) and (65), have been assembled in a transportable position and without using them.

Drawing 46: it shows the aerial view of the invention with the paper sheet holder doors open, (31) and (56), holding an open hard-cover book (67) and with the swivel handle (6) in horizontal position. Position for this swivel handle (6) in horizontal position. This is the required position of the swivel handle (6) when you are holding the invention with one or two hands. We also see the open paper sheets (68) of this book that are fastened by means of the removable paper sheet fixer accessories, (53) and (65). We can identify the supporting spacers of paper sheets, (46) and (55), which will be used only when a hard-cover book has been coupled. Then, we can observe the join (57) that allows the right supporting spacer (46) of paper sheets to rotate 360 degrees and to insert itself into the supporting fin of paper sheets (45) of the same side. We also can identify the join (58) that allows the left supporting spacer (55) of paper sheets to rotate 360 degrees and to insert itself in the supporting fin of paper sheets (54) of the same side. You can observe how the hard cover (67) of the book is between the paper sheet holder door (31) and the floodgate of the interior system (32). You can also observe how the superior fins, (36) and (62), fix the floodgates of the internal system with the paper sheet holder doors (31) and (56).

Drawing 47: it shows the aerial view of the invention, in the position that will be used when it is required to be assembled in an expandable arm (77) or tripod, placing the swivel handle (6) in vertical position. This swivel handle (6) has a hole (78) along the main cylinder (27)—a hole in which will be inserted the plug corresponding to the expandable arm (77) or tripod, and by this way the structure will be able to float in the air, sustaining the rigid and hard-cover book (67) open and in perfect position. Also we can spot the right (46) and left (55) supporting spacers, having rotated them previously 360 degrees by means of the right (57) and left (58) joins. The right (46) and left (55) supporting spacers are located on the supporting right and left fins (45), (54).

Drawing 48: it shows the aerial view of the invention with the revolvable or rotating handle (6) in horizontal position having coupled a publication of soft binding (70). We observe the closed (69) publication of soft binding which paper sheets are situated between both paper sheet holder doors (31) and (56). These are supported by means of the Velcro (1). The removable fixer accessories (53) (65) have been assembled in a transportable position and without using it.

Drawing 49: it shows the aerial view of the invention with the swivel handle (6) in vertical position, carrying a publication of soft binding (70), observing the paper sheets (69) of this publication between both paper sheet holder doors (31) and (56) which in turn are supported or fixed by means of the Velcro (1) having assembled the removable fixer accessories of paper sheets right (53) and left (65) in the transportable position and without using it. The transportable position of the invention is represented in this graph, application that will be put into practice when we place the structure in this position stopping it when grabbing with the hand the swivel handle (6). Also we can observe the right and left superior fins (36) (62) that correspond to the floodgates of the interior system and to the females (61), which are 4 and they have a millimetric thread that will be useful to adapt to the optional accessory of illumination (75) that is mentioned in the explanation of this drawing but it is not presented in this graph.

Drawing 50: it shows the aerial view of the invention having open the paper sheets holder doors (31) and (56), carrying a publication of soft binding (79) and holding the swivel handle (6) that will be used when we stop the invention with one or two hands. We also see the open paper sheets (71) of this publication of soft binding (70), which are fixed by means of the removable fixer accessories of paper sheets, right (53) and left (65). We can observe that the soft binding (70) of this publication is between the paper sheet holder doors (31) and the floodgate (32) of the interior system. Additionally, if desired, it is possible to insert both the soft cover (or binding) (70) and a small group of paper sheets of the beginning or end of a publication. In this graph, we can see the supporting fins of paper sheets (45) and (54), sustaining the paper sheets of this publication of soft binding (70), without using the right (45) and left (54) supporting spacers of paper sheets. Also we can see the right (36) and left (62) fins that correspond to the floodgates of the interior system, we also can observe the 4 females (61) with millimetric thread, which is useful to assemble the optional accessory of illumination (75), we can also notice the butt (59) corresponding to the swivel handle (6). This butt will be useful to avoid the handle to rotate totally on its axis and by this way to avoid the structure to rotate without control, when there are more sheets in one of the paper sheet holder doors than the other, right (31) and left (56).

Drawing 51: it shows the aerial view of the invention in the position that will be used when it is required to be assembled in an expandable arm (77) or tripod, carrying a publication of soft binding (70), placing the swivel handle (6) in the vertical position. This swivel handle (6) will have an egg (78) along the main cylinder (27)—hole in which the male or plug of the expandable arm or tripod will be inserted (77), and consequently the structure will be able to be detained in the aerial, having open and in perfect position the publication of soft binding (70) that is used. We also see the open paper sheets (71) of this publication of soft cover (70), which are fixed by means of the removable fixer accessories of paper sheets, right (53) and left (65). In this graph, we also see to the right (45) and left (54) supporting fins of paper sheets sustaining the paper sheets of this publication of soft cover (70), without using the right (45) and left (54) supporting spacers of paper sheets. We also observe the open paper sheets (71) of this publication of soft binding (70), which are fixed by means of the right (53) and left (65) removable fixer accessories of paper sheets. In this graph, we notice the supporting fins of paper sheets (45) and (54), sustaining the paper sheets of this publication of soft cover (70), without using the right (45) and left (54) supporting spacers of paper sheets. Also we can observe the right (36) and left (62) fins that correspond to the floodgates of the interior system and on the half superior moon (22) we can see the 4 females (61) with millimetric thread, which will be useful for assembling the optional accessory of illumination (75).

Drawing 52: it shows the aerial view of the invention, without having assembled the swivel handle (6). You can recognize that the structure has coupled a book of stiff and rigid cover or binding (67)—book that is totally placed between both paper sheet holder doors (31) and (56), having the paper sheets (66) of this closed book to the center, between the floodgates of the internal system, right (32) and left (81). We can see that the paper sheet holder doors (31) and (56) are supported by means of the Velcro (1). Also, we see the removable stopper accessories of paper sheets (53) and (65) in the transportable position and without being used. We can observe how the hard cover (67) of this book is between the paper sheet holder door (31) and the right floodgate (32) of the interior system, we also see the superior fins (36) and (62), fixing the right (32) and left (81) floodgates of the interior system with the paper sheet holder doors (31) and (56), we can observe other elements as the 4 females (61) with millimetric thread that will be useful to adapt it to the optional accessory of illumination (75). We see the hexagonal male (24) with a thread to the center, in which will be assembled the swivel handle (6) forming consequently a single unit and leaving an internal system rachet. With dotted lines we see the butts (5) and the small base (10), which are elements that constitute part of the central base (4) of the structure. To the center of the book, among the paper sheets, although it is not visible, there is a central thread (11) that is assembled by a buttonhole (9) in the base (10) fastening and supporting the hard-cover book (67) that here is used. We also see the right (37) and left (63) stoppers for certain publications with a sequence of 4 paper sheets, stoppers (37) and (63), which are in a transportable position and without being used.

Drawing 53: it shows the aerial view of the central base (4) of the invention, together with the right paper sheet holder door (31) without having assembled the swivel handle (6), simultaneously we will see inside the structure the right section of an opened book of hard cover (67), being able to distinguish the paper sheets (68) fixed by means of the removable fixer accessory of paper sheets (53) We also can observe the use of the supporting spacer of paper sheets (46), which will start functioning only when a hard-cover book has been coupled (67). We can observe how the hard cover (67) of the book is between the paper sheet holder door (31) and the right floodgate (32) of the internal system. Also we can see how the superior fin (36) fastens the right floodgate (32) of the internal system with the paper sheet holder door (31). With dotted lines we can observe the female (72) that corresponds to the butt (5); female (72), in which the male (16) of the paper sheet holder door (31) will be inserted. Females (72) and males (16) that constitute the system of hinges of the paper sheet holder doors, (31) and (56).

Drawing 54: it shows the aerial view of the central base (4) of the invention, together with the paper sheet holder door (56) and without having assembled the swivel handle (6), carrying the left section of an opened book or hard cover (67), then it's easy to see the aerial view of the paper sheets (68) fixed by means of the paper sheet removable fixer accessory (65). We also see the use of the paper sheet supporting spacer (55), which is mounted when rotating it in 360 degrees on the left paper sheet supporting fin (54) corresponding to the left paper sheet holder door (56). The paper sheet supporting spacer (55) will be put into practice only when it is required to couple a hard-pasta book (67).

Drawing 55: it shows the aerial view of the invention, without having assembled the swivel handle (6). You can observe that the structure has coupled a publication of soft cover (70). This publication is entirely situated between the right and left paper sheet holder doors (31) (56), which are closed and insured with the Velcro (1), the paper sheets (69) of this publication are sustained by means of the paper sheet supporting fins (45) and (54) that are clearly overlapped below the magazine. The removable accessories and paper sheet fixers (53) and (65) are assembled and in transportable position without being used. Also you can observe how the soft cover (70) of this publication is between the floodgate (32) of the interior system and the paper sheet holder door (31)—a space where if desired a group of paper sheets can be placed in addition to the soft cover. We can also mark on the half superior moon (22) corresponding to the central base of the structure (4) the 4 females (61) with milimetric thread which will be needed to be assembled to the optional accessory of illumination (75). We also see the hexagonal and embossed male (24) with milimetric thread to the center, or it can be formed with the same material of the central base (4), in which the swivel handle (6) is assembled, internally constructing the “rachet” (7) system.

Drawing 56: it shows the aerial view of the central base of the invention (4), together with the right paper sheet holder door (31) carrying the right section of a soft cover publication (70). We can see the paper sheets (71) fixed by means of the paper sheet removable fixer accessory (53). You can deduce that when using publications of soft pasta it isn't necessary to use the paper sheet supporting spacer (46); so the paper sheet supporting fin (45) corresponding to the right paper sheet holder door (31) is free and without the paper sheet supporting spacer (46). We see the circular female (64) where the paper sheet supporting spacer (46) is incrusted or coupled when this is in use. The paper sheet supporting spacer (46) is mentioned in the explanation of this drawing and we can observe it in the dotted lines under the right paper sheet supporting fin (45).

Drawing 57: it shows the aerial view of the central base (4) of the invention together with the paper sheet holder door (56), and without having assembled the swivel handle (6). We also see that the structure is supporting the left section of a soft cover publication (70). We can perceive the aerial view of the paper sheets (71), which are sustained by means of the central base (4) and the left paper sheet supporting fin (54) corresponding to the paper sheet holder door (56). We can additionally notice how the left superior fin (62) corresponding to the system of interior floodgate fastens and supports this left floodgate (81) with the paper sheet holder door (56). We also observe the 4 milimetric females (61) that will be useful when it is needed to assemble the optional accessory (75) of illumination. We can also identify the circular female (74) where the paper sheet supporting spacer (55) is incrusted or coupled when this is in use. The paper sheet supporting spacer (55) is incrusted or coupled when this is in use. The paper sheet supporting spacer (55) is mentioned in the explanation of this drawing and we can observe it in dotted lines under the left paper sheet supporting fin (54).

Drawing 58: it shows the aerial view of the optional accessory of illumination, which is necessary to be screwed on the half superior moon to adapt it with the invention (22) of the central base (4). With dotted arrows you can identify the range of horizontal movement of the lamps corresponding to this optional accessory (75).

Drawing 59: it shows the right view of the optional accessory (75) of illumination.

Drawing 60: it shows the left view of the optional accessory of illumination (75), being able to identify the range of inclination of the lamp by means of the dotted arrows.

Drawing 61: it shows the aerial view of the invention with the swivel handle (6) in horizontal position, having assembled the optional accessory of illumination (75), having coupled a hard cover book (67), observing the closed paper sheets (66) of this book, which are between the paper sheet holder doors (31) and (56),

those which in turn are assured by means of the Velcro (1). Also we see to the accessories removable fixers of paper sheets (53) and (65) in transportable position and without using. Also paper sheet the aerial view of the stopping ones (37) and (63) for the enlarged paper sheets paper sheets in certain publications.

Drawing 62; it shows the aerial view of the invention with the swivel handle (6) in vertical position, having coupled a book of hard cover (67) assembled to the optional accessory of illumination (75). We can observe the closed paper sheets (66) of this book between the paper sheet holder doors (31) and (56), which in turn are assured by means of the Velcro (1). We also see the right and left removable paper sheets fixer accessories in transportable position and without using them. This graph also represents the transportable position of the invention, application that will be put into practice when we place the structure in this position stopping it when grabbing with the hand the swivel handle (6).

Drawing 63: it shows the aerial view of the invention having assembled the optional accessory of illumination (75), the structure is in the required position needed to float in the air with the paper sheet holder doors (31) and (56) opened and with the hard cover book (67) assembled. By means of the swivel handle (6) in vertical position and with a hole (78) along the main cylinder (27), it is possible to assemble the structure in the expandable arm of the base (77). Additionally, the removable accessories of the paper sheet fixers (53) and (65) are in use.

Drawing 64; it shows the aerial view of the invention with the paper sheet holder doors (31) and (56) opened, supporting a hard cover book (67) and having assembled the optional accessory of illumination (75). We see the swivel handle (6) in the rotating position (6)—position used when we stop the invention with one or two hands. We also note the open paper sheets (68) of this book. These (68) are fixed by means of the removable accessories of the paper sheet fixers (53) and (65).

Drawing 65: it shows the aerial view of the invention without having assembled the swivel handle (6) and having assembled the optional accessory of illumination (75). You can notice that the structure is supporting a hard cover book (67). This book is entirely located between the paper sheet holder doors (31) and (56). These in turn are assured by means of the Velcro (1). Also we see the stopping removable accessories of paper sheets (53) and (65) in transportable position and without being used. The description of the drawings #66 to the #80 contain a group of innovations related to this invention that constitute the ramification #2.

Drawing 66: it shows the aerial view of the optional accessory of illumination (82). In this graph we can analyze the different components of this optional accessory corresponding to the invention. It is important to observe the coupling guides (83) that allow you to assemble this accessory with the invention without using any screws. Also we can observe the milimetric females (95) in which the coupling system will be assembled—quality of the central base (4) of the invention. With dotted lines, we can observe the batteries double “AA” (84). These are installed inside the capsules (99) and to have access to these batteries (84), it will be necessary to unlock the superior part from these capsules when inserting the fingernail of one of the user's fingers inside the small spaces, (100) pulling up to the superior cover of these capsules (84). We also observe the bulbs (85) of this optional accessory of illumination. These are sheltered by means of their protectors (101). These protectors (101) have a milimetric thread (103) that allow to coil and uncoil them. Additionally, they possess a cut (102) in the inferior part to allow the light of these bulbs (85) to project. We also observe the female connector (90) that will serve to connect the male of the 110 V to 12 V transformer, and the ON/OFF switch (91) of this optional accessory of illumination.

Drawing 67: it shows the right lateral view of the superior part of the central base (4) of the invention, being able to observe on the half superior moon (22) the coupling system for the optional accessory of illumination (82). This system consists of the following pieces: The superior piece (86), which has an upward movement range. It is necessary to unlock it in order to be able to assemble the optional accessory (82) of illumination that by means of their guides (83) it will slip and will attach itself to the fixed inferior pieces (87). When this optional accessory of illumination (82) is totally inside the half superior moon (22), it will be necessary to press the superior piece (86) down, until this is completely attached to the fixed inferior piece (87). The accessory of illumination must be fixed or attached by means of the superior males (89). These will be incrusted inside the milimetric females (95) that correspond to the optional accessory of illumination (82). We can also observe the right milimetric screw (88) that serves as axis for the superior piece (86) with movement range.

Drawing 68: it shows the right lateral view of the superior part of the central base (4) of the invention, being able to observe on the half superior moon (22) the coupling system for the optional accessory of illumination (82) that consists of the following pieces. We can see the right superior piece (86) that is detached from the inferior piece (87), being able then to identify the range of movement of this superior piece (86) with dotted lines. This superior piece (86) will be in an unlocked or detached position in regard to the fixed inferior piece (87) in order to be able to assemble the optional accessory (82) of illumination that by means of their guides (83) will be assembled in the fixed inferior pieces (87). When this optional accessory of illumination (82) is totally inside the half superior moon (22), it will be necessary to press the superior piece (86) down, until this is completely attached to the fixed inferior piece (87). The accessory of illumination must be fixed or attached by means of the superior males (89). These will be incrusted inside the milimetric females (95) that correspond to the optional accessory of illumination (82). We can in addition observe the right milimetric screw (88), which serves as axis for the superior piece (86) with movement range.

Drawing 69: it shows the right lateral view of the superior part of the central base (4) of the invention, being able to observe the detached coupling system of the optional accessory of illumination (82) over the half superior moon (22). This coupling system consists of the following pieces: the right and left superior pieces (86), which possess an upward movement range. The fixed right and left inferior pieces (87) that are useful to direct the optional accessory (82) of illumination in the coupling. These right and left fixed inferior pieces will also be helpful to attach the superior pieces (86) that possess movement range which, when being begun when having assembled to the optional accessory of illumination, it will immobilize this. It also shows us the right screw (88) that serves of axis for the range of movements of the piece (86) right superior, this screw (88) it passes through the females (102).

Drawing 70: it shows the front view of the central base (4) of the structure, being able to observe on the half superior moon (22) the coupling system of the optional accessory of illumination (82). This coupling system consists of the following pieces: superior pieces (86) which are attached to the fixed inferior pieces (87). These superior pieces (86) have an upward movement range and they must be detached by pulling them up in order to be able to assemble the optional accessory of illumination (82) This accessory will be assembled in the fixed inferior pieces (87) by means of its guides (83). When this optional accessory of illumination (82) is totally inside the half superior moon (22), it will be necessary to press the right and left superior pieces (86) down, until these are completely attached to the fixed inferior pieces 887). The accessory of illumination must be fixed or attached by means of the superior males (89). These will be incrusted inside the milimetric females (95) that correspond to the optional accessory of illumination (82). Likewise, we can observe the milimetric screws (88), which will serve as axis and will give a range of movement to the superior pieces (86).

Drawing 71: it shows the aerial view of the central base (4) of the invention which illustrates on the half superior moon (22) the coupling system of the optional accessory of illumination (82): This coupling system consists of the following pieces: the right and left pieces (86) that are attached to right and left fixed inferior pieces(87) marked with dotted lines. The superior pieces (86) possess an upward range of movement. It will be necessary to unlock them in order to be able to assemble the optional accessory of illumination (82). The optional accessory of illumination (82) will be assembled by means of its guides (83) in the fixed inferior pieces (87). When this optional accessory of illumination (82) is totally inside the half superior moon (22), it will be necessary to press the right and left superior pieces (86) down, until these are completely attached to the fixed inferior piece 887). The accessory of illumination must be fixed or attached by means of the superior males (89). These will be incrusted inside the milimetric females (95) that correspond to the optional accessory of illumination (82). Likewise, we can observe the milimetric screws (88), which will serve as axis and will give a range of movement to the superior pieces (86).

Drawing 72: it shows the aerial view of the invention without having assembled the swivel handle (6) and with the optional accessory of illumination (82), using the coupling system of the central base (4) to be able to couple the optional accessory of illumination (82). We observe the superior pieces 886) that have a range of movement and are attached to the inferior pieces (87) shown with dotted lines. We observe that the optional accessory of illumination (82) is immobilized by means of the males (89) that belong to the superior pieces (86) inserted inside the milimetric female (95). Pieces, (95) and (89) can be distinguished in dotted lines. We can observe the ON/OFF switch (91) when connected to 110V. The structure is holding a hard cover book (67). This book and its paper sheets (66) are entirely located between the paper sheet holder doors (31) and (56). These in turn are assured by means of the Velcro (1). We also see the stopping removable paper sheet accessories, (53) and (65), in the transportable position and without using them.

Drawing 73: it shows the left lateral view of the right door of the invention, in which we can distinguish with dotted lines the range of movement of the supporting spacer of paper sheets (46). When the spacer is attached to the supporting paper sheet fin 845) by means of the system of double hinge, which consists of screws (94), joints (93) and females (92), it will be able to rotate in 360 degrees. When performing this movement, this will allow the paper sheet spacer to position itself on the supporting fin of paper sheets (45), using the male (47) and to the circular female (64) to position itself on the female (45). We can also see the left lateral view of the holder for enlarged paper sheets paper sheets (37) with its axis (52), the left lateral view of the Velcro (1), the over-relief space 842) that will serve to sustain the optional removable fixer accessory of paper sheets (53), the borders of the superior and inferior fins, (36) and (35), corresponding to the interior system of floodgates, the system of hinges (33) with its screws (34) that give internal movement to the right floodgate (32) of the interior system.

Drawing 74: In this drawing we see the supporting spacer of paper sheets (46). It has already been rotated and positioned on the supporting fin of paper sheets (45). We see an element (48) that is a locking device to which the supporting spacer of paper sheets will be fastened or attached (46) when this rotates to its original position. The system of double hinge is shown and it is part of the ramification #2 consisting of the following pieces: screws (94), joints (93) and females (92). We can also see the left lateral view of the holder for enlarged paper sheets (37) with its axis (52), the left lateral view of the Velcro (1) and the space over relief (42) which is handy to assemble the fixer accessory of paper sheets (53). The system of double hinge for the supporting spacer of paper sheets (46) that is part of the ramification #2 is the difference with the joint (57) that constitutes part of the ramification #1 presented in the drawings #12 and #13.

Drawing 75: it shows the left lateral view of the right door of the invention, in which we can see the supporting spacer of paper sheets (46) and their system of double hinge temporarily disabled. This double-hinge system consists of: screws (94), milimetric females (92) and joints (93). This double-hinge system is responsible of making possible a 360-degree rotation of the supporting paper sheet spacer (46) and by this way to be positioned on the supporting fin of paper sheets (45) or to rotate to its original position, attaching itself to the locking devices 848) adopting its transportable position and without being used. We can also see other elements: right lateral view of the holder for enlarged paper sheets paper sheets (37) with its axis (52); right lateral view of the Velcro (1) and the space over relief (42) that will serve to stop the optional removable fixer accessory of paper sheets (53).

Drawing 76: it shows the aerial view of the left paper sheet holder door (56) having assembled it in a transportable position and without using the optional removable fixer accessory of paper sheets (65). We also see the supporting spacer of paper sheets (46) temporally disabled showing its pieces; in dotted lines, the circular male (47) which is below the supporting spacer of paper sheets (46). This supporting spacer of paper sheets (46) is incrusted inside the circular female (74) which should be inside the supporting fin of paper sheets (54) when desired to rotate it in 360 degrees. We also see the components of the system of double hinge; the screws (94) that will be screwed in the milimetric female (92) which have a butt (96) that will allow the milimteric joints (93) to be attached or fastened by means of the screws (94) with the freedom of rotating in 360 degrees. This also allows the supporting spacer of paper sheets (46) to rotate in 360 degrees being able to be positioned perfectly on the supporting fin of paper sheets (54) when it is wanted to be used or to rotate to its original position being placed below the supporting fin of paper sheets (54) in a transportable position and without being used. We also see the holder for left enlarged paper sheets (63) that will be rotated in 90 degrees on its own axis (52) when it is wanted to be used. The holder for the enlarged paper sheets paper sheets (63) will be used when magazines that possess expandable paper sheets are being read making a sequence of four paper sheets, being able to have those paper sheets in perfect condition and position for their reading.

Drawing 77: it shows the aerial view of the half superior moon (22) together with the central base (4) of the structure, showing the mechanism of springs (97) which are located inside superior butts (5) next to the half superior and inferior moons (22) next to the half inferior moon (15). This mechanism of springs (97) will maintain open the paper sheets holder doors, (31) and (56), when desired to keep them open.

Drawing 78: it shows the aerial view of the half superior moon (22) together with the central base (4), having the paper sheets holder door, (31) and (56), closed and drawn in sections. The dotted arrows show the range of movements that the mechanism of springs (97) will maintain when the paper sheets holder doors, 831) and (56), are open or close.

Drawing 79: it shows the front view of the half superior moon (22) with the superior butts (5). They form together a single piece, which is a shape independent from the central base (4) of the structure. We can also see the cavities (98) inside the superior butts (5); these cavities will be handy and useful to assemble the mechanism of springs (97). These cavities (98) will also be inside the inferior butts (5) inside which the springs will be assembled (97), allowing the mechanism to keep the paper sheet holder doors, (31) and (56), open when you wish to keep them open. We can also distinguish the females (76) shown by dotted circles inside which the screws will be installed (23) and will attach the butt (5) with the half superior moon (22) next to the central base (4). On the half superior moon (22), the pieces (86) that belong to the coupling system for the optional accessory of illumination (75) are visible.

Drawing 80: it shows the half superior moon (22) assembled to the central base (4), firmly attached to these pieces by means of screws (23), the pieces of the paper sheet holder doors (31) and (56), and the disassembled springs (97). Because of the transparent plastic used to manufacture the pieces, it is possible to distinguish the cavities (98) that are inside the superior butts (5). These cavities are inside the inferior butt (5) and the paper sheet holder doors, (31) and (56), in which the springs are assembled (97) allowing to be tightly attached and functional at the same time. This results in an independent system of springs for the paper sheet holder doors, (31) and (56), which are drawn in sections. When using the system of springs, the pieces will be kept open when so desired, no matter the invention's position chosen by the user. When the user wants to close the invention, he/she will press the paper sheet holder doors, (31) and (56), toward the center to close it and to fix it with the Velcro (81) when desired.

Drawing 81: it shows the aerial view of the laptop (104) having connected the handle specially designed with 2 axes (103), this handle will help to mount and to dismount the laptop (104), pressing at the same time the levers (105) that are the revolvable male adapters of the swivel handle—part of the mechanism to mount and to dismount the swivel handle of the female adapters (125) that are inside the portable structure (104).

Drawing 82: it shows the rear view of the laptop (104), where you can notice with dotted lines the females (125) that are inside the structure of the laptop (104) that serve to connect and firmly fix the males (105) of the swivel handle; it can also be identified the area (126) which is inside the structure of the laptop (104) that serves to assemble the swivel handle (103). We can also see the connections (127) that are standard in all laptops. Likewise, we can observe the area of the structure that contains the screen (121).

Drawing 83: it shows the right view of the laptop (104) in vertical position and with the swivel handle connected. At the same time the levers can be identified (105) and they are part of the revolvable males of the handle that are assembled inside the females (125); we also note the hole (106)—key part of the handle that allows to place the laptop in the expandable arms.

Drawing 84: it shows the revolvable left side of the handle.

Drawing 85: it shows the aerial view of the assembled swivel handle.

Drawing 86: it shows the aerial view of the swivel handle disassembled and the different pieces that conform the same (103), specially designed with 2 axes, beginning with the hole (106) that serves to assemble the swivel handle in vertical position in an expandable arm (120), the sponge (116) that offers comfort when grabbing the main cylinder (114); the males (115) with the required incorporated female (106) necessary for the assembling system of the main cylinder (114) and the rotating piece (109). This rotating piece possesses the central axis male of the swivel handle, which is assembled in the female (110) and is fixed by means of the screw (109) with milimetric thread. The screw is screwed in the piece (113) that will be fastened by the two half moons (108) when the swivel handle is assembled. These two half moons compose the central structure of the swivel handle and are firmly fixed by the rivets (111). We can also identify the springs (107) necessary for the assembling mechanism of the swivel handle (103). These springs (107) push towards the males (105) of the swivel handle creating then the horizontal axis of the mentioned handle.

Drawing 87: it shows the right view of the laptop, with the swivel handle (103) assembled in horizontal position, which is an example of one of the positions in which the laptop can be sustained comfortably and steadily in one arm and with one hand. You can also identify the different parts of the swivel handle (103) and the portable computer (104): the hole (106) that runs along the main cylinder (114) necessary for assembling or placing the laptop in expandable arms (120) or tripods; the sponge (116) that wraps the main cylinder (114) for user's comfort when sustaining the cylinder; the males (115) with incorporated female (106) necessary for the assembling system of the main cylinder and the rotating piece (109); the small levers (105) that are part of the males of the swivel handle. Part of the assembling system of the laptop and swivel handle can be identified to the center of the data processor (104) joined to the fully opened screen (121).

Drawing 88: it shows the right view of the portable computer placed on a table, and we see the swivel handle (103) assembled in horizontal position and the open screen (121); we can also see the small levers (105) that are part of the males, elements required to assemble the swivel handle (103) in an expandable arm (120) and the sponge (116) that wraps the main cylinder (114) for user's comfort when sustaining the main cylinder.

Drawing 89: it shows the left view of the laptop. In this drawing, we can view how the CPU (104) is placed on your lap with the screen open (121) and it also shows how the swivel handle (103) should be placed when being fixed between the user's knees.

Drawing 90: it shows the right view of the laptop placed on a table, using the swivel handle (103) to raise the CPU (104) and keyboard up to an inclination of 35°, having the screen (121) open.

Drawing 91: it shows the right view of the laptop using the swivel handle(103) in vertical position assembled in an expandable arm (117), joined by means of the female or hole (106) that runs along the main cylinder (114) and the male (118) of the expandable arm (117). The CPU will be in an angle of 50° and the screen (121) will be open.

Drawing 92: it shows an expandable arm (117) placed on a table in which the swivel handle (103) is assembled, using the coupling system the male (118) with the female (106) of the swivel handle. It can also be distinguished the detachable keyboard (119) lying on a table, the (104) CPU sustained in the air with 50 degrees of inclination and the screen (121) open. The inclination angle can be set and modified as the user deems convenient.

Drawing 93: it shows the right view of the laptop, which is assembled in an expandable arm (120), screwed in a wall. This is possible thanks to the male (118) of the expandable arm and the hole or female (106) of the swivel handle. The laptop will be practically sustained in the air. The CPU and keyboard form an angle of 50 degrees, with the screen (121) open.

Drawing 94: This drawing shows a rear view of the laptop when it is completely open. The CPU (104) is in the inferior area, the structure that contains the screen (121) is in the superior area and the swivel handle (103) is in vertical position located in the center. This is the required position when you need to assemble the expandable arm.

Drawing 95: this drawing shows the rear view of the laptop when it is completely open. The CPU (104) is in the inferior area, the structure that contains the screen (121) is in the superior area and the swivel handle (103) is in horizontal position located in the center.

Drawing 96: this drawing show a front view of the laptop when it is completely open. The CPU (104) and the detachable keyboard (119) are in the inferior area. In this drawing, we can also identify the half moons (123) necessary to dismount the keyboard with the fingers. We can also observe the screen (121) in the superior area and the swivel handle (103) in the center, represented with dotted lines.

Drawing 97: it shows the front view of the laptop when it is completely open and without the keyboard. The CPU (104) is in the inferior area, exactly where (124) the detachable keyboard should be located. The screen (121) is in the superior area. It is easy to recognize the right border of the swivel handle (103) which is connected backwards and it is visible through the hole of the hinge that joins the CPU (104) with the screen (121).

Drawing 98: it shows the left view of the laptop in the ramification No. 1 with the swivel handle (103) assembled, where we can distinguish the rail (129) that slips through the males (131) that run along this rail and within the females (137), which are part of the laptop structure. The swivel handle (103) can be easily mounted and dismounted from the rail by pressing the levers (105) that are part of the males of the swivel handle and that will couple in the females (130) of the rail. When the rail (128) is mounted in the structure of the computer (104), the connections (127) will be covered. This means that when it is necessary to use these connections, it will be necessary to disassemble the rail (128). It can also be distinguished the hole or female (106) of the rotating main cylinder of the handle (103), and the CPU (104) with the screen (121) that run inside the females (137)—part of the structure of the laptop. The connections (127) will be then covered.

Drawing 99: it shows the right view of the laptop in the ramification No. 2 with the swivel handle (103) assembled, where we can see how the rail (128) is coupled slipping by means of the females (138) with the males (129) that are part of the structure of the laptop. The swivel handle (103) can be easily mounted and dismounted from the rail by pressing the levers (105) that are part of the males of the swivel handle and that will couple in the females (130) of the rail. When the rail (128) is mounted in the structure of the computer (104), the connections (127) will be covered. This means that when it is necessary to use these connections, it will be necessary to disassemble the rail (128). This drawing also shows the place (106) of the main cylinder (114), part of the swivel handle (103) and the CPU (104) with the screen (121) closed. The main basis of the ramification No. 2 and the difference of the design relies on the rail (128) with the females (138) that couple slipping within the males (129)—part of the structure of the laptop. The connections (127) are covered.

Drawing 100: it shows the rear view of the laptop (104) with the rail (128) assembled and without the swivel handle (103). We can also identify the females (139) represented in dotted lines. These females are in the rail structure and they help the males (105) of the swivel handle (103) to couple according multiple applications required. We can also observe the connections (127), which are covered behind the rail (128), represented in dotted lines

Drawing 101: it shows the aerial view of the laptop with the swivel handle (103) assembled in the laptop (104) by means of the basis (132) that will be assembled between the laptop (104) and the swivel handle (103), firmly fixed by a coupling system that works by means of the female space (134) that is part of the structure of the portable computer (104) and the male in dotted lines (133) that it is introduced and couples in the female (134). To keep this piece immobile and fixed, it will be screwed the screw (136) that is in vertical form. To be able to mount and to disassemble the swivel handle (103) of the basis (132), the levers will be pressed (105). The levers are part of the revolvable males of the handle (103) and will be introduced in the females (139) of the base (132) in this case.

Drawing 102: it shows the aerial view of the swivel handle (103) joined to the basis (132) by means of the males (135) of the swivel handle and the females (139) of the basis (132) that are marked in dotted lines; you can see the tip males (133), the hole (140), and the screw (136)—essential elements to fix firmly the basis (132) with the laptop (104).

Drawing 103: it shows how the invention should be adjusted according to the publication thickness. We can identify the right paper sheet holder elements (2); left paper sheet holder (3); central basis (4), swivel handle assembled (6) and Velcro (1). This invention modality allows the gap to be adjusted according to the publication thickness. To be able to adjust this gap, the structure should be positioned downwards, the paper sheet holder doors, (2) and (3), should hang and with the index fingers we can adjust the inferior and superior thickness regulators.

Drawing 104: it shows the different disassembled components of the adjustment system of the publication thickness, among those, we can mention: left male thread (141), right male thread (142), female with thread for the right side (143), female with thread for the left side (144), thickness regulator (145) and milimetric screws (146) that tightly fasten the paper sheet holder doors, (2) and (3).

Drawing 105: it shows clearly the screw assembly of the superior axis (147) and the screw assembly of the inferior axis (148) which are inserted in the female with thread for the right side (143) and in the female with thread for the left side (144). We can also identify the central basis (4) and the rachet system (7).

Drawing 106: it shows the right paper sheet holder door (2) and the left paper sheet holder door (3) which can be made of a transparent material.

Drawing 107: it shows the left view of the lap-top holder with the adaptable structure (160). The holder is adjusted perfectly to the lap-top and is firmly fixed within the structure (160) when the floodgate (159) is closed. We can also observe the open spaces for the connections of the laptop (161), the sponge (116), the hole or female of the swivel handle (106) the hinge where the floodgate of the accessory (158) rotates, the floodgate of the accessory (159) and the milimetric superior area of the accessory (162) that is between the screen and the keyboard.

Drawing 108: it shows the mechanism of the internal spring (164), the floodgate of the accessory (159) the hinge (158) where the floodgate of the laptop holder rotates, the adaptable structure (160), the milimetric superior area of the accessory (162), the spaces on the milimetric superior area (163) through which the laptop locker located on the screen passes, and the swivel handle of two axes (103).

Drawing 109: it shows the left view of the laptop holder where the hinge of the accessory floodgate (158) the spaces for the laptop connections (161), the milimetric superior area of the accessory (162), the swivel handle of two axes (103), and the hinge where the floodgate rotates (158) can be distinguished.

Drawing 110: it shows the right view of the laptop holder where the swivel handle of two axes (103), the males with incorporated female (115), the locker (164), the spaces for the laptop connections (161), and the milimetric superior area of the accessory (162) can be identified.

Drawing 111: it shows the laptop holder with the swivel handle of two axes (103), the sponge (116) the floodgate of the accessory (159) the hinge where the hinge rotates (158) the structure with the laptop (160), the milimetric superior area of the accessory (162), and the spaces on the milimetric superior area (163).

Drawing 112: it shows the front view of the e-books holder and we can observe the range of movement of the floodgate (159) that rotates thanks to the hinge (158) on the left superior side of the structure (166). We can also identify with dotted lines the swivel handle (6) with the internal rachet system (7). The swivel handle is fastened or fixed to the structure (166) by means of the overlapped area (154). We also observe in dotted lines the fin (165) that is fastened inside the overlapped area (154) inside the structure (166). This structure also possesses spaces (167) specially located for the control switches of the e-books. We also may identify the locker (164) that firmly fixes the floodgate (159) with the structure (166); we see the locker (164) that will firmly fix the floodgate (159) with the structure (166). This drawing shows the right position of the invention when an e-book slips in and how to use it in an efficient and comfortable manner.

Drawing 113: it shows the front view of the invention for e-books in a transportable and closed position through the roll-up blind (168) that will protect the screen of the e-books. We see the handle (6) that was displaced from the usable position to the transportable position. In this position, the e-book will be upside-down. We also see the structure (166) inside which are the e-book and the spaces (167) for the buttons of the e-book. We also see the area of the internal rachet system (7), the floodgate (159) firmly fixed to the structure (166) by means of the locker (164).

Drawing 114: it shows the lateral view of the invention with a system of magnetos with positive and negatives poles for the interior floodgates, substituting the locking devices of the fins, (35) and (36). The magnetos (149) are positive and they are located in the interior floodgates. The negative magnetos (150) are located in the external paper sheet holder floodgates.

Drawings 115 and 116: they show the view of paper sheet holder fin (13) with a magneto (149) with a positive pole incrusted and the supporting spacer of paper sheets (46) with a negative pole incrusted. These magnetos, for the door system of paper sheet holder fins and spacers, attract each other when having negative and positive poles, what produces a perfect union between both.

Drawing 117: it shows the right lateral view with the swivel handle (6) in usable vertical position.

Drawing 118: it shows the right lateral view with the swivel handle (6) in usable horizontal position.

Drawing 119: it shows the right lateral view with the swivel handle in transportable position and with a paper pad assembled.

Drawing 120: Front view with the swivel handle in transportable position and with a paper pad assembled.

Drawing 121: Front view with the swivel handle coupled to the invention and in usable position.

Drawing 122: it shows the right view of the binder with the handle (103) coupled in horizontal position.

Drawing 123: it shows the aerial view of the binder in transportable position with the handle (103) coupled in transportable position.

Drawing 124: it shows the rear view of the binder with the swivel handle (103) coupled in vertical position; the right and left doors, (169) and (170), of the binder; the cylindrical space (178) inside the swivel handle; the easy-to-insert fin (177); the fins (173); the hinges (172) that avoid that the doors move; the screws (181) that join the doors with the central base.

Drawing 125: it shows the rear view of the binder without the swivel handle; the right and left doors, (169) and (170), of the binder; the central base of the same (103); the screws (181) that join to the doors; the easy-to-insert fin (177) and the over-relief fins (173).

Drawing 126: it shows the front view of the central base of the binder (171); the metallic clip (175) and the special hinges (172).

Drawing 127: it shows the rear view of the central base of the binder (171); the over-relief fins (173); the internal space (176) inside the central base; the low-relief space (174) where the identification of the binder is inserted.

Drawing 128: it shows the aerial view of the central base of the binder (171), the special hinges (172), and the metallic clip (175).

Drawing 129: it shows the rear view of the binder with the swivel handle (103) coupled in horizontal position, the right and left fins (169) and (170), of the binder; the central base of the binder (171), the easy-to-insert fin (177); the low-relief space (174), and the hinges (172).

Drawing 130: it shows the aerial view of the binder with the swivel handle (103) the right and left doors, (169) and (170), of the binder, the central base of the binder (171); the screws (181); the metallic clip (175) and the internal space (176) inside the central base necessary to couple an accessory.

Drawing 131: it shows the right view of the binder where you can observe the application and convenience when having the binder open in an angle of 35 degrees. We can observe the screw (181); the swivel handle (103) and the cylindrical space (178) inside the swivel fastener and the metallic clip (175).

Drawing 132: it shows the right view of the binder with the swivel handle (103) in vertical position coupled in an expandable arm. We can also observe the screws (181); the right door (169); the cylindrical space (178); the accessory (179) and the metallic clip (175).

Drawing 133: it shows the aerial view of the swivel handle (103) with the internal rachet system. It also shows the cylindrical space (178) and the easy-to-insert fin (177).

Drawing 134: it shows the isometric view of a portion of the left door (170) where you can note the hinge system (172) that avoids that the doors move and the female thread (180).

Drawing 135: it shows the aerial view of the portion of the left door (170) and the hinge system (172) with the female thread (180).

Drawing 136: it shows the internal view of the left door (170). We can observe with dotted lines the area of female thread (180) where the screw of the hinge enters.

Drawing 137: it shows the isometric view of the disassembled binder. It also shows the internal space inside the central base (176), the central base of the binder (171), the screw (181) that joins the doors with the central base, the female thread (180) and the left door (170).

Drawing 138: it shows the right view of the binder without having coupled the swivel handle. It also shows the central base of the binder (171), the Velcro (1) and the screws (181) that join the doors with the central base.

Drawing 139: it shows the left view of the invention with an adjustable system depending on the dimensions of height and thickness of the publication. We can identify the superior and inferior system, (186) and (189), of the width adjustable door using the knobs (183) to regulate. Also we see the integrated system to regulate the height of the magazines, which is regulated by means of the knobs (184) for this function. Simultaneously, we notice the other pieces of the fastener, as follows: the swivel handle (6) that is in horizontal position in this graph, the central base (4), the half superior moon (22), the half inferior moon (15), the buttonhole of the central thread (9), the milimetric screws (146) that firmly fix the adjustable system of floodgates to the females with thread (144) and without thread (182) to graduate the thickness of the publication. We also see the superior screw/axis (147) for the thickness regulator, and the inferior screw/axis (148) for the thickness regulator. We can also identify the supporting fin of paper sheets (54) of the left inferior adjustable door (187).

1. The fastener of books, newspapers, magazines, paper pads, laptops, e-books and binders characterized by its light and portable structure specially designed to carry and hold a book, newspaper or similar is conformed by following elements:
The central piece of the structure
The paper sheet holder doors for soft and hard covers
The swivel handle
The central thread accompanied by its own buttonhole

2. The fastener of books, newspapers, magazines, paper pads, laptops, e-books and binders according to claim #1, characterized by its swivel handle with a hole in the center and rachet system. This swivel handle is specially designed to allow, in its unique and innovative way, to sustain open books, newspapers, magazines or similar, comfortably and safely, in a perfect position using a single arm and hand for the right reading; while the other arm and hand remains free for any other purpose.

3. The swivel fastener for books, newspapers, magazines, paper pads, laptops, e-books and binders according to claim #1 is characterized by its handle that allows to transport this structure with the book, newspaper, magazine or similar in the structure's interior when this is in vertical position with the paper sheet holder doors closed and firmly fixed by Velcro.

4. The fastener of books, newspapers, magazines, paper pads, laptops, e-books and binders according to claim #1 is characterized for its adjustable system for different publication thickness.

5. The fastener of books, newspapers, magazines, paper pads, laptops, e-books and binders according to claim #4 is characterized because such system is conformed by inferior and superior screws and axes, right and left females and a thickness regulator for index finger. This allows the paper sheet holder doors to be adjusted to the desired thickness.

6. The fastener of books, newspapers, magazines, paper pads, laptops, e-books and binders according to claim #2 is characterized because such swivel handle horizontally positioned allows to lean the structure in order to place it on a table, desk or flat surface, with the paper sheet holder doors open. This quality allows the books, newspapers or similar to be perfectly open in order to let the user read with both hands free for any other activity.

7. The fastener of books, newspapers, magazines, paper pads, laptops, e-books and binders according to claim #2 is characterized because when placing this structure in vertical position, it allows to assemble the structure in expandable arms or tripods so when the paper sheet holder doors are open, the book, newspaper, magazine or similar will be perfectly open and sustained in the air and the user will be able to use it for copying or reading anywhere

8. The fastener of books, newspapers, magazines, paper pads, laptops, e-books and binders according to claim #1 is characterized by its paper sheet holder doors specially designed with a system of interior floodgates, through which the user can enclose a bunch of paper sheets or hard cover either from the beginning or from the end of a book, newspaper or magazine, leaving the reading material in the center no matter the type of cover.

9. The fastener of books, newspapers, magazines, paper pads, laptops, e-books and binders according to claim #1 is characterized by its central piece or basis in which it is possible to assemble an optional accessory of illumination. The user will be able to use it in dark environments.

10. The fastener of books, newspapers, magazines, paper pads, laptops, e-books and binders is characterized because it is conformed by the items listed below for an easy transportation and portability of a laptop:
A detachable handle with rotation on its two axes: central axis and horizontal axis.
A detachable keyboard
A CPU together with a screen

11. The fastener of books, newspapers, magazines, paper pads, laptops, e-books and binders according to claim #10 is characterized by its detachable handle specially designed with a hole in the center and with two axes; which will allow, in its unique and creative way, to sustain comfortably and safely an open laptop with a single arm and hand while the other remains free for any other purpose.

12. The fastener of books, newspapers, magazines, paper pads, laptops, e-books and binders according to claim #10 is characterized by its detachable handle specially designed with two axes that allows to sustain an open or closed laptop over the superior part of the legs (“lap”), in its unique and innovative way, using as a stabilizer the detachable handle, which is positioned within the user's knees and is effectively avoiding the laptop to slip or fall to the floor.

13. The fastener of books, newspapers, magazines, paper pads, laptops, e-books and binders according to claim #10 is characterized by its swivel handle and detachable keyboard that allow through the swivel handle and central hole to assemble the portable computer in an expandable arm obtaining this way the ability to adjust the height and the angle of the screen of mentioned portable computer. Additionally, it allows the keyboard to be removed, having this way freedom to operate it.

14. The fastener of books, newspapers, magazines, paper pads, laptops, e-books and binders according to claim #10 is characterized due to the detachable handle specially designed with two axes that allow the handle to rotate on its horizontal axis—when place the laptop over a table—raising the rear part of the CPU, approximately 2.5 cm. This will allow to position the screen of corresponding laptop a little bit higher and to position the keyboard at an angle of approximately 35 20 degrees.

15. The fastener of books, newspapers, magazines, paper pads, laptops, e-books and binders according to claim #10 is characterized due to the fact that such swivel handle has two axes. When the laptop is closed, it will also function as transportation means.

16. The fastener of books, newspapers, magazines, paper pads, laptops, e-books and binders according to claim #10 is characterized by its plastic structure which will cover the laptop rims as a box leaving access to the lateral and frontal connections, screen and keyboard of the laptop.

17. The fastener of books, newspapers, magazines, paper pads, laptops, e-books and binders according to claim #16 is characterized because it possesses the mechanism of swivel grip in its two axes and it possesses an internal rachet mechanism.

18. The fastener of books, newspapers, magazines, paper pads, laptops, e-books and binders according to claim #16 is characterized because it possesses a mechanism of internal springs for closing and firmly fixing mentioned plastic structure.

19. The fastener of books, newspapers, magazines, paper pads, laptops, e-books and binders according to claim #16 because this plastic structure confers the characteristics of portability, protection, maneuverability and aesthetics to the laptop.

20. The fastener of books, newspapers, magazines, paper pads, laptops, e-books and binders according to claim #16 because this plastic structure is available in different sizes for each model and trademark of portable computer (laptop) available in the market.

21. The fastener of books, newspapers, magazines, paper pads, laptops, e-books and binders according to claim #1 because it possesses a plastic structure which will cover the rims of an e-book as a case which possesses a swivel handle that will shift from the transportable position to the usable position at the center of this e-book.

22. The fastener of books, newspapers, magazines, paper pads, laptops, e-books and binders according to claim #21 is characterized because it possesses a blind type protector in its front area to protect and cover the screen of such e-books when it is not being used.

23. The fastener of books, newspapers, magazines, paper pads, laptops, e-books and binders according to claim #21 is characterized because this plastic structure confers it the characteristics of portability, protection, maneuverability and aesthetics to this e-book.

24. The fastener of books, newspapers, magazines, paper pads, laptops, e-books and binders according to claim #21 is characterized because it possesses a mechanism of internal spring for closing and firmly fixing mentioned plastic structure.

25. The fastener of books, newspapers, magazines, paper pads, laptops, e-books and binders according to claim #8 is characterized because these paper sheet holder doors possess a system of magnetos with positive and negative polarity that allows a perfect joint for the user's comfort when it is using the invention with publications.

26. The fastener of books, newspapers, magazines, paper pads, laptops, e-books and binders according to claim #24 is characterized because it can be used for paper pads.

27. The fastener of books, newspapers, magazines, paper pads, laptops, e-books and binders according to claim #1 is characterized because it possesses an adjustment system for paper sheet holder doors that is used depending on the thickness of the book, newspaper or magazine.

28. The fastener of books, newspapers, magazines, paper pads, laptops, e-books and binders according to claim #1 characterized because it possesses a removable optional accessory of the paper sheet fixers which are for both paper sheet holder doors (right and left).

29. The fastener of books, newspapers, magazines, paper pads, laptops, e-books and binders according to claim #1 is characterized because it possesses an adjustable system depending on the dimensions (height and width) of the publication.

30. The fastener of books, newspapers, magazines, paper pads, laptops, e-books and binders according to claim #1 is characterized because when it is used as binder holder, it has a hinge system that avoids the doors to be open.
